(19) United States
(12) Patent Application Publication
(10) Pub. No.: US 2026/0361397 A1
(43) Pub. Date: Nov. 12, 2026

(54) METHODS AND APPARATUS FOR SATELLITE ASSISTED TERRESTRIAL WIRELESS CONNECTIVITY

(71) Applicant: Charter Communications Operating, LLC, St. Louis, MO (US)

(72) Inventor: Saran Khalid, Denver, CO (US)

(21) Appl. No.: 19/201,413

(22) Filed: May 7, 2025

(51) Int. Cl. H04B 7/185; H04W 8/22; H04W 64/00

(52) U.S. Cl. CPC H04B 7/18539; H04B 7/18547; H04W 8/22; H04W 64/006

(57) ABSTRACT

The present invention relates to methods and apparatus for providing satellite assisted terrestrial wireless device-to-device communications connections between user equipment devices of a terrestrial wireless network. An exemplary method embodiment includes the steps of: making a determination, by a Continuous Mobile Communications System (CMCS), that a first user equipment device meets criteria for providing satellite assisted terrestrial wireless device-to-device communications; identifying, by the CMCS, a second user equipment device to provide a satellite assisted terrestrial wireless device-to-device communications connection to the first user equipment device; and sending, by the CMCS, instructions to a terrestrial wireless core network for establishing a satellite assisted terrestrial wireless device-to-device communications connection between the second user equipment device and the first user equipment device.

### FIELD OF INVENTION

The present invention relates to methods and apparatus for providing satellite assisted terrestrial wireless connectivity. The present invention further relates to methods and apparatus for providing terrestrial wireless services to user equipment devices not able to directly communicate with wireless base stations of a terrestrial wireless system through the use of satellite tracking information.

### BACKGROUND OF THE INVENTION

Terrestrial mobile coverage provides mobile communication services to mobiles within its coverage. Due to various factors, the terrestrial mobile network may not be able to connect with every mobile and therefore it leaves some mobiles without coverage. This is specifically the case in mountainous terrain, dense urban areas, etc. Satellite systems in at least some instances can communicate with mobiles that the terrestrial mobile network cannot. However, satellite communication is usually not a part of a mobile provider's network and therefore is expensive. In some instances, a device-to-device user equipment device wireless connection can be used to support terrestrial wireless services but the determination of the which user equipment device or devices are best situated to provide the device-to-device connection to a mobile or user equipment device that has lost its connection and what wireless links and/or radio resources are best utilized for the device-to-device connections is not known.

For example, when a user equipment device that loses its direct wireless connection to a base station merely broadcasts a proximity service discovery announcement requesting a connection any number of user equipment devices may hear it and respond but in such instances the device-to-device connection established is not planned and selected and is typically sub-optimal for the overall network and in many instances for the user equipment devices which form the device-to-device connection leading to proper user experience and an efficient and/or ineffective use of network resources. For example, in some instances the device-to-device can lead to the device-to-device connection being quickly lost due to movement of one of the user equipment devices which form the device-to-device connection going out of range of the other device because they were at maximum range when the device-to-device connection was established. In other instances, the device-to-device connection is inadequate (e.g., the radio resources of the links supporting the device-to-device connection are inadequate to provide the requested quality of service and/or become overwhelmed leading to poor performance at both user equipment devices involved in the device-to-device connection). In other instances, there are mismatches in user equipment device properties or categories so that the links established are not efficient and the performance is sub-par when a better alternative user equipment device in the vicinity which could provide better performance is not utilized. As the location of the mobile or user equipment device which has lost connection with the terrestrial wireless network is unknown it is also problematic to make a determination as to which user equipment devices are best positioned to provide a device-to-device connection. Furthermore, an ad hoc approach to providing user equipment device-to-device connections leads to wasted radio resources and/or the inefficient use of the use of the terrestrial radio resources of the network.

From the foregoing, it should be understood that there is a need for new and/or improved methods and apparatus for providing terrestrial wireless services to mobiles or user equipment devices which are not within the coverage of the terrestrial wireless network. Furthermore, there is a need for new and/or improved methods and apparatus for providing terrestrial wireless services for mobiles or user equipment devices which do not have connectivity with a terrestrial wireless base station in an efficient and cost effective way. Furthermore, there is a need for new and/or improved methods and apparatus for providing wireless services to user equipment devices which utilize radio resources of a terrestrial wireless network in a efficient and effective manner. Furthermore, there is a need for new and/or improved methods and apparatus that utilize in an effective and efficient (e.g., efficient from a cost and spectrum usage perspective) manner a satellite system's ability to communicate and/or track user equipment devices to facilitate terrestrial wireless networks providing wireless services to user equipment devices which cannot directly communicate with wireless base stations of the terrestrial wireless network. Furthermore, there is a need for a solution to the technological problem of how to effectively and efficiently provide terrestrial wireless services to user equipment devices that are not directly receiving and/or cannot directly communicate with wireless base stations of a terrestrial wireless system. Furthermore, there is a need for a solution to the technological problem of how to identify which user equipment device or devices are optimal or a best-match for providing device-to-device wireless connections/services to a user equipment device that has lost its connection from a plurality of available user equipment devices and what radio resources and/or wireless links to utilize for such wireless device-to-device connections.

### SUMMARY OF THE INVENTION

The present invention provides new and/or improved methods and apparatus that provide terrestrial wireless services to mobiles or user equipment devices which are not within the coverage of the terrestrial wireless network using satellite assisted terrestrial wireless device-to-device communications connections. Various embodiments of the present invention provide new and/or improved methods and apparatus for providing efficient and cost effective terrestrial wireless services for mobiles or user equipment devices which do not have connectivity with a terrestrial wireless base station. Various embodiments of the present invention provide new and/or improved methods and apparatus for providing wireless services to user equipment devices which utilize radio resources of a terrestrial wireless network in a efficient and effective manner. Various embodiments of the present invention provide new and/or improved methods and apparatus that utilize in an effective and efficient (e.g., efficient from a cost and spectrum usage perspective) manner a satellite system's ability to communicate and/or track user equipment devices to facilitate terrestrial wireless networks providing wireless services to user equipment devices which cannot directly communicate with wireless base stations of the terrestrial wireless network. Various embodiments of the present invention provide a solution to the technological problem of how to effectively and efficiently provide terrestrial wireless services to user equipment devices that are not directly receiving and/or cannot directly communicate with wireless base stations of a terrestrial wireless system. Various embodiments of the present invention provide a solution to the technological problem of how to identify which user equipment device or devices are optimal or a best-match for providing device-to-device wireless connections/services to a user equipment device that has lost its connection from a plurality of available user equipment devices and what radio resources and/or wireless links to utilize for such wireless device-to-device connections.

The present invention provides satellite assisted terrestrial wireless user equipment device-to-user equipment device connections that provide terrestrial wireless services to user equipment devices that do not have connectivity with a wireless base station of a terrestrial wireless system. Once a user equipment device loses its connection to the terrestrial wireless system, it enables satellite communications and transmits signals to satellites of a satellite communications system. One or more of the satellites receive the signals, and the satellite system determines the location of the user equipment device that does not have connectivity with the terrestrial wireless system. The satellite tracks the user equipment device and reports the user equipment device location information to a Continuous Mobile Communications System. The Communications Mobile Communications System uses the position tracking and location information provided by the satellite system and information provided by the terrestrial wireless system (e.g., user equipment device location information and connectivity information) to identify a user equipment device (e.g., the best user equipment device) with a terrestrial wireless connection that can connect the user equipment device without terrestrial wireless connectivity to the terrestrial wireless system via a wireless device-to-device connection. The Communications Mobile Communications System makes the decision on which of the user equipment devices with terrestrial wireless connections to select for the wireless device-to-device connection based on data obtained from a propagation generator and link estimator which factors in various communications parameters such as distance, interference, modulation rates, load on the network, and load on the individual user equipment devices. As the satellite system is only providing satellite location and tracking services for the user equipment device it is less expensive than providing satellite voice services to user equipment devices that lose terrestrial wireless connectivity. This is true for various reasons including, for example, that voice services require the use of a larger amount of satellite spectrum/bandwidth than the satellite tracking service and additionally processing by the satellites and satellite systems not required for the satellite tracking service.

Unlike in situations in which a user equipment device which loses its connectivity and uses proximity service discovery mode of operation in an attempt to identify a user equipment device which can provide wireless device-to-device communications services, the present invention utilizes information from a satellite system to provide satellite assisted terrestrial wireless device-to-device communications. Some of the problems with the proximity service discovery mode of operation is that it may result in a long time for the user equipment device which has lost connectivity to find a suitable user equipment device that can provide device-to-device services. Furthermore, the user equipment device seeking a device-to-device connection does not have the information to know which of any number of devices which respond to a discovery request is best situated to provide a device-to-device communications link. In various instances, once a user equipment device is discovered using proximity discovery mode of operation and a device-to-device connection established, the user equipment device which lost terrestrial wireless connectivity or the user equipment device which is providing device-to-device services may not be slow moving resulting in a disruption or loss of the device-to-device communications link very quickly after it was established providing a very poor user experience. The use of satellite assisted terrestrial wireless device-to-device communications in accordance with various embodiments of the present invention, overcomes these problems as the information from the satellites results in better tracking, location, pathloss estimation, and faster connectivity options. A Continuous Mobile Communications System in accordance with various embodiments of the present invention utilizes information unavailable to the user equipment devices (e.g., user equipment device location, speed, direction of movement, and network link information) to determine the best situated user equipment device to provide a wireless device-to-device communications connection or link to the user equipment device without terrestrial wireless connectivity. Various embodiments of the invention provide for a more effective and controlled way of providing terrestrial wireless device-to-device communications services using satellite assistance.

An exemplary method of in accordance with one embodiment of the present invention includes the steps of: making a determination, by a Continuous Mobile Communications System (CMCS), that a first user equipment device meets criteria for providing satellite assisted terrestrial wireless device-to-device communications; identifying, by the CMCS, a second user equipment device to provide a satellite assisted terrestrial wireless device-to-device communications connection to the first user equipment device; and sending, by the CMCS, instructions to a terrestrial wireless core network for establishing a satellite assisted terrestrial wireless device-to-device communications connection between the second user equipment device and the first user equipment device. In some embodiments, the method further includes the additional step of the terrestrial wireless core network sending instructions to the second user equipment device to establish a satellite assisted terrestrial wireless device-to-device communications connection with the first user equipment device. In some embodiments, the method further includes the steps of: the second wireless device receiving the instructions from the terrestrial wireless core network and establishing the satellite assisted terrestrial wireless device-to-device communications connection with the first user equipment device.

In some embodiments, the determination that the first user equipment device meets criteria for providing satellite assisted terrestrial wireless device-to-device communications is based on location information for the first user equipment device provided to the CMCS from a satellite core network. In some embodiments, the location information for the first user equipment device includes geographical coordinates (e.g., longitude, latitude, altitude with respect to the Earth) for the first user equipment device.

In some embodiments, the steps of the method further include: determining, by the CMCS, whether or not the first user equipment device is moving based on the location information provided by the satellite core network; and when the CMCS determines that the first user equipment device is moving, determining, by the CMCS, a speed and a direction of the movement of the first user equipment device based on the location information provided by the satellite core network. In some embodiments, the location information provided by the first includes: a first location at which the first user equipment device is located and information (e.g., a timestamp) indicating when the first user equipment was located at the first location, and a second location at which the first user equipment device is located and information (e.g., a timestamp) indicating when the first user equipment was located at the second location.

In some embodiments, the criteria includes the distance from the location of the first user equipment device to a user equipment device that can provide satellite assisted terrestrial wireless device-to-device communications for the first user equipment device being less than a maximum distance of separation, said maximum distance of separation being based on a maximum transmit power level that can be utilized by a user equipment device for a terrestrial wireless device-to-device communications connection.

In some embodiments, the determination that the first user equipment device meets criteria for providing satellite assisted terrestrial wireless device-to-device communications is further based on movement information for the first user equipment device provided to the CMCS from the satellite core network or derived from the location information for the first user equipment device provided to the CMCS from the satellite core network, said movement information including speed information for the first user equipment device, said speed information being the speed at which the first user equipment device is moving.

In some embodiments, the criteria includes: (i) the first user equipment device is moving at a speed less than a first speed threshold amount, (ii) the first user equipment device has a subscription to a terrestrial wireless network and a subscription to a satellite wireless network, and (iii) the first user equipment device does not have wireless connectivity with the terrestrial wireless network (i.e., the first user equipment device does not have capability to establish a wireless connection or link to the terrestrial wireless network (e.g., the first user equipment device is outside the coverage area of the base stations of the terrestrial wireless network or is in a location where the wireless signal of the base stations of the terrestrial wireless network are being blocked (e.g., by terrain or clutter or the signals from the first user equipment device to the terrestrial wireless network are being blocked (e.g., by terrain or clutter)))).

In various embodiments, the first user equipment device is a dual subscription wireless device capable of simultaneously wirelessly communicating with: (i) satellites of a satellite wireless network, and (ii) wireless communications devices of a terrestrial wireless network, said terrestrial wireless core network being part of the terrestrial wireless network.

In various embodiments, said satellite wireless network provides user equipment device location tracking services.

In various embodiments, prior to sending instructions to the first terrestrial core network for establishing a satellite assisted terrestrial wireless device-to-device communications connection between the second user equipment device and the first user equipment device, generating, by the CMCS, said instructions, said instructions including: (i) identification information for the first user equipment device (e.g., GUTI or IMEI for the first user equipment device) which is to be the target of the satellite assisted terrestrial wireless device-to-device communications connection, (ii) identification information for the second user equipment device (e.g., GUTI or IMEI) which is to host the satellite assisted terrestrial wireless device-to-device communications connection, and (iii) radio resource information for the satellite assisted terrestrial wireless device-to-device communications connection to be established (e.g., radio frequency spectrum to be used, radio frequency bandwidth to be used, radio frequency channels to be used for the D2D connection, transmission power levels, timing synchronization information, modulation and coding scheme, time slot allocation).

In some embodiments, the step of identifying, by the CMCS, the second user equipment device includes: selecting the second user equipment device from a plurality of user equipment devices having a terrestrial wireless connection to a wireless base station of a terrestrial wireless network to which the first user equipment device is subscribed based on information provided by a propagation generator and link estimator, said information provided by the propagation generator and link estimator including information about which of the plurality of user equipment devices are capable of supporting a device-to-device communications link to the first user equipment device and attributes about the device-to-device communications link which could be supported (e.g., bandwidth, bit rate, signal path loss, etc.).

In some embodiments, the step of identifying, by the CMCS, the second user equipment device to provide a satellite assisted terrestrial wireless device-to-device communications connection to the first user equipment device further includes: selecting the second user equipment device from a plurality of user equipment devices having a terrestrial wireless connection to a wireless base station of a terrestrial wireless network to which the first user equipment device is subscribed based on one or more or any combination of the following: (i) distance between the first user equipment and user equipment devices of the plurality of user equipment devices, (ii) signal interference information, (iii) modulation rates supported by user equipment devices of the plurality of user equipment devices, (iv) load on the network, (v) individual load on the user equipment devices of the plurality of user equipment devices, (vi) user equipment device category of the first user equipment device, (vii) user equipment device capabilities of the first user equipment device, (viii) user equipment device type of the first user equipment device; (ix) user equipment device category of user equipment devices of the plurality of user equipment devices, (x) user equipment device capabilities of the user equipment devices of the plurality of user equipment devices, (xi) user equipment device type of the user equipment devices of the plurality of user equipment devices, (xii) information on the wireless links connecting the user equipment devices of the plurality of user equipment devices to terrestrial wireless base stations, (xiii) information on the movement (e.g., direction and/or speed) of the first user equipment device, (xiv) information on the movement (e.g., direction and/or speed) of the user equipment devices of the plurality of user equipment devices, (xv) contracted for quality of service of the first user equipment device, (xvi) contracted for quality of service of the user equipment devices of the user equipment devices of the plurality of user equipment devices, (xvii) estimated quality of service of wireless device-to-device connections that could be provided by user equipment devices of the plurality of user equipment devices, (xviii) measured received signal strength of signals from user equipment devices of the plurality of user equipment devices provided by the base stations to which the user equipment devices are connected.

In some embodiments, the step of identifying, by the CMCS, the second user equipment device to provide a satellite assisted terrestrial wireless device-to-device communications connection to the first user equipment device further includes: determining that the second user equipment device is a best match for providing a satellite assisted terrestrial wireless device-to-device communications connection to the first user equipment device from a plurality of user equipment devices having a terrestrial wireless connection to a wireless base station of a terrestrial wireless network to which the first user equipment device is subscribed based on: (i) location information for the first user equipment device, (ii) location information for the second user equipment device, (iii) movement of the second user equipment device with respect to the first user equipment device, (iv) traffic load on the second user equipment device, (v) estimated propagation path loss for a potential wireless device-to-device communications link connecting the second user equipment device to the first user equipment device.

Another exemplary method in accordance with an embodiment of the present invention includes the steps of: detecting, by a first user equipment device operating in a first mode of operation, the loss of wireless connectivity with a terrestrial wireless network system; changing, by the first user equipment device, from the first mode of operation to a second mode of operation, in response to detecting the loss of wireless connectivity with the terrestrial wireless network system; and wherein said first mode of operation is a terrestrial wireless only mode of operation in which satellite communications are not enabled; and wherein said second mode of operation is a mode of operation in which the first user equipment device is enabled to communicate with other user equipment devices and wireless base stations of the terrestrial wireless network system and satellites of a satellite communications system.

In some embodiments, the step of detecting, by the first user equipment device operating in the first mode of operation, the loss of wireless connectivity with the terrestrial wireless network system includes: detecting, by the first user equipment device, the inability to receive signals from or communicate with any wireless base stations of the terrestrial wireless network system.

In some embodiments, the method further includes that while operating in the second mode of operation, performing the following operations by the first user equipment device: (i) enabling satellite assisted terrestrial wireless device-to-device connection functionality on the first user equipment device; and (ii) once satellite assisted terrestrial wireless device-to-device connection functionality on the first user equipment device has been enabled, initiating, by the first user equipment device, wireless signal transmissions to one or more satellites of a satellite communications system for user equipment device location tracking by the satellite communications system; and (iii) continuing the wireless signal transmissions to the one or more satellites while said satellite assisted terrestrial wireless device-to-device connection functionality is enabled.

In some embodiments, the method further includes that while operating in the second mode of operation, performing the following operations by the first user equipment device: (i) enabling satellite assisted terrestrial wireless device-to-device connection functionality on the first user equipment device; and (ii) after enabling satellite assisted terrestrial wireless device-to-device connection functionality on the first user equipment device, establishing a wireless communications connection with a satellite of a satellite communications system, said wireless communications connection limited to signaling for location tracking of the first user equipment device by the satellite communications system.

In various embodiments, the method further includes that while continuing to operate in the second mode of operation, performing the following additional operations by the first user equipment device: wirelessly receiving, from a second user equipment device, a broadcast message offering terrestrial wireless device-to-device services, said second user equipment device having a wireless connection to a wireless base station of the terrestrial wireless network system; and generating a response to the broadcast message, said response requesting the offered terrestrial wireless device-to-device services and including identification information for the first user equipment device (e.g., GUTI or IMEI for the first user equipment device); wirelessly transmitting the generated response to the second user equipment device; receiving from the second user equipment device a message indicating acceptance of the request for the offered terrestrial wireless device-to-device services and including information for establishing the terrestrial wireless device-to-device connection between the first user equipment device and the second user equipment device.

In some embodiments, the method further includes that while continuing to operate in the second mode of operation, performing the following additional operations by the first user equipment device: establishing, the terrestrial wireless device-to-device connection with the second user equipment device; and establishing, a voice call, using the terrestrial wireless device-to-device connection to a third user equipment device.

In some embodiments, the method further includes that while continuing to operate in the second mode of operation, performing the following additional operations by the first user equipment device: receiving reference signals directly from a wireless base station of the terrestrial wireless network; generating performance metrics on the received reference signals (e.g., signal strength, signaling interference, signaling noise metrics such as Reference Signal Received Power (RSRP), Signal-to-Noise and Interference Ratio (SNIR), etc.); and reporting the performance metrics for the received reference signals to a Continuous Mobile Communications System (CMCS) via the terrestrial wireless device-to-device communications connection.

In some embodiments, the method further includes switching, by the first user equipment device, from the second mode of operation to the first mode of operation wherein switching from the second mode of operation to the first mode of operation includes: (i) disabling, by the first user equipment device, satellite assist terrestrial wireless device-to-device connection functionality at the first user equipment, and (ii) disabling, by the first user equipment device, satellite communications.

In various embodiments, disabling satellite assist terrestrial wireless device-to-device connection functionality includes ceasing sending transmission signals to the satellites of the satellite system.

The present invention is also applicable to apparatus and system embodiments wherein one or more devices implement the steps of the method embodiments. In some apparatus embodiments each of the wireless base stations, user equipment devices, network equipment devices, Continuous Mobile Communications System, Propagation Generator and Link Estimator, satellite core network, storage system, terrestrial wireless core network and each of the other apparatus/devices/nodes of the system include one or more processors and/or hardware circuitry, input/output interfaces including receivers and transmitters, and a memory. The memory including instructions when executed by one or more of the processors control the apparatus/device/node of the system to operate to perform the steps and/or functions of various method embodiments of the invention.

The present invention is also applicable to and includes apparatus and systems such as for example, apparatus and systems that implement the steps and/or functions of the method embodiments. For example, a system in accordance with one embodiment of the present invention includes: a Continuous Mobile Communications System (CMCS), a propagation generator and link estimator, a satellite system with a plurality of satellites and a satellite core network, a terrestrial wireless system with a terrestrial wireless core network, a plurality of wireless base stations, and a plurality of user equipment devices that have wireless satellite communications interfaces for communicating with satellites and terrestrial wireless communications interfaces for communicating with communications devices (e.g., wireless base stations and other user equipment devices) with one or more of the plurality of user equipment devices having satellite assisted terrestrial wireless device-to-device applications. In some embodiments, the CMCS includes memory and a first processor, said first processor controlling the CMCS to perform the following operations: making a determination, by a Continuous Mobile Communications System (CMCS), that a first user equipment device meets criteria for providing satellite assisted terrestrial wireless device-to-device communications; identifying, by the CMCS, a second user equipment device to provide a satellite assisted terrestrial wireless device-to-device communications connection to the first user equipment device; and sending, by the CMCS, instructions to a terrestrial wireless core network for establishing a satellite assisted terrestrial wireless device-to-device communications connection between the second user equipment device and the first user equipment device.

An exemplary apparatus embodiments includes a first user equipment device that includes: memory, and a first processor, said first processor configured to control the first user equipment device to perform the following operations: detecting, by a first user equipment device while operating in a first mode of operation, the loss of wireless connectivity with a terrestrial wireless network system; changing, by the first user equipment device, from the first mode of operation to a second mode of operation, in response to detecting the loss of wireless connectivity with the terrestrial wireless network system; and wherein said first mode of operation is a terrestrial wireless only mode of operation in which satellite communications are not enabled; and wherein said second mode of operation is a mode of operation in which the first user equipment device is enabled to communicate with other user equipment devices and wireless base stations of the terrestrial wireless network system and satellites of a satellite communications system.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates coverage of a terrestrial wireless network and a satellite wireless network with a typical terrestrial mobile network unable to provide mobile coverage to all the subscribers operating user equipment devices in its area while satellites of a satellite system are able to communicate with subscriber user equipment devices which the terrestrial mobile network cannot.

FIG. 2 illustrates the limited coverage of a terrestrial mobile network.

FIG. 3 illustrates an exemplary system in accordance with an embodiment of the present invention.

FIG. 4 illustrates details of an exemplary terrestrial wireless base station in accordance with one embodiment of the present invention.

FIG. 5 illustrates details of an exemplary User Equipment (UE) device, e.g., a mobile device, cell phone, smartphone, wireless tablet, laptop, wireless notebook, in accordance with one embodiment of the present invention.

FIG. 6 illustrates details of an exemplary network equipment device/system/server e.g., a Continuous Mobile Communications System (CMCS), terrestrial network core system, satellite core network system, a storage system, a propagation generator and link estimator, in accordance with an embodiment of the present invention.

FIG. 7 illustrates details of an exemplary satellite in accordance with an embodiment of the present invention.

FIG. 8 illustrates an exemplary assembly of components for a user equipment device in accordance with an embodiment of the present invention.

FIG. 9 illustrates an exemplary assembly of components for a network equipment device/system/server in accordance with an embodiment of the present invention.

FIG. 10 illustrates an exemplary system in accordance with an embodiment of the present invention.

FIG. 11 comprises FIG. 11A, FIG. 11B, FIG. 11C, FIG. 11D, FIG. 11E, FIG. 11F, FIG. 11G, FIG. 11H, and FIG. 11I.

FIG. 11A is the first part of a signaling diagram which illustrates the steps and signaling of an exemplary method in accordance with an embodiment of the present invention.

FIG. 11B is the second part of a signaling diagram which illustrates the steps and signaling of an exemplary method in accordance with an embodiment of the present invention.

FIG. 11C is the third part of a signaling diagram which illustrates the steps and signaling of an exemplary method in accordance with an embodiment of the present invention.

FIG. 11D is the fourth part of a signaling diagram which illustrates the steps and signaling of an exemplary method in accordance with an embodiment of the present invention.

FIG. 11E is the fifth part of a signaling diagram which illustrates the steps and signaling of an exemplary method in accordance with an embodiment of the present invention.

FIG. 11F is the sixth part of a signaling diagram which illustrates the steps and signaling of an exemplary method in accordance with an embodiment of the present invention.

FIG. 11G is the seventh part of a signaling diagram which illustrates the steps and signaling of an exemplary method in accordance with an embodiment of the present invention.

FIG. 11H is the eighth part of a signaling diagram which illustrates the steps and signaling of an exemplary method in accordance with an embodiment of the present invention.

FIG. 11I is the ninth part of a signaling diagram which illustrates the steps and signaling of an exemplary method in accordance with an embodiment of the present invention.

FIG. 12 comprises FIG. 12A, FIG. 12B, FIG. 12C, FIG. 12D, and FIG. 12E.

FIG. 12A is the first part of a flowchart of an exemplary method in accordance with an embodiment of the present invention.

FIG. 12B is the second part of a flowchart of an exemplary method in accordance with an embodiment of the present invention.

FIG. 12C is the third part of a flowchart of an exemplary method in accordance with an embodiment of the present invention.

FIG. 12D is the fourth part of a flowchart of an exemplary method in accordance with an embodiment of the present invention.

FIG. 12E is the fifth part of a flowchart of an exemplary method in accordance with an embodiment of the present invention.

FIG. 13 illustrates a table including exemplary information used for determining: (i) whether a user equipment device is to be provided satellite assisted terrestrial wireless device-to-device services, (ii) the user equipment device to provide those terrestrial wireless device-to-device services, and (iii) information about the device-to-device link to be provided.

### DETAILED DESCRIPTION

As previously discussed, a terrestrial mobile or wireless system provides mobile communication services to mobiles or user equipment devices which are within the coverage of the terrestrial mobile or wireless system. Due to various factors, the terrestrial mobile or wireless network or system may not be able to connect with every mobile or user equipment device and therefore it leaves some mobiles or user equipment devices without coverage. This is specifically the case in mountainous terrain, dense urban areas, locations in which wireless signals are blocked by clutter, etc. Satellite systems in at least some instances can communicate with mobiles or user equipment devices that the terrestrial mobile or wireless network cannot. However, satellite communication is usually not a part of a mobile provider's network and therefore is expensive. In some instances, a device-to-device user equipment device wireless connection can be used to support terrestrial wireless services but the determination of the which user equipment device or devices are best situated to provide the device-to-device connection to a mobile or user equipment device that has lost its connection and what wireless links and/or radio resources are best utilized for the device-to-device connections is not known.

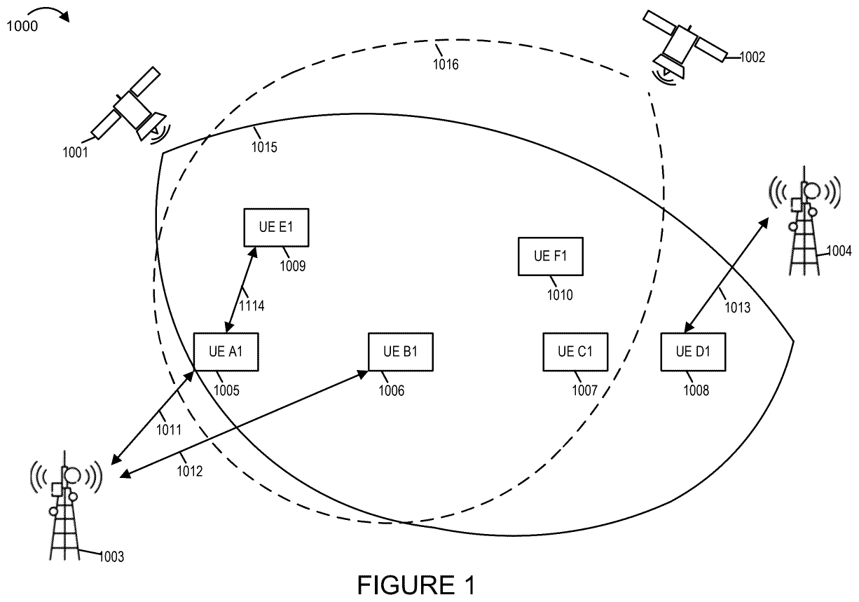

FIG. 1 illustrates a diagram 1000 showing the coverage of a terrestrial wireless network and a satellite wireless network. The terrestrial mobile network bases stations 1003 and 1004 are unable to provide mobile coverage to all the user equipment device subscribers in its area while satellites 1001 and 1002 of a satellite system are able to receive signals from and communicate with subscriber user equipment devices which the terrestrial mobile network cannot (e.g., UE C1 1007 and UE F1 1010). The terrestrial base station 1003 is shown as directly communicating with UE A1 1005 via direct wireless communications link 1011. The terrestrial base station 1003 is shown as directly communicating with UE B1 1006 via direct wireless communications link 1011. UE E1 1009 is shown as being wirelessly connected to the UE A1 1005 via a device-to-device wireless link 1014. The terrestrial base station 1004 is shown as directly communicating with UE D1 1008 via direct wireless communications link 1013. UE C1 1007 and UE F1 1010 are not within the coverage of either terrestrial wireless base station 1003 or terrestrial wireless base station 1004. The satellite 1001 has a coverage area 1015 which includes UE A1 1005, UE B1 1006, UE C1 1007, UE D1 1008, UE E1 1009, and UE F1 1010. The satellite 1002 has a coverage area which 1016 which includes UE A1 1005, UE B1 1006, UE C1 1007, UE E1 1009, and UE F1 1010.

Satellite communication is usually not a part of a mobile provider's network and therefore is expensive. Since various mobiles/user equipment devices are left out of coverage of the terrestrial network, various embodiments of the present invention provide methods and apparatus for providing these mobiles/user equipment devices terrestrial wireless services.

While a terrestrial mobile network system might not be able to cover all of its subscriber user equipment devices in its network due to terrain and clutter related challenges, satellite(s) may be able to see that is receive signals from and/or communicate with these user equipment devices. Satellites however are only able to communicate with these user equipment devices if satellite communication is enabled on the user equipment device that is the user equipment devices (UEs) are capable of communication with satellites of a satellite system and the feature has been enabled on the user equipment device (e.g., via the Operating System software or application software executing on the user equipment device).

In various embodiments of the invention, UEs unable to find terrestrial wireless service (e.g., UEs which can not directly connect to a terrestrial wireless base station) will enable this feature and then be able to reach or communicate with satellite(s) of a satellite system. These satellites of the satellite system are then able to track the UEs that is they are able to identify the exact position/location of the UEs on the earth and track their movements and/or change of position/location. This location tracking information which includes the movement of the UEs is then shared with the terrestrial mobile or wireless network system which forms a grid of communication using the user equipment devices with which it has direct wireless communications to support indirect wireless communications to the user equipment devices that are not receiving wireless terrestrial service because they are not within the coverage of the terrestrial mobile or wireless network system. This is achieved using user equipment device to user equipment device wireless communications. User equipment devices within the coverage of the terrestrial wireless network system provide wireless device-to-device links/connections to user equipment devices which are out of the coverage of the terrestrial wireless network system.

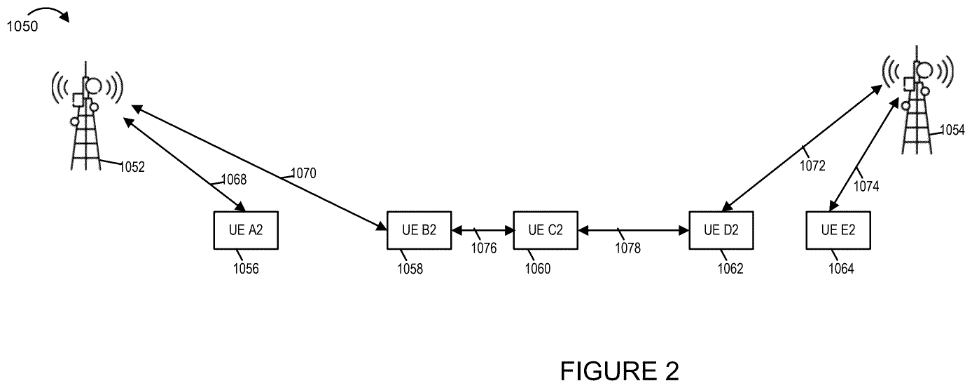

FIG. 2 diagram 1050 illustrates the limited coverage of a terrestrial mobile or wireless network system. The terrestrial mobile or wireless network system wireless base station 1052 has UE A2 1056 and UE B2 1058 within its coverage and can communicate with them via direct wireless communications links 1068 and 1070 respectively. The terrestrial mobile or wireless network system wireless base station 1054 has UE D2 1062 and UE E2 1064 within its coverage and can communicate with them via direct wireless communications links 1072 and 1074 respectively. UE C2 1060 is not within the coverage area of terrestrial mobile or wireless network system as it is outside the coverage of wireless base station 1052 and 1054. However, as shown UE C2 1060 can be connected to UE B2 1058 via device-to-device wireless communications link 1076 or to UE D2 1062 with device to device wireless link 1078.

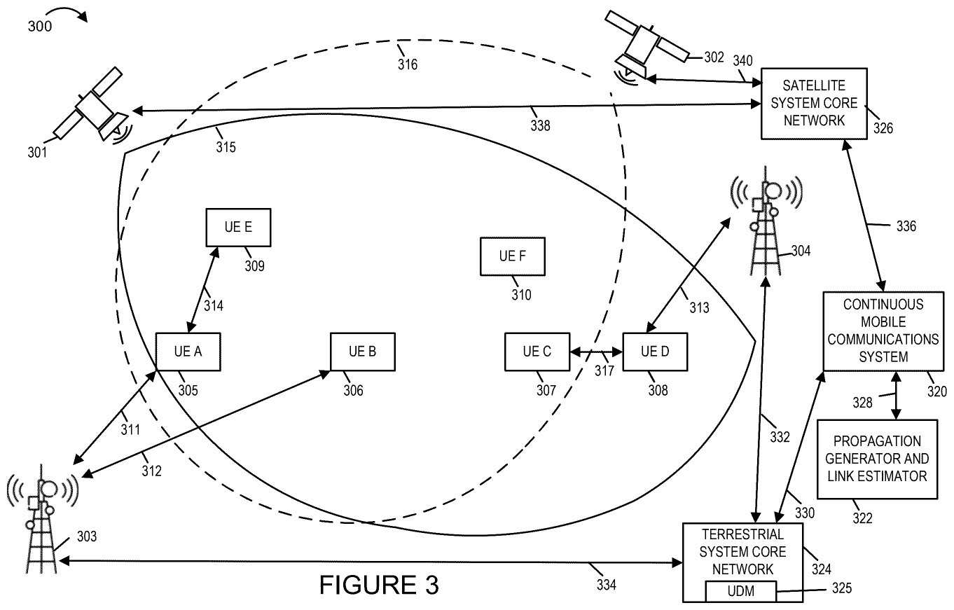

FIG. 3 illustrates an exemplary system 300 in accordance with an embodiment of the present invention. System 300 includes a satellite system, a terrestrial wireless system, a continuous mobile communications system 320, a propagation generator and link estimator 322, a plurality of user equipment devices (UE A 305, UE B 306, UE C 307, UE D 308, UE E 309, UE F 310), and a plurality of communications links (311, 312, 314, 330, 332, 334, 336, 338, and 340). The satellite system includes satellite system core network 326, satellite 301 having coverage area 315 and satellite 302 having coverage area 316.

The terrestrial wireless system includes terrestrial wireless bases stations 303 and 304 which are unable to provide wireless coverage to all the user equipment device subscribers in its area while satellites 301 and 302 of a satellite system are able to receive signals from and communicate with subscriber user equipment devices which the terrestrial mobile network cannot (e.g., UE C 307 and UE F 310). The terrestrial wireless base station 303 is shown as directly communicating with UE A 305 via direct wireless communications link 311. The terrestrial wireless base station 303 is shown as directly communicating with UE B 306 via direct wireless communications link 311. UE E 309 is shown as being wirelessly connected to the UE A 305 via a device-to-device wireless link 314. The terrestrial wireless base station 304 is shown as directly communicating with UE D 308 via direct wireless communications link 1013. UE C 307 and UE F 310 are not within the coverage of either terrestrial wireless base station 303 or terrestrial wireless base station 304. The satellite 301 has a coverage area 315 which includes UE A 305, UE B 306, UE C 307, UE D 308, UE E 309, and UE F 310. The satellite 302 has a coverage area 316 which includes UE A 305, UE B 306, UE C 307, UE E 309, and UE F 310.

The user equipment devices are wireless devices such as for example smartphones, mobile phones, tablets, laptops, personal digital assistants. Each of the user equipment devices supports and is subscribed to the terrestrial wireless network service offered by the terrestrial system to which wireless base station 303 and 304 are a part. A subset of the plurality of user equipment devices are dual subscriber dual capability devices with subscriptions to the terrestrial wireless system and the satellite wireless system and have the capability to operate using multiple wireless technologies (e.g., multi-Radio Access Technologies) including satellite wireless technology and terrestrial wireless technology. In some embodiments, a plurality of the user equipment devices are terrestrial only user equipment devices which do not have subscriptions to the satellite service. In some embodiments, all of the UEs are dual subscriber dual capability devices with the capability to operate using both the terrestrial wireless system and the satellite wireless system. The dual subscription dual capability user equipment devices of system 300 have the terrestrial wireless system as their primary wireless system and the satellite wireless system as their secondary wireless system. A plurality of the subset of dual subscription dual capability user equipment devices are subscribed to a satellite assisted essential communication service for user equipment devices with no terrestrial connectivity. This service provided only essential satellite service for obtaining and providing location and tracking information for user equipment devices without terrestrial wireless connectivity. This service utilizes minimum satellite resources and costs less than satellite voice communications. The user equipment devices satellite communications capabilities (e.g., receiving and transmitter and/or software application) remain disable until terrestrial wireless connectivity is lost at which time the user equipment device enables the satellite assisted essential communications service. After terrestrial wireless connectivity is restored, the satellite assisted essential communications service is disabled. Hence, the satellite service is minimized.

The communications link 328 couples and/or connects the CMCS 320 to the propagation generator and link estimator 322. The communications link 330 couples and/or connects the terrestrial core network 324 to the CMCS 320. The communications link 332 couples and/or connects the terrestrial system core network 324 to the wireless base station 304. The communication link 1034 couples and/or connects wireless base station 303 to the terrestrial system core network 324. The communications link 336 couples and/or connects the CMCS 320 to the satellite core network 326. The wireless communications link 338 couples and/or connects the satellite 301 to the satellite system core network 326. The wireless communications link 340 couples and/or connects the satellite 302 to the satellite system core network 326. The communications links 328, 330, 332, 334, 336 are typically wired or optical high speed links.

An important part of the overall communications system 300 is the Continuous Mobile Communications System 320 which interacts with both the satellite system and terrestrial wireless system. The CMCS 320 determines which user equipment devices are without coverage by using data available from both the satellite system and the terrestrial wireless communications system. The CMCS 320 will determine which of the user equipment without terrestrial service have the satellite assisted essential communication subscribed and determine and track their location. Based on the location of these user equipment devices, the CMCS 320 will determine the best user equipment device to connect it to the terrestrial wireless system via a terrestrial wireless device-to-device (D2D) connection. The CMCS 320 makes the decision/determination of which of the user equipment devices is the best user equipment device for the device-to-device connection based on data obtained from the terrestrial core network 324, the satellite core network 326, and the propagation generation and link estimator 322 factoring in various communications parameters such as for example distance between user equipment devices, signal interference, modulation rates, load on the network, load on the user equipment device under consideration, user equipment device category of the user equipment device without terrestrial wireless connectivity, user equipment device capabilities of the user equipment device without terrestrial wireless connectivity, user equipment device type of the user equipment device without terrestrial wireless connectivity, user equipment device category of user equipment device under consideration, user equipment device capabilities of the user equipment device under consideration, user equipment device type of the user equipment device under consideration, information on the wireless links of the network, movement (direction and/or speed) of the user equipment without terrestrial wireless connectivity, movement (direction and/or speed) of the user equipment device under consideration, contracted for quality of service of the user equipment device without terrestrial connectivity, contracted for quality of service of the user equipment device under consideration, etc.

The propagation generator and link estimator 322 in various embodiments utilize one or more or all or any combination of the following: locations of the UEs, distance between UEs, interference, modulation rates, load on the network, load on the UEs, terrain and clutter information, and propagation models to determine link propagation loss estimates for the potential wireless D2D links and provide UE candidate(s) for the wireless D2D link to the Continuous Mobile Communications system. In addition to the UE candidates for the wireless D2D link to be established to a UE without terrestrial wireless connectivity the propagation generator and link estimator also provides a report on the wireless links of the terrestrial system and the potential wireless D2D links that can be established with each of the UE candidates.

In the example shown in FIG. 3, the UE C 307 does not terrestrial wireless connectivity with the terrestrial wireless system as it is not receiving a signal from either the terrestrial wireless base station 303 or the terrestrial wireless base station 304 (e.g., because it is not within their coverage because clutter or terrain is blocking the terrestrial wireless base station signals or the UE C 307's signal to the wireless base station. The UE C 307 enabled its satellite assist capability and send signals to and/or communicates with satellite 301 and/or satellite 302. The satellite system based on the received signals and/or communications with the UE C 307 determines the location of UE 7 307 (e.g., satellite 301, 302, or satellite system core network 326 which receives reports/information from the satellites 301 and 302 on the signals/communications received from UE C 307 determines the location of UE C 307) and begins tracking the location of UE 7 307 and obtaining information on its movements (speed and direction being determined for example based on change in location and position over time). The satellite system core network 326 reports the location of the UE C 307 and the tracking information to the Continuous Mobile Communication System 320. The terrestrial system core network 324 on losing wireless connectivity with UE C 307 reports the loss of connectivity to the Continuous Mobile Communications System 320. The CMCS 320 determines from the Unified Data Management (UDM) function 325 of the terrestrial core network 324 that UE C 307 has subscribed to satellite assisted terrestrial wireless services. The CMCS 320 determines based on the tracking information received from the satellite system core network 326 that the UE C 307 is stationary or moving at a speed less than a satellite assist D2D link threshold speed value. Upon determining that the UE C 307 is moving at a speed less than the satellite assist D2D link threshold speed value, the CMCS determines that UE C 307 is a candidate for providing a satellite assisted terrestrial wireless D2D link to re-establish terrestrial wireless connectivity for UE C 307. If UE C 307 was moving at a speed equal to greater than (that is a speed not less than) the satellite assist D2D link speed threshold value, the CMCS 320 would determine that the UE C 307 is not a candidate for providing a satellite assisted terrestrial wireless D2D link as it is moving too fast. A user equipment device which is moving too fast will likely have D2D link issues and a poor user experience as the D2D link will likely be dropped as the user equipment devices move for example away from one another or into locations where the D2D link experiences propagation losses or interference from clutter or terrain causing problems with signal interference or attenuation resulting in an inadequate, sub-par, or lost D2D link/connection.

In this example as discussed above, the CMCS 320 has determined that the UE C 307 is a candidate for satellite assisted D2D terrestrial wireless service. In response to this determination the CMCS 320 sends a request to the Propagation Generator and Link Estimator to provide best UE candidates for providing a terrestrial wireless D2D connection to UE C 307 and link reports for the terrestrial wireless system including reports on the link propagation estimates for the candidate terrestrial wireless D2D links which would be established between UE C 307 and the determined best UE candidates.

The propagation generator and link estimator 322 using the location information for UE 7 307 included in the request as one or more or all or any combination of the following: locations of the UEs with terrestrial wireless connectivity, distance between UEs, interference, modulation rates, load on the network, load on the UEs, terrain and clutter information, and propagation models determines link propagation loss estimates for the potential wireless D2D links and best UE candidate(s) for the wireless D2D link to the Continuous Mobile Communications system. In addition to the best UE candidates to establish the wireless D2D link to the UE C 307, the propagation generator and link estimator also generates a report on the wireless links of the terrestrial system and the potential wireless D2D links that can be established with each of the identified UE candidates. The propagation generator and link estimator 322 sends a response with the identified/determined best UE candidates for the terrestrial wireless D2D connection and the generated report on the links.

The CMCS 320 receives the response from the propagation generator and link estimator and makes a decision/determination of which of the identified best UE candidates is the best UE for providing the terrestrial wireless D2D link to UE C 307. The CMCS 320 decision takes into account various factors as discussed above including the information included in the report on the wireless links as well as one or more of the following: signal interference, modulation rates, load on the network, load on the user equipment device under consideration, user equipment device category of the user equipment device without terrestrial wireless connectivity, user equipment device capabilities of the user equipment device without terrestrial wireless connectivity, user equipment device type of the user equipment device without terrestrial wireless connectivity, user equipment device category of user equipment device under consideration, user equipment device capabilities of the user equipment device under consideration, user equipment device type of the user equipment device under consideration, information on the wireless links of the network, movement (direction and/or speed) of the user equipment without terrestrial wireless connectivity, movement (direction and/or speed) of the user equipment device under consideration, contracted for quality of service of the user equipment device without terrestrial connectivity, contracted for quality of service of the user equipment device under consideration, etc. In some embodiments, the determination based on the terrestrial network policies and/or using a weighted factoring system where the different items being considered are provided different weights to generate a score for each candidate UE and then determining the best UE based on the UE scores. In some embodiments, one or more of the above factors may be taken into account by the Propagation and generator link estimator and in such instances the CMCS 320 does not consider it again such as for example weighting the factor with a 0. In this example, the propagation generator and link estimator 1022 determines that the UE B 306 and UE D 308 are the best two candidates for providing a satellite assist terrestrial wireless device-to-device connection to UE C 307 based on the above factors (e.g., UE B 306 and UE D 308 are the two user equipment devices with direct terrestrial wireless connectivity that are in the proximity of the UE C 307 and will have estimated D2D links with acceptable propagation losses. The UE D 308 is closer to UE C 307 than UE B 306 and will have less propagation loss on a wireless D2D link established between UE D 308 and UE C 307 and this reported to the CMCS 320 by the propagation generator and link estimator.

The CMCS 320 using the information provided by the propagation generator and link estimator 1022 and other information such as the UE categories of the UE C 307, UE B 306, and UE D 308 and the terrestrial wireless system policies determines UE D 308 is the best UE candidate for establishing the satellite assisted terrestrial wireless device-to-device connection to the UE C 307.

The CMCS 320 then generates instructions for the UE D 308 to establish the satellite assisted terrestrial wireless device-to-device communications link to the UE C 307. The instructions includes information on the radio resources to be used for the D2D connection including for example the radio frequencies and/or amount of bandwidth to used. The CMCS 320 sends these instructions to the terrestrial system core network 324. The CMCS 320 sends the instructions to the terrestrial wireless base station 326 which sends the instructions to the UE D 308. The UE D 308 in response to receiving the instructions establishes the satellite assisted terrestrial wireless device-to-device link 317 to the UE C 307 in accordance with the instructions. Once the satellite assisted terrestrial wireless device-to-device link 317 has been established, UE C 307 receives terrestrial wireless services from the terrestrial wireless base station 304 via the D2D link 317, UE D 308, and wireless communications link 313 which wirelessly connects UE D 308 to the wireless base station 304. When the UE C 307 changes position the satellite system core network 1026 will notify the CMCS 320 of the change in position and the CMCS 320 can determine whether a different UE should be used for a new D2D connection to the UE C 307. This may occur for example if the UE C 307 moves toward UE B 306 and out of the range of UE D 308. In various embodiments, the link capacity of wireless links 312 and 313 which are links from the UE candidates to their respective base station are included in the link report and considered by the propagation generator and link estimator 322 and/or the CMCS 320 when determining the best UE or best UE candidates to provide the D2D services to UE C 307.

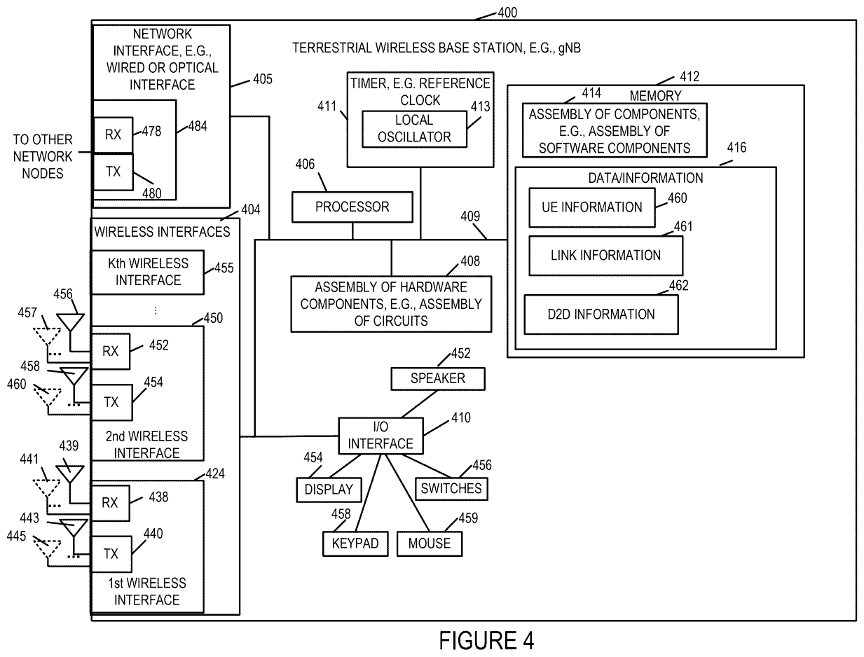

FIG. 4 illustrates an exemplary terrestrial wireless base station 400 in accordance with an embodiment of the present invention. The exemplary terrestrial wireless base station will be discussed in further detail below.

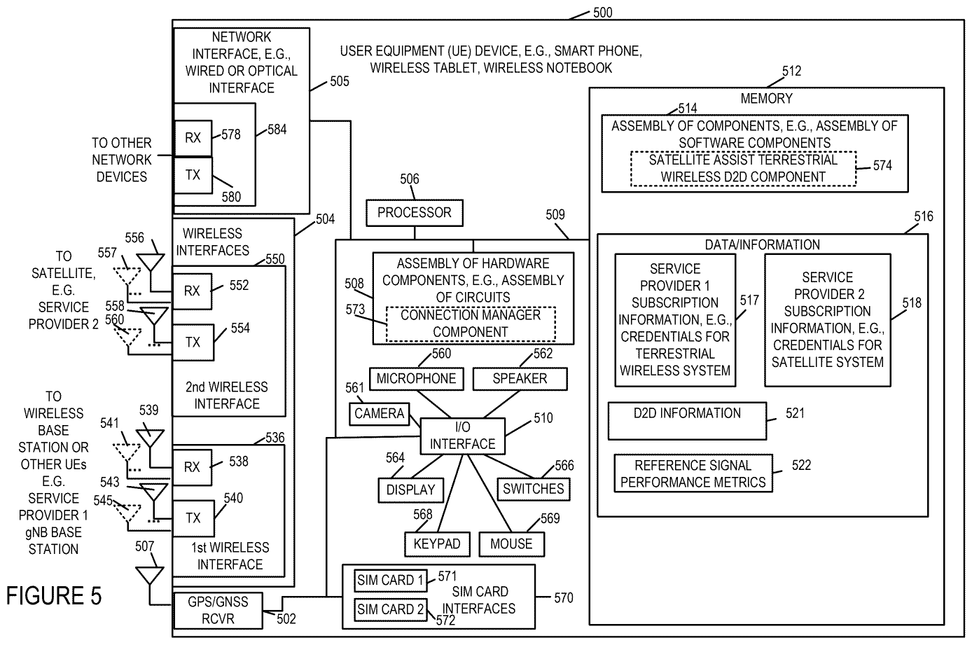

FIG. 5 illustrates an exemplary user equipment device (UE) 500 in accordance with an embodiment of the present invention. The exemplary terrestrial wireless base station will be discussed in further detail below.

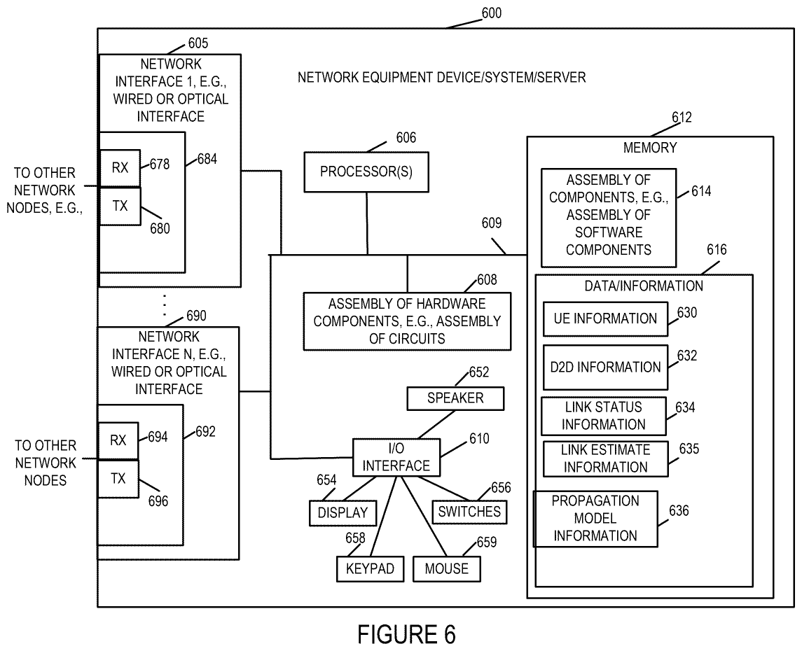

FIG. 6 illustrates an exemplary network equipment device/system 600 (e.g., Continuous Mobile Communications System (CMCS), terrestrial core network system, satellite communications ground system, satellite core network system, Propagation Generator and Link Estimator, storage system) in accordance with an embodiment of the present invention. The exemplary network equipment/system will be discussed in further detail below.

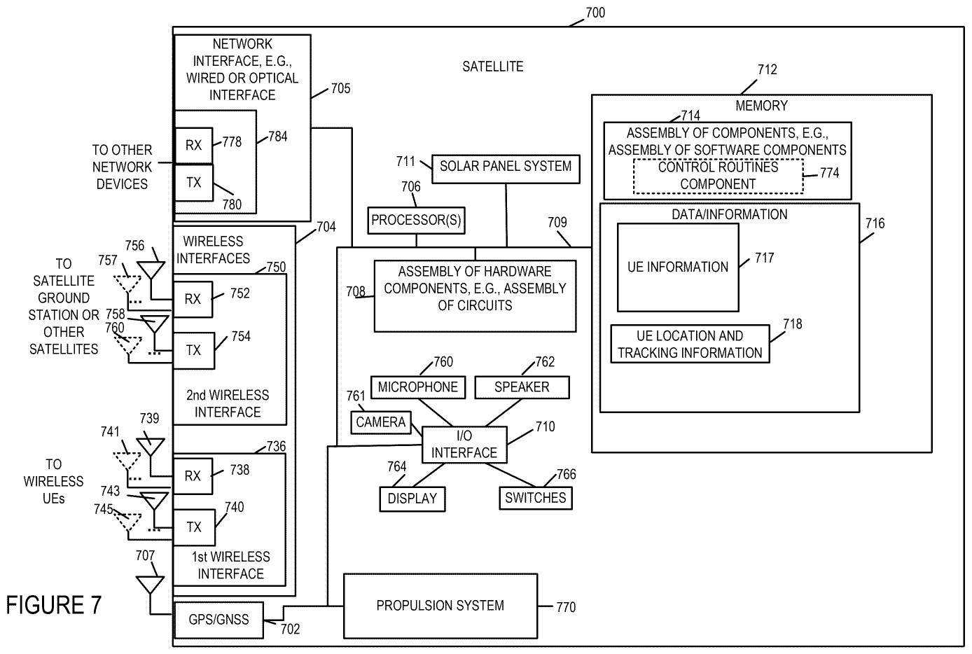

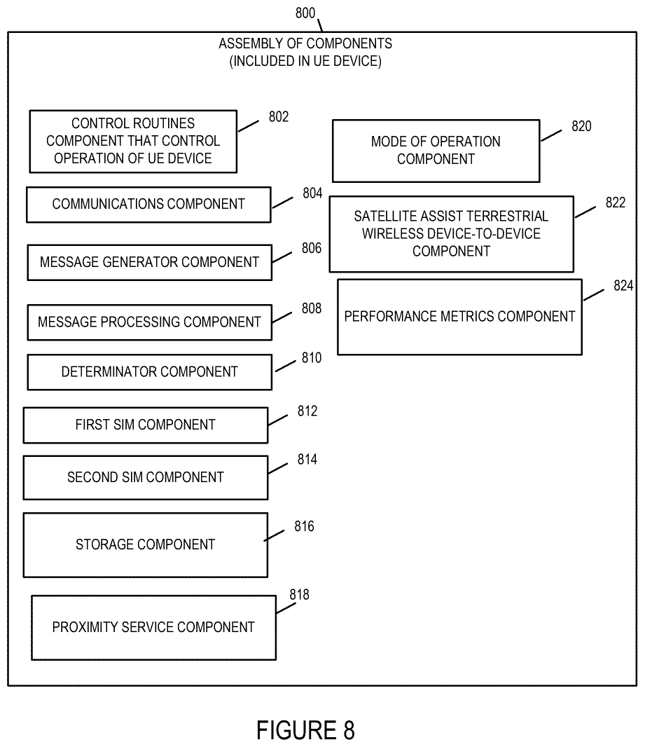

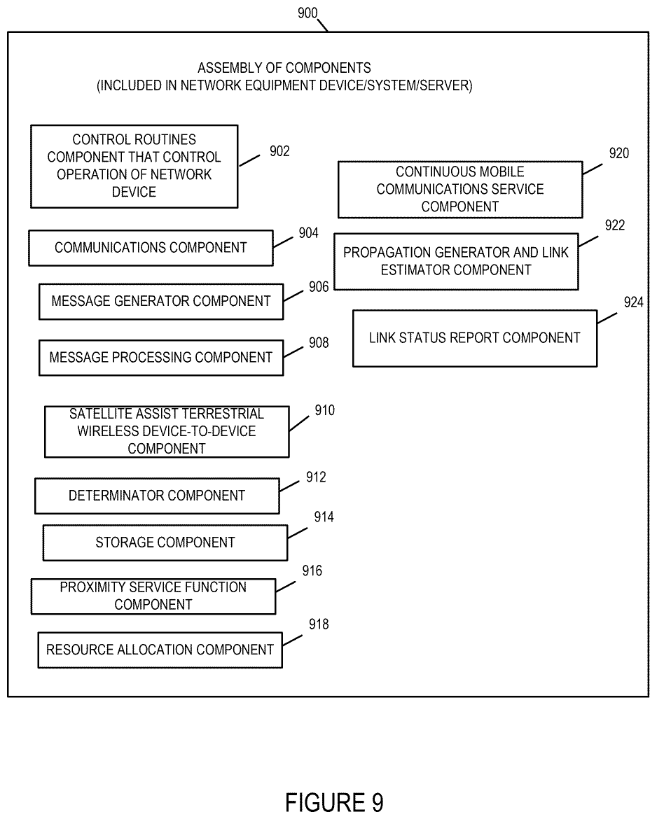

FIG. 7 illustrates details of an exemplary satellite 700 in accordance with an embodiment of the present invention. The exemplary satellite 700 will be discussed in further detail below. FIG. 8 illustrates an exemplary assembly of components 800 for a user equipment device in accordance with an embodiment of the present invention. The assembly of components 800 will be discussed in further detail below. FIG. 9 illustrates an exemplary assembly of components for a network equipment device/system/server in accordance with an embodiment of the present invention. The assembly of components 900 will be discussed in further detail below.

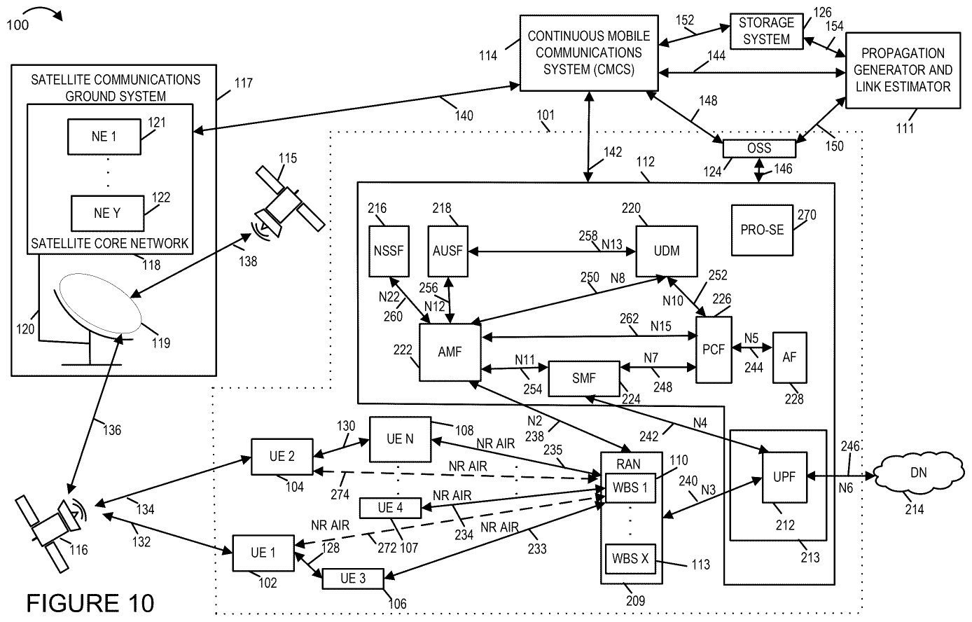

FIG. 10 illustrates an another exemplary system 100 implemented using satellite technology and terrestrial wireless technology (e.g., 5G technology) in accordance with an embodiment of the present invention. System 100 includes a terrestrial wireless system 101 (e.g., a 5G wireless network system operated by a wireless network operator (e.g., Charter Communications), a satellite system (e.g., a satellite communications system with voice/data communications and position/location tracking capabilities), a Continuous Mobile Communications System (CMCS) 114, a storage system 126, a propagation generator and link estimator 111 a data network (e.g., the Internet) and a plurality of communications links which couple and/or connect the elements of the system 100 so that they can communicate and/or exchange information and data.

The use of 5G technology in system 100 is merely exemplary and for the sake of clarity in explaining the invention. It should be understood that the invention is not limited to 5G technology but may be, and in some embodiments is, implemented using other wireless technologies, e.g., 4G, LTE, etc. (e.g., with respect to the terrestrial wireless system 101. The terrestrial wireless system 101 is a land based system that provides wireless services via land based wireless base stations. The exemplary terrestrial wireless system 101 includes a terrestrial wireless core network 112, a Radio Access Network 209, a User Plane 213, Operational Support Systems (OSS) 124, a plurality of user equipment devices (UE 1 102, UE 2, 104, UE 3, 106, UE 4 107, . . . , UE N 108 (N being an integer greater than 4), a plurality of communications links.

The terrestrial wireless network system 101 includes Operational Supports Systems (OSS) 124, a Radio Access Network (RAN) 209 including a plurality of base stations (WBS 1 110, . . . , WBS X 113, X being a positive integer greater than 1), a plurality of user equipment devices (UE 1 102, UE 2 104, UE 3 106, UE 4 107, . . . , UE N), a terrestrial wireless core network 112 including a control plane and a user plane. The user plane 231 includes the User Plane Function (UPF) 212. The control plane includes a Network Slice Selection Function (NSSF) 216, an Authentication Server Function (AUSF) 218, a Unified Data Management Function (UDM) 220, an Access and Mobility Management Function (AMF) 222, a Session Management Function (SMF) 224, a Policy Control Function (PCF) 226, an Application Function (AF) 228, and Proximity Service (PRO-SE) function 270. The Pro-Se function 270 is coupled/connected via communications link(s) to one or more or any combination of the other functions and/or elements in the terrestrial core network 112. In some embodiments, the Pro-Se function 270 is implemented outside of the terrestrial core network but is coupled to the terrestrial core network via communications link. In the exemplary embodiments, the Pro-Se function which provides device-to-device services is considered to be part of the terrestrial core network. In some embodiments, the one, some or all of the functions of the terrestrial core network 112 are implemented as hardware components, software components or a combination of hardware and software components.

The user plane function (UPF) component 212 of the wireless network is coupled to a Data Network (DN) 214, e.g., the Internet. The base stations (e.g., WBS 1 110, . . . , WBS X 113) of the Radio Access Network 209 may be, and in some embodiments are, gNodeBs.

The user equipment devices (UE 1 102, . . . , UE 2 104, UE 3 106, UE 4 107, . . . , UE N) are multi-function wireless devices such as for example mobile devices (e.g., smart phones, laptops, mobile phones, tablets, etc.) which can connect to/wireless communicate with the RAN 209 as well as the plurality of satellites (satellite 115, . . . , satellite 116) of the satellite system of system 100. These multi-function wireless devices support a plurality of different wireless protocols and radio frequencies (e.g., satellite, cellular, CBRS, and Wi-Fi protocols and radio frequencies used by these protocols). In some embodiments, only a subset of the plurality of user equipment devices of the terrestrial wireless system 101 are multi-function wireless devices (e.g., UE 1 102 and UE 2 104) that support both satellite and terrestrial wireless communications and are subscribed to both wireless services while the remaining user equipment devices support only terrestrial wireless communications (e.g., communications with the wireless base stations of the RAN 209) or are only subscribed to terrestrial wireless communications services.

In some embodiments, one or more or any combination of the Propagation Generator and Link Estimator 111, Continuous Mobile Communications System 114, OSS 124, storage system (e.g., data base system) 126 are functions, nodes or devices which are implemented in a cloud. In some embodiments, the CMCS 114 and/or the Propagation Generator and Link Estimator 111 is implemented as a function or service in a cloud.

The RAN 209 operates using spectrum licensed or generally available to the terrestrial wireless system 101.

The satellite communications system of system 100 includes a plurality (satellites 115, . . . , satellite 116) and one or more satellite communications ground systems. Satellite communications ground system 117 being an exemplary satellite communications ground system of the satellite communications system. The satellite communications ground system including a satellite core network 118 including a plurality of network equipment device (NE 1 121, . . . , NE Y 122, Y being an integer greater than 1), a satellite antenna 119 and a plurality of communications links (120, 136, 138, 140). The network equipment devices 1 121, . . . , Y 122 receive, transmit and process communications signals and information including for example signals to establish connections with the satellites and UE devices being served by the satellites and track UE device location, position and movement as well as in various embodiments provide voice and/or data communications services to UE devices which have subscribed to such services. The network equipment device 1 121, . . . , Y 122 also provide information to the CMCS 114 including UE identification information and location/position, movement and position tracking location. The communications link 120 coupling and/or connecting the satellite antenna 119 to the satellite core network 118. The communications link 136 coupling and/or connecting the satellite 116 to the satellite antenna 119. The communications link 138 coupling the satellite 115 to the satellite antenna 119. The communications link 140 coupling and/or connecting the satellite communications ground system (e.g., satellite core network 118) to the CMCS 114. The communications links allowing the elements of the satellite system to exchange information and/or instructions. The communications links 120 and 140 are typically cable (e.g., high speed wired or optical) communications links but can be wireless communications links. The communications links 136 and 138 are wireless communications links. The communications link 140 is used for communicating and/or sharing information about the user equipment devices with the CMCS including UE identification information, UE position/location and tracking information. Such information includes for example location/position information which includes UE geographic coordinates with timestamp and change of location/position with timestamp and/or movement information (e.g., speed, direction, velocity, acceleration, etc.).

The communications link 142 couples and/or connects the terrestrial wireless core network 112 with the CMCS 114. The communications link 144 couples and/or connects the CMCS 114 to the Propagation Generator and Link Estimator 111. The communications link 146 couples and/or connects the OSS 124 to the terrestrial core network 112. The communications link 148 couples and/or connects the CMCS 114 to the OSS 124. The communications link 150 couples and/or connects the OSS 146 to the Propagation Generator and Link Estimator 111. The communications link 152 couples and/or connects the CMCS 114 to the storage system 126. The communications link 126 couples and/or connects the storage system 126 to the Propagation generator and Link Estimator 111. The communications links 140, 142, 144, 146, 148, 150, 152, and 154 are typically cable (e.g., high speed wired or optical) links. In some embodiments, one or more or any combination of these links is implemented as a wireless communications link.

The storage system 126 in some embodiments is used as common storage for the CMCS 114 and the Propagation Generator and Link Estimator 111. The CMCS for example storing information such as for example terrestrial wireless system 101 UE connectivity/connection information, terrestrial wireless system link status information, terrestrial wireless system link assignment information, UE device capabilities information, UE subscription information, UE position/location information (e.g., from satellite system and terrestrial system), UE device-to-device information, and terrestrial wireless system radio frequency resource usage/availability. In some embodiments this information is received by the CMCS 114 from the terrestrial wireless system (e.g., from the terrestrial wireless core network 112 or the OSS 124) and/or the satellite core network 118 and is used by the Propagation Generator and Link Estimator to determine and/or identify UEs and link resources available for device-to-device connections using propagation modeling and link estimations as explained in further detail below.

It will be understood that the various functions of the system may be implemented in a variety of ways as components, servers, devices, nodes, entities, etc. The components of the system 100 are coupled and/or connected via communications links using various interfaces as shown in FIG. 2 including New Radio Air Interface 233, 234, . . . , 235, 271 and 272, N3 interface 240, N4 interface 242, N5 interface 244, N7 interface 248, N8 interface 250, N10 interface 252, N11 interface 254, N12 interface 256, N13 258, N22 interface 260, N15 interface 262, so that they can exchange information, data, and messages.

Satellite wireless communications link 132 connects UE 1 102 to the satellite 116. The satellite wireless communications link 134 connects UE 2 104 to the satellite 116. These satellite communications links 132 and 134 are only implemented when the UEs have satellite communications enabled as will be discussed in further detail below. The terrestrial wireless communications link 128 is a device-to-device wireless communications link wirelessly connecting the UE 1 102 to UE 3 106. The terrestrial wireless communications link 130 is a device-to-device wireless communications link wirelessly connecting the UE 2 104 to UE N 108.

The terrestrial wireless communications link 272 wirelessly connects the UE 1 102 to the wireless base station 1 of the RAN 209. The terrestrial wireless communications link 274 wirelessly connects the UE 2 104 to the wireless base station 1 of the RAN 209. Terrestrial wireless communications links which connect a UE directly to a wireless base station such as wireless links 233, 234, . . . , 235, and wireless links 272 and 274 are sometimes referred to herein as direct wireless communications links as UE wirelessly communications directly with the wireless base station. The terrestrial wireless links 233, 234, . . . , 235 connect UE 3 106, UE 4 107, . . . , UE N 108 respectively to the wireless base station 1 110. The UEs shown are system 100 are connected to the WBS 1 110 for simplicity. In various embodiments, various UEs will be wirelessly connected to the different wireless base stations of the RAN 209 depending on a variety of factors including signal strength, signal interface, and load conditions.

In various embodiments, the satellite communications links 136 and 138 are minimal bandwidth links that are used determining UE position/location information and tracking of position but not for voice communications. The UE position/location information and tracking information is then reported from the satellite core network 118 to the CMCS 114 which uses it to assist the UE to obtain a terrestrial wireless connection as will be discussed in further detail below.

UE 1 102, UE 2 104, UE 3 106, UE 4 107, . . . , UE N 108 utilize New Radio (NR) air interfaces to communicate with the base stations of the Radio Access Network 209. For example, UE 1 102, UE 2 104, UE 3 106, UE 4 107, . . . , UE N 108 utilize N1 interfaces to communicate with the AMF 222 when communicating via the terrestrial wireless network. While only a few user equipment devices are illustrated as being connected to the base stations of the first Radio Access Network 209 in practice a large plurality (e.g., thousands) of user equipment devices (e.g., mobile devices) may be, and in some embodiments are, connected to first RAN 209. The UPF 212 utilizes the N6 246 interface to communicate with the Data Network 214.

The communications links 120, 140, 142, 144, 146, 148, 150, 152, 154, 238, 240, 242, 244, 246, 248, 250, 252, 254, 256, 258, 260, and 262 are typically high speed wired, optical or fiber optic communications links. While physical communications links are shown in system 100 in some embodiments, the communications links are logic communications links which represent connections and/or interfaces.

The communications links and interfaces shown in FIG. 10 are exemplary and the functions/components of the system 100 may be, and in some embodiments are, coupled and/or connected using a different configuration and/or interfaces.

In some embodiments, one or more or any combination of the functions and/or devices of the terrestrial wireless system 101 are implemented on one or more or any combination of compute nodes in a cloud system. For example, in some embodiments, the CMCS 114 and Propagation Generator and Link Estimator 111, are implemented on separate compute nodes in a cloud system.

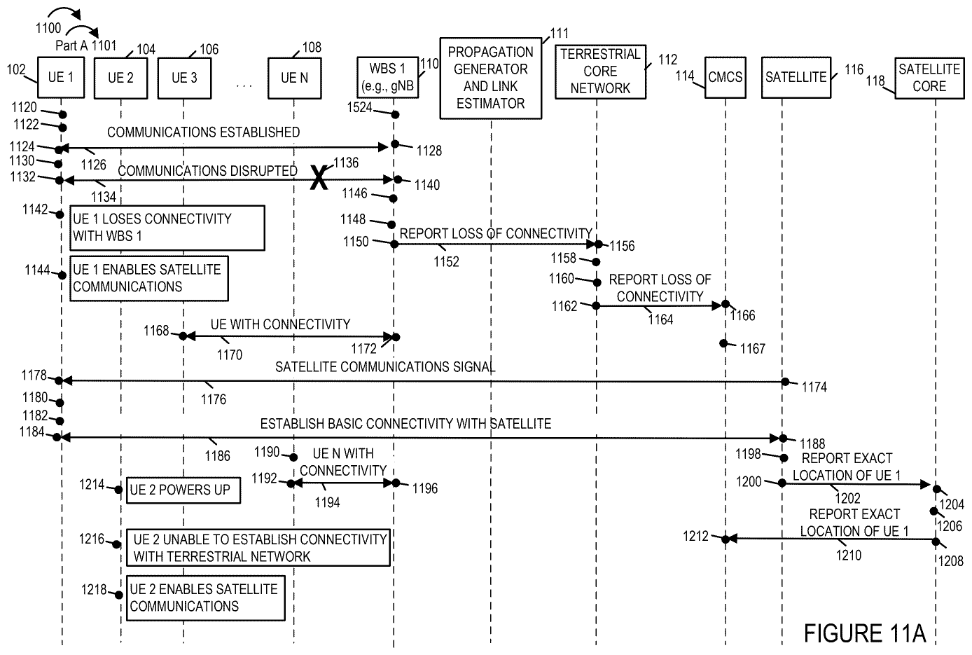

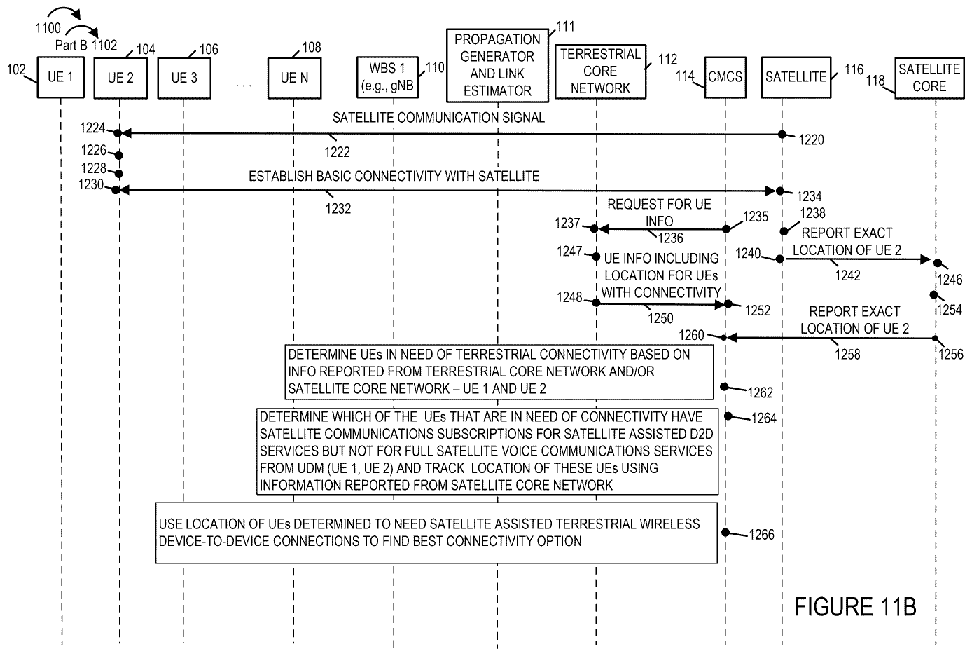

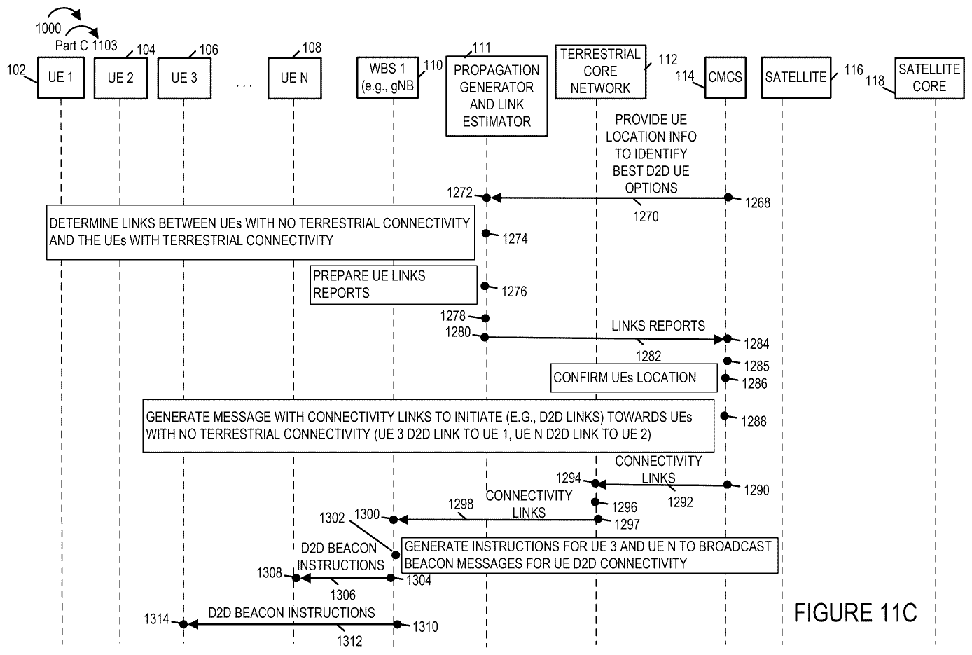

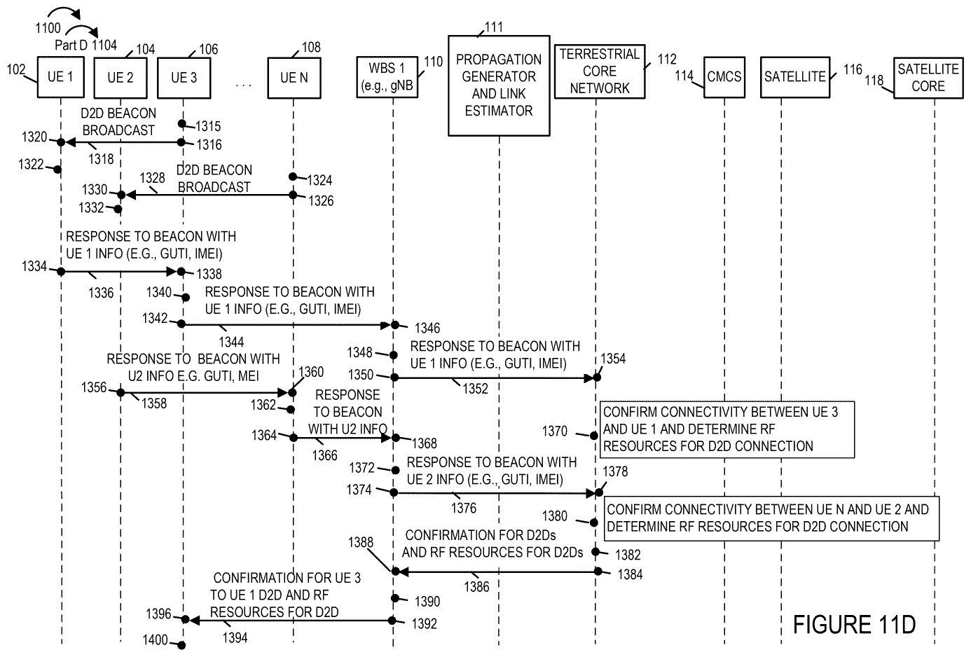

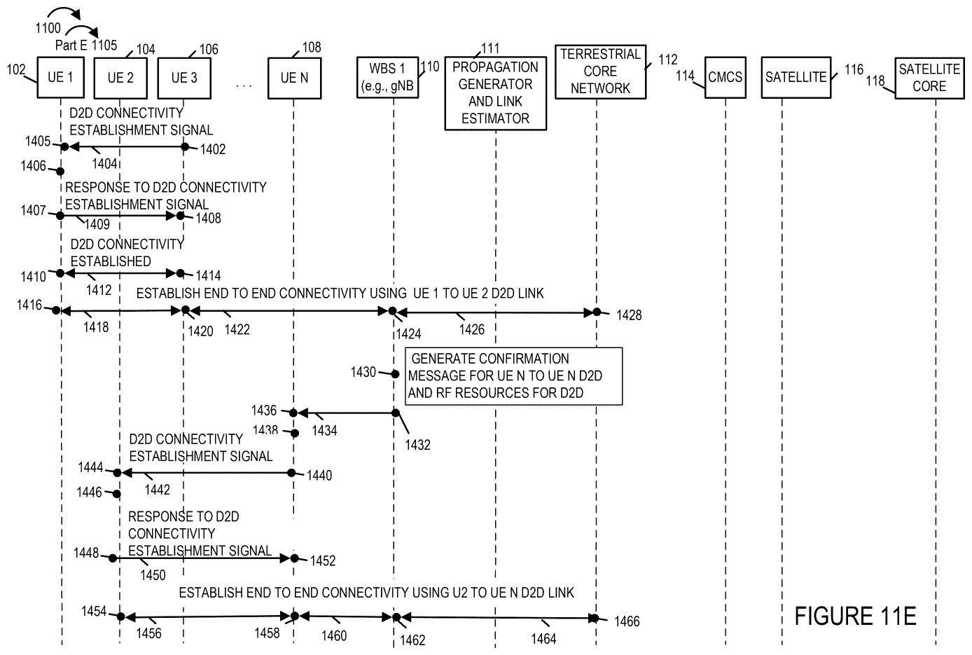

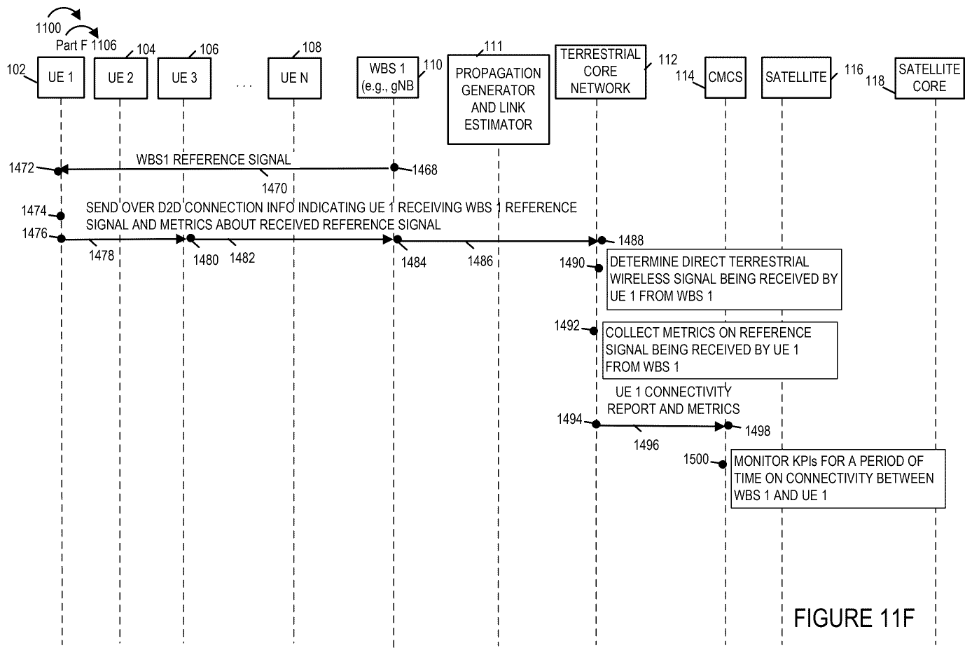

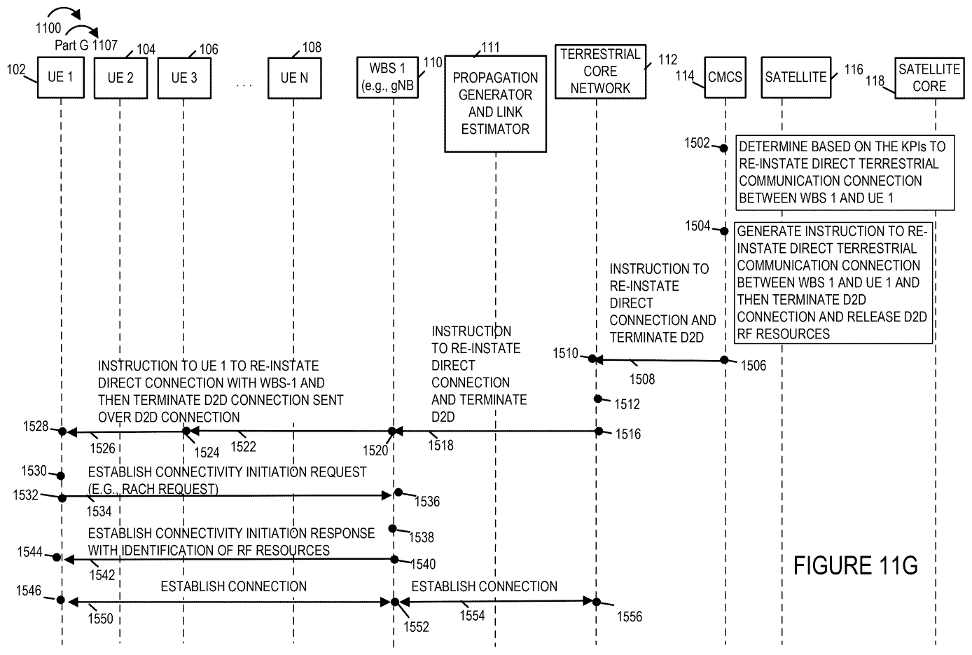

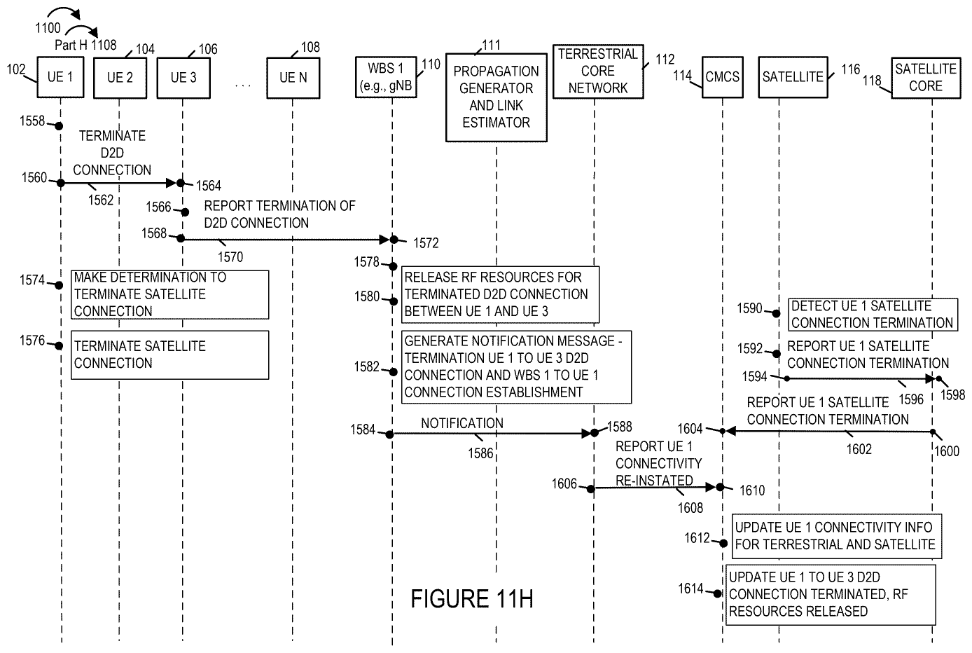

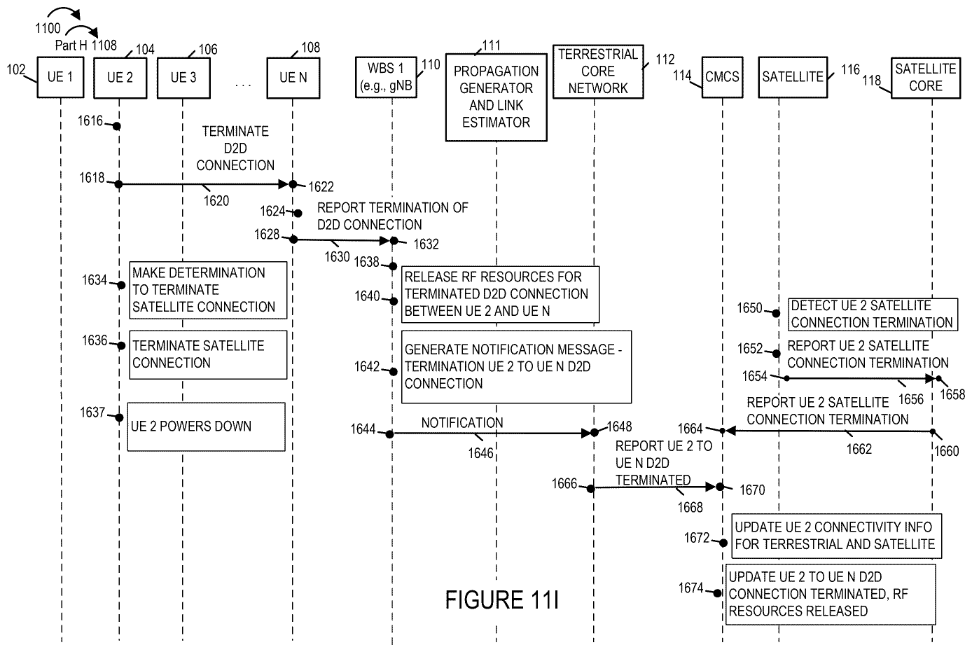

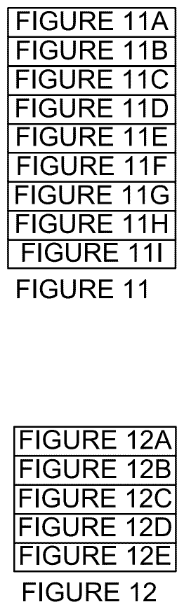

FIG. 11 comprises FIG. 11A, FIG. 11B, FIG. 11C, FIG. 11D, FIG. 11E, FIG. 11F, FIG. 11G, FIG. 11H, FIG. 11I, FIG. 11J, and FIG. 11K. FIG. 11A is the first part (Part A 1101) of a signaling diagram which illustrates the steps and signaling of an exemplary method in accordance with an embodiment of the present invention. FIG. 11B is the second part (Part B 1102) of a signaling diagram which illustrates the steps and signaling of an exemplary method in accordance with an embodiment of the present invention. FIG. 11C is the third part (Part C 1103) of a signaling diagram which illustrates the steps and signaling of an exemplary method in accordance with an embodiment of the present invention. FIG. 11D is the fourth part (Part D 1104) of a signaling diagram which illustrates the steps and signaling of an exemplary method in accordance with an embodiment of the present invention. FIG. 11E is the fifth part (Part E 1105) of a signaling diagram which illustrates the steps and signaling of an exemplary method in accordance with an embodiment of the present invention. FIG. 11F is the sixth part (Part F 1106) of a signaling diagram which illustrates the steps and signaling of an exemplary method in accordance with an embodiment of the present invention. FIG. 11G is the seventh part (Part G 1107) of a signaling diagram which illustrates the steps and signaling of an exemplary method in accordance with an embodiment of the present invention. FIG. 11H is the eighth part (Part H 1108) of a signaling diagram which illustrates the steps and signaling of an exemplary method in accordance with an embodiment of the present invention. FIG. 11I is the ninth part (Part I 1109) of a signaling diagram which illustrates the steps and signaling of an exemplary method in accordance with an embodiment of the present invention. FIG. 11J is the tenth part (Part J 1110) of a signaling diagram which illustrates the steps and signaling of an exemplary method in accordance with an embodiment of the present invention. FIG. 11K is the eleventh part (Part K 1111) of a signaling diagram which illustrates the steps and signaling of an exemplary method in accordance with an embodiment of the present invention.

While it will be readily understood that additional steps and signaling are performed in connection with communicating information, messages, and packets between devices, the method 1100 focuses on and discusses the steps and signaling for understanding the invention. Elements or steps with the same reference numbers used in different figures are the same or similar and those elements or steps will not be described in detail again.

The signaling diagram/method 1100 may be, and in some embodiments is, implemented using exemplary system 100 of FIG. 10. The use of the exemplary system 100 in explaining the signaling diagram/method 1100 is only exemplary and it is to be understood that the signaling diagram/method 1100 can be implemented using other systems and system architectures. For example, system 300 FIG. 3 is another exemplary system on which the method 1100 can be implemented.

The signaling diagram/method 1100 is implemented by a system including a plurality of wireless user equipment devices (UE 1 102, UE 2, 104, UE 3 106, . . . , UE N 108), a plurality of wireless base stations including a first wireless base station 110 also referred to as WBS 1 110 (e.g., a gNB), a terrestrial core network 112, a Continuous Mobile Communication System (CMCS) 114, a plurality of communications satellites including satellite 116, and a satellite core network 118.

The wireless user equipment devices UE 1 102, UE 2, 104, UE 3 106, . . . , UE N 108 are wireless devices such as for example such as by way of example a mobile phone, smart phone, laptop, tablet, computer with wireless capabilities with a first SIM card with credentials to access a first mobile network operator's network and a second SIM card with credentials to access a satellite network.

The method 1100 starts in start step 1120 shown on FIG. 11A. Operation proceeds from start step 1120 to step 1122. In step 1122, the first wireless user equipment device UE 1 102 initiates a wireless connection to the first wireless base station WBS 1 110 in response to receiving a user input at the first user equipment device UE 1 102. Operation proceeds from step 1122 step 1124.

In steps 1124 and 1128, the UE 1 102 and WBS 1 110 generate and exchange messages 1126 to establish a wireless communications link between UE 1 102 and WBS 1 110. In at least one of the UE 1 102 messages (e.g., wireless connection request message) sent to WBS 1 110 as part of establishing the wireless communications link between UE 1 102 and WBS 1 110, the UE 1 102 includes first subscriber credentials stored in its first SIM which the WBS 1 110 receives and verifies. The WBS 1 110 sends a wireless connection response message to the UE 1 102 which identifies radio resources (e.g., RF spectrum) to be used by the UE 1 102 and WBS 1 110 for exchanging information and/or signals (e.g., control signals) in connection with the established wireless communications link. UE 1 102 receives the wireless connection response message and commences utilizing the radio resources (e.g., RF spectrum) to communicate with the WBS 1 110. Operation proceeds from steps 1124 and 1128 once the wireless communications link has been established to step 1130.

In step 1130, UE 1 102 moves to a different location or position from the location or position UE 1 102 was at when it established the wireless communications link with WBS 1 110 in steps 1124 and 1128. Operation proceeds from step 1130 to steps 1132, 1136, and 1140.

In steps 1130 and 1132, UE 1 102 and WBS 1 1140 are exchanging messages 1134 over the established wireless communications link when in step 1136, the wireless communications are disrupted (e.g., UE 1 102 has moved to a location or position outside of the coverage area of WBS 1 110 (and/or there is terrain and/or clutter in the wireless communications path between UE 1 102 and WBS 1 110) resulting from the change in location or position of UE 1 102 due to the movement of UE 1 102 in step 113. Operation proceeds to step 1142.

In step 1142, the UE 1 102 loses connectivity with WBS 1 110 and makes the determination that it has lost connectivity with WBS 1 110 (i.e., the wireless communications link established between UE 1 102 and WBS 1 110 has been lost and the UE 1 102 can not re-establish a connection with WBS 1 110 for example because it is no longer receiving a signal from WBS 1 110 because it is out of WBS 1 110's coverage area and/or clutter/terrain is obstructing the wireless path from UE 1 102 to the WBS 1 110. Operation proceeds from step 1142 to step 1144 and operation proceed from step 1140 to step 1146.

In step 1146, WBS 1 110 determines that the connectivity has been lost with UE 1 102 (e.g., WBS 1 110 determines that it is no longer receiving wireless signals from UE 1 102). Operation proceeds from step 1146 to step 1148. In step 1148, WBS 1 110 generates message 1152 including information indicating that connectivity between WBS 1 110 and UE 1 102 has been lost. The information may also include the last reported location and/or position of UE 1 102 (e.g., GPS coordinates provided by UE 1 102 to WBS 1 110 and/or location information such as map location or GPS coordinates determined by WBS 1 110 based on signaling being received from UE 1 102 and/or information provided by UE 1 102 on neighboring cells/base stations (e.g., information identifying cell Id of cells/base stations from which UE 1 102 is receiving signals that are used for handover or handoff of UE 1 102 from WBS 1 110 to another base station/cell of the terrestrial wireless system). Operation proceeds from step 1148 to step 1150. In step 1150, WBS 1 110 transmits message 1152 to network equipment in the terrestrial core network 112. Operation proceeds from step 1150 to step 1156. In step 1156, network equipment in the terrestrial core network 112 receives the message 1152 from WBS 1 110. Operation proceeds from step 1156 to step 1158. In step 1158, network equipment in the terrestrial core network 112 determines based on the information included in message 1152 that the wireless connectivity between UE 1 102 and WBS 1 110 (e.g., the wireless communications link between UE 1 102 and WBS 1 110) has been lost. Operation proceeds from step 1158 to step 1160. In step 1160, network equipment in the terrestrial core network 112 generates message 1164 based on message 1152. The message 1164 includes information on the loss of connectivity between UE 1 102 and WBS 1 110. In some embodiments, the message includes the last reported location and/or position of UE 1 102 as previously discussed. In some embodiments, the message 1160 is merely a forwarded copy of message 1152. Operation proceeds from step 1160 to step 1162. In step 1162, network equipment in the terrestrial core network 112 transmits the message 1164 to the Continuous Mobile Communication System (CMCS) 114. Operation proceeds from step 1162 to step 1166. In step 1166, the CMCS 114 receives and processes the message 1164. Operation proceeds from step 1166 to step 1167. In step 1167, the CMCS 114 updates a record for UE 1 102 indicating that it has lost connectivity with WBS 1 110. When the last known location and/or position of the UE 1 102 has been provided, the record is also updated with this information. In some embodiments, the record and/or the location information for UE 1 102 is stored in memory of the CMCS 114 or in a database or storage system coupled and/or connected to the CMCS 114 that is used to track UE location information received from the terrestrial wireless network and/or the satellite wireless network for UEs of the terrestrial system.

Turning to steps being performed by UE 3 106, in step 1168 the UE 3 106 exchanges messages 1170 with WBS 1 110 for initiating and establishing wireless connectivity (e.g., a wireless communications link) between UE 3 106 and WBS 1 110. In step 1172, WBS 1 110 exchanges messages 1170 with UE 3 106 as part of establishing wireless connectivity between UE 3 106 and WBS 1 110. Exchanging messages for establishing wireless connectivity including the UE 3 106 generating and transmitting messages to WBS 1 110 and receiving and processing messages for the WBS 1 110. For example, UE 3 106 generates and transmits a wireless connection request message including subscription credentials to the WBS 1 110. The WBS 1 110 receives and processes the wireless connection request message. The WBS 1 110 determines that the UE 3 106 is subscribed to the terrestrial wireless network service based on the UE 3 subscription credentials and transmits a wireless connection response message to UE 3 106 with radio resources (e.g., RF spectrum) to be utilized for the wireless communications between the UE 3 106 and WBS 1 110. The UE 3 106 receives and processes the message with the radio resources. The UE 3 106 and WBS 110 have established wireless connectivity and begin to utilize the radio resources to wirelessly communicate information and signals to each other.

Returning to operations occurring at UE 1 102, in step 1144, UE 1 102 in response to detecting and/or determining the loss of the connectivity with WBS 1 110 enables the UE 1 102 satellite communications functionality (e.g., hardware circuitry) and/or application. Operations proceed from step 1144 to step 1174. In step 1174, the satellite 116 transmits/broadcasts a satellite communications signal 1176. In some embodiments, the satellite communications signal is a radio wave in a higher frequency band than the radio waves used by the wireless base stations including WBS 1 110 of the terrestrial wireless system. These higher frequency satellite signals can penetrate through clutter such as building structures and walls better than the terrestrial wireless signals and as a result the satellite wireless signal can be received by a UE when terrestrial wireless signal may be blocked from being received (e.g., because of the terrestrial wireless signal is unable to penetrate through the clutter (e.g., building structures and walls)). Operation proceeds from step 1174 to step 1178. In step 1178, the UE 1 102 receives and processes the satellite communications signal from the satellite 116. Operation proceeds from step 1178 to step 1180. In step 1180, UE 1 102 determines that it is receiving signals from satellite 116 and initiates operation to establish basic connectivity with satellite 116 including obtaining subscription credentials from storage (e.g., from a SIM) for satellite service needed for establishing a wireless service connection with satellite 116. Operation proceeds from step 1180 to step 1182. In step 1182, UE 1 102 generates a satellite connection request message including UE 1 102 satellite subscription credentials. Operation proceeds from step 1182 to step 1184 and step 1188. In step 1184, UE 1 102 exchanges messages 1186 with satellite 116 for initiating and establishing basic wireless connectivity (e.g., a wireless communications link) between UE 1 102 and satellite 116. In some embodiments, UE 1 102 sends its location information (e.g., UE 1 102 GPS coordinates and a timestamp) to the satellite 116 during the establishment of the connection. In step 1188, satellite 116 exchanges messages 1186 with UE 1 102 as part of establishing basic wireless connectivity between UE 1 102 and satellite 116. Exchanging messages for establishing wireless connectivity including the UE 1 102 generating and transmitting messages to satellite 116 and receiving and processing messages from the satellite 116. For example, UE 1 102 transmits the wireless connection request message including UE 1 102 satellite subscription credentials generated in step 1182 to the satellite 116. The satellite 116 receives and processes the wireless connection request message. The satellite 116 determines that UE 1 102 is subscribed to the satellite wireless network service based on the UE 1 102 satellite subscription credentials and transmits a wireless connection response message to UE 1 102 with radio resources (e.g., spectrum) to be utilized for the wireless communications between UE 1 102 and satellite 116. UE 1 102 receives and processes the message with the identified radio resources. The UE 1 102 and satellite 116 have established wireless connectivity and begin to utilize the radio resources to wirelessly communicate information and signals to each other including in some embodiments the UE 1 102 sending its location and a timestamp (e.g., GPS coordinates and timestamp) to the satellite 116 which the satellite 116 receives. In some embodiments, the UE 1 102 location information is included in information transmitted from the UE 1 102 to the satellite 116 during the establishment of the connection for example in the connection request message generated in step 1182. In some embodiments, the satellite subscription service is for basic connectivity in which location information for the UE 1 102 is communicated to the satellite. In some embodiments, the wireless connectivity is limited to this functionality and as a result the cost for the subscription is much lower than if the subscription is for the communication of user data or making calls. In some embodiments, the UE 1 102 location information is sent periodically to the satellite 116 with the periodicity being a variable setting on the UE 1 102 device and/or in the satellite application program executing on the UE 1 102 device. While the UE 1 can and in some embodiments does send it location information to the satellite 116, in most embodiments the satellite 116 determines the location of UE 1 without UE 1 sending location information. This may be achieved for example, by the satellite 116 communicating with other satellites in the satellite network which are also receiving signals from UE 1 102 and the satellite 116 using its own information and the information reported by the other satellites about the signals being received from UE 1 102 determines the location of UE 1 102 using triangulation. In another embodiment, the satellite 116 is a non-stationary satellite (i.e., a moving satellite) and it determines the location of UE 1 102 based on multiple signals received from UE 1 102 over a period of time. In some embodiments, the satellite 116 only determines UE 1 102 location information and sends its information to the satellite core 118 which then combines the information from satellite 116 about UE 1 102 along with information reported about UE 1 102's location from other satellites of the satellite system to triangulate and/or determine the exact location of UE 1 102. Operation proceeds from step 1188 to step 1198.

In step 1198, the satellite 116 generates message 1202 which includes the location of UE 1 102 (e.g., exact location with geographical coordinates and a timestamp). The message 1200 in some embodiments is based on the location information and time stamp information received from UE 1 102 and/or location information derived from communication signals received from UE 1 102 by satellite 116. Operation proceeds from step 1198 to step 1200. In step 1200, satellite 116 reports the location of UE 1 102 (e.g., exact location coordinates and time stamp) to network equipment in the satellite core network 118 by transmitting message 1202 to the network equipment in the satellite core network 118. Operation proceeds from step 1200 to step 1204. In step 1204, network equipment in the satellite core network 118 receive and process the message 1202. Operation proceeds from step 1204 to step 1206. In step 1206, network equipment in the satellite core network 118 generates message 1210 which includes location information for UE 1 102 (e.g., GPS coordinates and a timestamp). The message 1210 is based on the information included in message 1202. Operation proceeds from step 1206 to step 1208. In step 1208, network equipment in the satellite core network 118 reports the exact location of UE 1 102 (e.g., GPS coordinates and timestamp) to the CMCS 114 by transmitting message 1210 to CMCS 114. Operation proceeds from step 1208 to step 1212. In step 1212, the CMCS 114 receives and processes the message 1210 updating its information on the status of UE 1 102 as currently having connectivity with the satellite 116 and updating its location information (e.g., coordinates and timestamp) in records maintained in the CMCS 114 or in a storage system coupled and/or connected to the CMCS 114. The satellite core network 118 and terrestrial core network 112 both share information about the UEs, their connectivity, and their locations with the CMCS 114.

Turning to steps being performed by UE N 108, in step 1190, the UE N 108, powers up and receives a Reference Signal from WBS 1 110. Operation proceeds from step 1190 to steps 1192 and 1196 in which UE N 108 exchanges messages 1194 with WBS 1 110 for initiating and establishing wireless connectivity (e.g., a wireless communications link) between UE N 108 and WBS 1 110. In some embodiments, in step 1190 the UE N 108 receives user input from a user indicating a request to initiate a connection with the terrestrial network and in response to receiving the user input proceeds to step 1192. In step 1196, WBS 1 110 exchanges messages 1194 with UE N 108 as part of establishing wireless connectivity between UE N 108 and WBS 1 110. Exchanging messages for establishing wireless connectivity including the UE 2 108 generating and transmitting messages to WBS 1 110 and receiving and processing messages for WBS 1 110. For example, UE N 108 generates and transmits a wireless connection request message including UE N's subscription credentials to WBS 1 110. WBS 1 110 receives and processes the wireless connection request message. WBS 1 110 determines that the UE N 108 is subscribed to the terrestrial wireless network service based on the UE N subscription credentials and transmits a wireless connection response message to UE N 108 with radio resources (e.g., RF spectrum) to be utilized for the wireless communications between the UE N 108 and WBS 1 110. UE N 108 receives and processes the message with the radio resources. Once, UE N 108 and WBS 110 have established wireless connectivity and begin to utilize the radio resources to wirelessly communicate information and signals to each other.

Turning to steps being performed by UE 2 104, in step 1214, UE 2 104 powers up and in some embodiments receives user input to initiate a wireless connection with the terrestrial wireless system. In some embodiments, the UE 2 104 is configured to automatically establish a connectivity with the terrestrial wireless network of the terrestrial wireless system to which the WBS 1 110 is apart. Operation proceeds from step 1214 to step 1216. In step 1216, UE 2 1216 is unable to establish connectivity with the terrestrial network (e.g., the UE 2 1216 is unable to establish a wireless connection with wireless base stations of the terrestrial network of the terrestrial wireless system including WBS 1 110). Operation proceeds from step 1216 to step 1218. In step 1218, UE 2 104 in response to being unable to establish connectivity with wireless terrestrial network, enables the UE 2 104 satellite communications functionality (e.g., hardware circuitry) and/or application. Operations proceed from step 1218 to step 1220 shown on FIG. 11B. In step 1220, the satellite 116 transmits/broadcasts a satellite communications signal 1222. In some embodiments, the satellite communications signal is a radio wave in a higher frequency band than the radio waves used by the wireless base stations including WBS 1 110 of the terrestrial wireless system. Operation proceeds from step 1220 to step 1224. In step 1224, the UE 2 104 receives and processes the satellite communications signal from the satellite 116. Operation proceeds from step 1224 to step 1226. In step 1226, UE 2 104 determines that it is receiving signals from satellite 116 and initiates operations to establish basic connectivity with satellite 116 including obtaining subscription credentials from storage (e.g., from a SIM) for satellite service needed for establishing a wireless service connection with satellite 116. Operation proceeds from step 1226 to step 1228. In step 1228, UE 2 104 generates a satellite connection request message including UE 2 104 satellite subscription credentials. Operation proceeds from step 1228 to step 1230 and step 1234. In step 1230, UE 2 104 exchanges messages 1232 with satellite 116 for initiating and establishing basic wireless connectivity (e.g., a wireless communications link) between UE 2 104 and satellite 116. In some embodiments, UE 2 104 sends its location information (e.g., UE 2 104 GPS coordinates and a timestamp) to the satellite 116. In step 1234, satellite 116 exchanges messages 1232 with UE 2 104 as part of establishing basic wireless connectivity between UE 2 104 and satellite 116. Exchanging messages for establishing wireless connectivity including the UE 2 104 generating and transmitting messages to satellite 116 and receiving and processing messages from satellite 116. For example, UE 2 104 transmits the wireless connection request message including UE 2 104 satellite subscription credentials generated in step 1228 to the satellite 116. The satellite 116 receives and processes the wireless connection request message. The satellite 116 determines that UE 2 104 is subscribed to the satellite wireless network service based on the UE 2 104 satellite subscription credentials and transmits a wireless connection response message to UE 2 104 with radio resources (e.g., spectrum) to be utilized for the wireless communications between UE 2 104 and satellite 116. UE 2 104 receives and processes the message with the identified radio resources. The UE 2 104 and satellite 116 have established wireless connectivity and begin to utilize the radio resources to wirelessly communicate information and signals to each other. In some embodiments, the UE 2 104 sends its location and a timestamp (e.g., GPS coordinates and timestamp) to the satellite 116 which the satellite 116 receives. In some embodiments, the satellite subscription service is for basic connectivity in which location information for the UE 2 104 is communicated to the satellite. In some embodiments, the wireless connectivity is limited to this functionality and as a result the cost for the subscription is much lower than if the subscription is for the communication of user data or making calls. In some embodiments, the UE 2 104 location information is sent periodically to the satellite 116 with the periodicity being a variable setting on the UE 2 104 device and/or in the satellite application program executing on the UE 2 104 device. In most embodiments, satellite 116 determines the UE 2 104 location based on communication signals received from the UE 2 104 and not from the GPS coordinates provided by the UE 2 104 for example in one of the ways previously described in connection with the determination of UE 1 102's location by the satellite 116 or the satellite core 118. Operation proceeds from step 1234 to step 1238.

In step 1238, the satellite 116 generates message 1242 which includes the location of UE 2 104 (e.g., exact location such as geographical coordinates and a timestamp). The message 1242 in some embodiments is based on the location information and time stamp information received from UE 2 104 and/or derived from communication signals received from UE 2 104. Operation proceeds from step 1238 to step 1240. In step 1240, satellite 116 reports the exact location of UE 2 104 to network equipment in the satellite core network 118 by transmitting message 1242 to the network equipment in the satellite core network 118. Operation proceeds from step 1240 to step 1246. In step 1246, network equipment in the satellite core network 118 receive and process the message 1242. Operation proceeds from step 1246 to step 1254.

At the CMCS 114, in step 1235 the CMCS 114 generates and transmits message 1236 to network equipment in the terrestrial core network 112. The message 1236 includes a request for UE information for UEs with terrestrial connectivity including the location of the UEs with the terrestrial connectivity. Operation proceeds from step 1235 to step 1237. In step 1237, network equipment in the terrestrial core network 112 receives and processes the message 1236. Operation proceeds from step 1237 to step 1247.

In step 1247, network equipment in the terrestrial core network 112 generate message 1250 which includes information on the UEs with terrestrial connectivity including location information for the UEs with terrestrial connectivity with the terrestrial core network 112 which in this example includes UE 3 106 and UE N 108. The UE information in addition to the UE location information may, and in some embodiments does, also include UE identifier and link status information or information about the change in position of the UE such as the velocity of the UE (e.g., is the UE slow moving making it a candidate to provide a D2D connection to a UE that has lost terrestrial connectivity or is not slow moving but moving faster than a threshold amount making it a poor candidate or not suitable to use for providing a D2D).

In some embodiments, the UE location information is either being provided by the UEs for example the UEs with connectivity to the terrestrial core network provide on a periodic basis location information and a timestamp of when the location information was generated (e.g., GPS coordinates and a timestamp) to the terrestrial core network 112 and/or the UE location information is generated by the terrestrial core network 112 for example using base station triangulation methods to determine UE locations and timestamping when the locations were determined. In some embodiments, the UE information for UEs with terrestrial connectivity to the terrestrial core network 112 is not provided in response to a request but is provided on a periodic and/or on-going continuous basis. Operation proceeds from step 1247 to step 1248. In step 1248, the message 1250 is transmitted to the CMCS 114. Operation proceeds from step 1248 to step 1252. In step 1252, the CMCS receives and processes message 1250 including updating records to reflect the connectivity status and location information for the terrestrials UEs based on the reported information included in message 1250. The information may be, and in some embodiments is, included in memory of the CMCS 114 or a storage system coupled and/or connected to the CMCS 114 as previously discussed.

In step 1254, network equipment in the satellite core network 118 generate message 1258 which includes location information for UE 2 104 (e.g., geographical coordinates and a timestamp). The message 1258 is based on the information included in message 1242. Operation proceeds from step 1254 to step 1256. In step 1256, network equipment in the satellite core network 118 reports the exact location of UE 2 104 (e.g., geographical coordinates and timestamp) to the CMCS 114 by transmitting message 1258 to CMCS 114. Operation proceeds from step 1256 to step 1260. In step 1260, the CMCS 114 receives and processes the message 1258 updating its information on the status of UE 2 104 as currently having connectivity with the satellite 116 and updating its location information (e.g., geographical coordinates and timestamp) in records maintained in the CMCS 114 and/or storage system coupled and/or connected to the CMCS 114 as previously discussed. In various embodiments, a storage system is incorporated into the CMCS 114 and/or coupled to the CMCS 114 which is updated on a regular basis to maintain information about the UEs (e.g., their connectivity and location) which are subscribed to the terrestrial wireless system and/or the satellite system.

Operation proceeds from step 1260 to step 1262. In step 1262, the CMCS 1262 determines the UEs in need of terrestrial connectivity based on information reported from the terrestrial core network (e.g., UE 1 102 loss of wireless terrestrial connectivity reported to the CMCS 114) and/or the satellite core network 118 (e.g., satellite core network 118 reporting UE 1 102 and UE 2 104 having established satellite connectivity and reported their locations). Operations proceed from step 1262 to step 1264.

In step 1264, the CMCS 114 determines which of the UEs that are in need of wireless terrestrial connectivity (UE 1 102 and UE 2 104) have satellite communications subscriptions for satellite assisted terrestrial wireless device-to-device services but do not have subscriptions for full satellite voice communications from the records included in the unified data management system and commence tracking the location of these UEs using information reported from the satellite core network which provide periodic updates on the location of the UEs (e.g., UE geographical coordinates) with timestamps indicating when the location information was obtained. In some embodiments, the UDM will only indicate that the UE has a voice communications satellite subscription which will be an indication that the UE does not require satellite assisted terrestrial wireless device-to-device services. In some of such embodiments, satellite assisted terrestrial wireless service will be provided as a default when there is no satellite subscription but the satellite is reporting the UE location information as it indicates that the UE is requesting satellite assisted terrestrial wireless device-to-device services.

In some embodiments, step 1264 further includes determining which of the UEs which do not have terrestrial wireless connectivity meet the criteria for providing satellite assist terrestrial wireless network device-to-device connections/services with the criteria including that the UE is moving below a threshold level of speed (e.g., slow moving or stationary) and does not have a satellite subscription which would provide satellite voice communications services to the UE. In some embodiments, the criteria includes that the UE has a limited satellite subscription which limits satellites services to services required for satellite assisted terrestrial wireless device-to-device services such as UE location and tracking services. In some embodiments, step 1264 is a sub-step of step 1262. Operation proceeds from step 1264 to step 1266.

In step 1266, CMCS 114 uses the location information for the user equipment devices determined to require satellite assisted terrestrial wireless device-to-device connections (e.g., because they do not have satellite voice service subscriptions) to find the best connectivity option. (E.g., use the location information provided by the satellite core network to identify the best user equipment devices to provide satellite assisted terrestrial wireless device-to-device connections to the UEs determined to need these connections (e.g., UE 1 and UE 2).

Operation proceeds from step 1266 to step 1268 shown on FIG. 11C. In step 1268, the CMCS generates and transmits message 1270 to the propagation generator and link estimator 111. The message 1270 includes UE information (e.g., UE location information) to identify the best device-to-device (D2D) UE options for each of the UEs that are in need of wireless terrestrial network connectivity. Operation proceeds from step 1268 to step 1272.

In step 1272, the propagation generator and link estimator 111 receives and process message 1270. Operation proceeds from step 1272 to step 1274. In step 1274, the propagation generator and link estimator 111 determines candidate UEs and candidate wireless communications links (device-to-device D2D links that could be established between UEs with no wireless terrestrial connectivity (UE 1 102 and UE 2 104 in this example) and the UEs with wireless terrestrial connectivity (UE 3 106 and UE N 108 in this example).

Operation proceeds from step 1274 to step 1276. In step 1276, propagation generator and link estimator 111 prepares and/or generates one or more UE links reports which include information on the wireless base station to UE links which are already established, the UE to UE D2D links already established as well as candidate D2D links to be established between UEs in need of wireless terrestrial connectivity and the UEs with wireless terrestrial connectivity. This information further includes its recommended candidates for the D2D connections and information on the candidate D2D links. In this example, the propagation generator and link estimator 111 determines that UE 3 106 and UE N 108 are options for UE 1 102 and UE 2 104 and generates information on candidate D2D links which could be provided based on propagation models. Operation proceeds from step 1276 to step 1278.

In step 1278, the propagation generator and link estimator 111 generates message 1282 which includes the prepared and/or generated UE links reports. Operation proceeds from step 1278 to step 1280. In step 1280, the propagation generator and link estimator 111 transmits the message 1282 to the CMCS 114. Operation proceeds from step 1280 to step 1284. In step 1284, the CMCS 114 receives and processes the message 1282. Operation proceeds from step 1284 to step 1285.

In step 1285, the CMCS 114 determines that UE 3 106 is the best UE with wireless terrestrial connectivity to provide a D2D link to UE 1 102 based on one or more or any combination of the following: distance (e.g., distance between the UE 1 102 and other UEs with terrestrial connectivity such as UE 3 106 and UE N 108), clutter (e.g., in the wireless communication path between UE 1 102 and UEs with terrestrial connectivity such as UE 3 106 and UE N 108, interference being experienced at the UEs with connectivity or along the wireless communications path from UE 1 102 to UEs with terrestrial connectivity and/or interference measurements received at WBS 1 110 from the UEs with terrestrial connectivity, modulation rates supported by UE 1 102 and the UEs with terrestrial connectivity, load on network, and load on the UEs with terrestrial connectivity such as UE 3 106 and UE N 108. In some embodiments, the CMCS 114 determines that UE 3 106 is the best UE with wireless terrestrial connectivity to provide a D2D link to UE 1 102 based on the terrestrial network policies and the recommendations (e.g., UE candidates and candidate D2D links) and information (e.g., information about the candidate links) provided by the propagation generator and link estimator which makes the analysis based on one or more or any combination of the following: distance (e.g., distance between the UE 1 102 and other UEs with terrestrial connectivity such as UE 3 106 and UE N 108), clutter (e.g., in the wireless communication path between UE 1 102 and UEs with terrestrial connectivity such as UE 3 106 and UE N 108, interference being experienced at the UEs with connectivity or along the wireless communications path from UE 1 102 to UEs with terrestrial connectivity and/or interference measurements received at WBS 1 110 from the UEs with terrestrial connectivity, modulation rates supported by UE 1 102 and the UEs with terrestrial connectivity, load on network, and load on the UEs with terrestrial connectivity such as UE 3 106 and UE N 108.

In this example, the CMCS 114 determines that UE N 108 is the best UE with wireless terrestrial connectivity to provide a D2D link to UE 2 104 based on one or more or any combination of the following: distance (e.g., distance between the UE 2 104 and other UEs with terrestrial connectivity such as UE 3 106 and UE N 108), clutter (e.g., in the wireless communication path between UE 2 104 and UEs with terrestrial connectivity such as UE 3 106 and UE N 108, interference being experienced at the UEs with connectivity or along the wireless communications path from UE N 104 to UEs with terrestrial connectivity and/or interference measurements received at WBS 1 110 from the UEs with terrestrial connectivity, modulation rates supported by UE 1 102 and the UEs with terrestrial connectivity, load on network, and load on the UEs with terrestrial connectivity such as UE 3 106 and UE N 108.

In some embodiments, the CMCS 114 determines that UE N 108 is the best UE with wireless terrestrial connectivity to provide a D2D link to UE 2 104 based on the terrestrial network policies and the recommendations (e.g., UE candidates and candidate D2D links) and information (e.g., information about the candidate links) provided by the propagation generator and link estimator which makes the analysis based on one or more or any combination of the following: distance (e.g., distance between the UE 2 104 and other UEs with terrestrial connectivity such as UE 3 106 and UE N 108), clutter (e.g., in the wireless communication path between UE 2 104 and UEs with terrestrial connectivity such as UE 3 106 and UE N 108, interference being experienced at the UEs with connectivity or along the wireless communications path from UE N 104 to UEs with terrestrial connectivity and/or interference measurements received at WBS 1 110 from the UEs with terrestrial connectivity, modulation rates supported by UE 1 102 and the UEs with terrestrial connectivity, load on network, and load on the UEs with terrestrial connectivity such as UE 3 106 and UE N 108. Operation proceeds from step 1285 to step 1286.

In step 1286, the CMCS 114 confirms that the UEs in need of terrestrial connectivity locations have not changed based on the latest reported location information from the satellite core network 118. The CMCS 114 also confirms that the locations of UEs with terrestrial connectivity which have been identified to provide the D2D links for the UEs without terrestrial connectivity locations have also not changed based on the latest UE location information provided by the terrestrial core network 112. If a UE in need of terrestrial connectivity has changed location by an amount greater than a threshold movement distance then the CMCS 114 makes a determination that with respect to that UE operation will proceed from step 1286 to step 1262 of the method 1000 to repeat the method steps using the new UE location. Similarly, if the CMCS 114 makes a determination that a UE with terrestrial connectivity which was to provide a D2D link to a UE without terrestrial connectivity has changed location by an amount greater than a threshold movement distance then the CMCS 114 makes a determination that with respect to the UE that was to be provided a D2D link from the UE that changed position by an amount greater than a threshold movement distance, operation will proceed from step 1286 to step 1262 of the method 1000 to repeat the method steps to find another UE with terrestrial connectivity to provide the D2D connection. In some embodiments, the confirmation of UEs location in step 1286 includes determining that the distance between the UEs which are to form a D2D connection have not changed in a way or manner that will negatively impact the D2D connection so that it is no longer an acceptable D2D connection (e.g., the D2D link to be established will no longer meet predefined terrestrial wireless network operator D2D link quality of service parameters set for example by quality of service agreements or policies).

When the CMCS 114 determines that a UE in need of terrestrial connectivity has not moved by an amount greater than the threshold movement distance then operation proceeds from step 1286 to step 1288. In this example, UE 1 102 and UE 2 104 are determined in step 1286 to have not moved by an amount greater than the threshold movement distance. Operation proceeds from step 1286 to step 1288.

In step 1288, the CMCS 114 generates message 1292. The message 1292 includes information on the links (e.g., wireless base station to UE links and UE to UE D2D links) to be initiated towards UEs with no terrestrial connectivity. In this example, the links to be initiated are UE 3 106 D2D link to UE 1 102 and UE N 108 D2D link to UE 2 104. The message 1292 can also include information on the radio resources, bandwidth, data rate, modulation scheme, radio frequency spectrum and/or channel for the link. Operation proceeds from 1288 to step 1290.

In step 1290, the CMCS 114 transmits message 1292 to network equipment in the terrestrial core network 112. Operation proceeds from step 1290 to step 1294. In step 1294, network equipment in the terrestrial core network 112 receives and processes the message 1292. Operation proceeds from step 1994 to step 1296. In step 1296, network equipment in the terrestrial core network 114 generates message 1298 based on message 1292. The message 1298 includes information on the connectivity links to be initiated toward UEs in need of connectivity. In some embodiments it includes the same information on the connectivity links to be initiated as included in message 1292. In some embodiments, the message 1298 is message 1292 which is being forwarded by network equipment in the terrestrial core network 112 to the WBS 1 110. Operation proceeds from step 1296 to step 1297. In step 1297, network equipment in the terrestrial core network 112 transmit message 1298 to WBS 1 110. Operation proceeds from step 1297 to step 1300. In step 1300, the WBS 1 110 receives the message 1298. Operation proceeds from step 1300 to step 1302.

In step 1302, WBS 1 110 generates instructions for UE 3 and UE N to broadcast beacon messages for UE 2D2 connectivity discovery. The D2D beacon instructions for UE N 108 are included in the WBS 1 110 generated message 1306 and the D2D beacon instructions for UE 3 106 are included in the WBS 1 110 generated message 1312. Operation proceeds from step 1302 to steps 1304 and 1310. In step 1304, WBS 1 110 transmits the message 1306 to UE N 108. Operation proceeds from step 1304 to step 1308. In step 1308, UE N 108 receives and processes message 1306. In step 1310, WBS 1 110 transmits the message 1312 to UE 3 106. Operation proceeds from step 1310 to step 1314. In step 1314, UE 3 106 receives and processes message 1312. Operation proceeds from 1314 to step 1315 shown on FIG. 11D.

In step 1315, UE 3 106 generates D2D beacon discovery message 1318. The D2D beacon discovery message includes information advertising that UE 3 106 is available to provide device-to-device wireless services. In some embodiments, the D2D beacon discovery message is a proximity service beacon discovery message offering services by the UE 3 106. Operation proceeds from step 1315 to step 1316. In step 1316, UE 3 106 wirelessly transmits/broadcasts the message 1318 to other wireless devices in the proximity of UE 3 106. Operation proceeds from step 1316 to step 1320. In step 1320, UE 1 102 receives and processes the D2D beacon message 1318. Operation proceeds from step 1320 to step 1322. In step 1322, the UE 1 determines that the UE 3 106 is advertising and/or offering to provide device-to-device (D2D) wireless communications services. UE 1 102 determines to respond to the advertised D2D wireless communications services (e.g., D2D wireless proximity services) and generates message 1336 requesting the advertised and/or offered wireless D2D services. The message 1336 includes information about UE 1 102 including identification information which identifies UE 1 102 and/or its user/subscriber (e.g., a Globally Unique Temporary Identifier (GUTI) assigned to UE 1 102 by the terrestrial core network 112 or the International Mobile Equipment Identity (IMEI) assigned to the mobile subscriber). Operation proceeds from step 1322 to step 1334.

In step 1334, UE 1 102 transmits message 1336 to UE 3 106 in response to the D2D beacon broadcast message 1318. Operation proceeds from step 1334 to step 1338. In step 1338, UE 3 106 receives and processes the response message 1336. Operation proceeds from step 1338 to step 1340. In step 1340, UE 3 106 generates message 1344 which includes the UE 1 102 response and/or the UE 1 102 information included in the response to the D2D beacon broadcast message 1318. Operation proceeds from step 1340 to step 1342. In step 1342, UE 3 106 transmits message 1344 to WBS 1 110. Operation proceeds from step 1342 to step 1346.

In step 1346, WBS 1 110 receives and processes message 1344. Operation proceeds from step 1346 to step 1348. In step 1348, WBS 1 110 generates message 1348 based on message 1344. The message 1352 includes the UE 1 102 response and/or the UE 1 102 information included in the response to the D2D beacon broadcast message 1318 which was included in message 1344. Operation proceeds from step 1348 to step 1350. In step 1350, WBS 1 110 transmits message 1350 to network equipment in the terrestrial core network 112. Operation proceeds from step 1350 to step 1354. In step 1354, network equipment in the terrestrial core network 1112 receives and processes message 1352. Operation proceeds from step 1354 to step 1370. In step 1370 network equipment in the terrestrial core network 112 confirms the connectivity between UE 1 102 and UE 3 106 and determines and/or calculates Radio Frequency resources to be used for the UEs D2D communications link to be established between UE 1 102 and UE 3 106. Part of the confirmation process is determining based on the UE 1 102 identification information provided by UE 1 102 that UE 1 102 is the UE without terrestrial wireless connectivity that the CMCS 114 determined UE 3 106 was to establish a D2D link to. This is done as there may be, and in some instances are multiple UEs without connectivity that respond to UE 3 106 D2D beacon message 1318. For example, another UE without terrestrial wireless communications such as a UE 4 may also be in the vicinity of UE 3 106 and receive the beacon message 1318 and respond to it. In such a case, when the UE 4 responds and includes its UE 4 identification information, the terrestrial core network 112 will be able to determine that this is not the UE for which UE 3 106 is provided a D2D wireless services as determined by the CMCS 114 and included in the instructions provided connectivity links message 1292. In such a case, the terrestrial core network 112 would not provide RF resources but would instead wait for additional responses to be provided from UE 3 106 until the UE 1 102 response was received from UE 3 106 and confirmed by the terrestrial core network 112 at which time RF resources for the D2D wireless connection between UE 1 102 and UE 3 106 would be determined and/or calculated as previously discussed.

Returning to UE N 108, operation proceeds from step 1308 to step 1324 shown on FIG. 11D. In step 1324, UE N 108 generates D2D beacon discovery message 1326. The D2D beacon discovery message includes information advertising that UE N 108 is available to provide device-to-device wireless services. In some embodiments, the D2D beacon discovery message is a proximity service beacon discovery message offering services by the UE N 108. Operation proceeds from step 1324 to step 1326. In step 1326, UE N 108 wirelessly transmits/broadcasts the message 1328 to other wireless devices in the proximity of UE N 108. Operation proceeds from step 1326 to step 1330. In step 1330, UE 2 104 receives and processes the D2D beacon message 1328. Operation proceeds from step 1330 to step 1332. In step 1332, the UE 2 104 determines that the UE N 108 is advertising and/or offering to provide device-to-device (D2D) wireless communications services. UE 2 104 determines to respond to the advertised D2D wireless communications services (e.g., D2D wireless proximity services) as it does not terrestrial wireless connectivity and generates message 1358 requesting the advertised and/or offered wireless D2D services. The message 1358 includes information about UE 2 104 including identification information which identifies UE 2 104 and/or its user/subscriber (e.g., a Globally Unique Temporary Identifier (GUTI) assigned to UE 2 104 by the terrestrial core network 112 or the International Mobile Equipment Identity (IMEI) assigned to the mobile subscriber). Operation proceeds from step 1332 to step 1356. In step 1356, UE 2 104 sends message 1358 to UE N 108 in response to the D2D beacon broadcast message 1328. Operation proceeds from step 1356 to step 1360.

In step 1360, UE N 106 receives and processes the response message 1386. Operation proceeds from step 1360 to step 1362. In step 1362, UE N 108 generates message 1366 which includes the UE 2 104 response and/or the UE 2 104 information included in the response to the D2D beacon broadcast message 1328. Operation proceeds from step 1362 to step 1364. In step 1364, UE N 108 transmits message 1366 to WBS 1 110. Operation proceeds from step 1364 to step 1368.

In step 1368, WBS 1 110 receives and processes message 1366. Operation proceeds from step 1368 to step 1372. In step 1372, WBS 1 110 generates message 1376 based on message 1366. The message 1376 includes the UE 2 104 response and/or the UE 2 104 information included in the response to the D2D beacon broadcast message 1328 which was included in message 1366. Operation proceeds from step 1372 to step 1374. In step 1374, WBS 1 110 transmits message 1376 to network equipment in the terrestrial core network 112. Operation proceeds from step 1374 to step 1378. In step 1378, network equipment in the terrestrial core network 112 receives and processes message 1376. Operation proceeds from step 1378 to step 1380. In step 1380 network equipment in the terrestrial core network 112 confirms the connectivity between UE 2 104 and UE N 106 and determines and/or calculates Radio Frequency resources to be used for the UEs D2D communications link to be established between UE 2 104 and UE N 108. Part of the confirmation process is determining based on the UE 2 104 identification information provided by UE 2 104 that UE 2 104 is the UE without terrestrial wireless connectivity that the CMCS 114 determined UE N 108 was to establish a D2D link to. This is done as there may be, and in some instances are multiple UEs without connectivity that respond to UE N 108 D2D beacon message 1328 as previously explained in connection with the response to the UE 3 106 beacon message 3118. The terrestrial core network 112 does not provide RF resources if the UE identification of the responding UE does not match expected UE 2 104 identification information but would instead wait for additional responses to be provided from UE N 108 until the UE 1 102 response was received from UE N 108 and confirmed by the terrestrial core network 112 at which time RF resources for the D2D wireless connection between UE 2 104 and UE N 108 would be determined and/or calculated as previously discussed. Operation proceeds from step 1380 to step 1382.

In step 1382, network equipment in the terrestrial core network 112 generate message 1386. The message 1386 includes confirmation for the D2D connections to be made for UE 3 106 to UE 1 102 and UE N 108 to UE 2 104. The message 1386 further includes the determined and/or calculated RF resources for each of the D2D communications links to be established. In some embodiments, the message 1386 may be implemented as two separate messages one for each D2D connection to be made and send separately. In many embodiments, this is done to ensure the fastest response to providing the requested D2D service. However, in this example a single message has been used as the terrestrial core network 112 confirmed the two D2D connections to be made one after the other in a narrow time window. The use of a single message not sufficiently affecting the time to establish the different D2D connections while reducing network traffic between the terrestrial core network 112 and the WBS 1 110. Operation proceeds from step 1382 to step 1384. In step 1384, network equipment in the terrestrial core network 112 transmit the message 1386 to the WBS 1 110. Operation proceeds from step 1384 to step 1388. In step 1388, WBS 1 110 receives and processes the message 1388. Operation proceeds from step 1388 to step 1390.

In step 1390, WBS 1 110 generates message 1394 based on information included in message 1386. The message 1394 provides a confirmation for the UE 3 106 to UE 1 102 D2D link to be established and identifies the RF resources to be used for the D2D wireless communications link to be established between UE 3 106 and UE 1 102. Operation proceeds from step 1390 to step 1392. In step 1392, WBS 1 110 transmits message 1394 to UE 3 106. Operation proceeds from step 1392 to steps 1396 and 1430 shown on FIG. 11E.

In step 1392, WBS 1 110 transmits message 1394 to UE 3 106. Operation proceeds from step 1392 to step 1396. In step 1396, UE 106 receives and processes message 1394. Operation proceeds from step 1396 to step 1400. In step 1400, UE 3 106 determines based on message 1394 that the UE 3 106 to UE 1 102 D2D wireless link has been confirmed to be established and the RF resources that are to be used for the D2D link between UE 3 106 and UE 1 102. Operation proceeds from step 1400 to step 1402 shown on FIG. 11E. In step 1402, UE 3 106 generates and transmits D2D connectivity establishment signal message 1404 to UE 1 102. The establishment signal message 1404 includes information for the establishment of the D2D wireless link between UE 3 106 and UE 1 102 including the identification of the RF resources to be used for the D2D link. Operation proceeds from step 1402 to step 1405. In step 1405, the UE 1 102 receives and processes the D2D connectivity establishment signal message 1404. Operation proceeds from step 1405 to step 1406. In step 1406, UE 1 102 generates response message 1409 responding to the D2D connectivity establishment signal message 1404. The message 1409 acknowledging that it has received the D2D establishment message 1404 with the information identifying the RF resources to be used for the D2D connection to be established between UE 1 102 and UE 3 106. Operation proceeds from step 1406 to step 1407. In step 1407, UE 1 102 transmits message 1409 to the UE 3 106. Operation proceeds from step 1407 to step 1408. In step 1408, UE 3 106 receives and processes response message 1409. Operation proceeds from step 1407 to step 1408 to step 1410 and 1414. In steps 1410 and 1414 the D2D connectivity is established between UE 3 106 and UE 1 102 using the RF resources identified by the CMCS 114 for the UE 3 106 to UE 1 102 D2D communications link. Once the D2D connectivity has been established messages 1412 are exchanged between UE 1 102 and UE 3 106 using the RF identified resources.

Operation proceeds from 1410 and 1414 to steps 1416, 1420, 1424 and 1428 the operations of which establish end to end connectivity from UE 1 102 to the terrestrial core network 112. In steps 1416 and 1420, the D2D wireless connection UE 1 102 and UE 3 106 is used to exchange messages 1418 over the established D2D wireless communications link using the identified RF resources. In step 1416, UE 1 102 receives messages from UE 3 106 and transmits messages to UE 3 106. In step 1420, UE 3 106 receives messages from UE 1 102 and transmits those messages or the information contained in those messages to WBS 1 110 over the wireless communications link between UE 3 106 and the WBS 1 110 as part of the messages 1422 exchanged between UE 3 106 and WBS 1 110. In step 1420, UE 3 106 also receives messages from WBS 1 110 for UE 1 102 which are part of the messages 1422 exchanged between WBS 1 and UE 3 106 and transmits those received message or the information in those received messages to UE 1 102. The UE 3 106 acting as a relay for UE 1 102. In step 1424, WBS 1 110 acts as a relay receiving messages including in messages 1422 from UE 1 102 via UE 3 106 and transmitting those messages to the terrestrial core network 112 as part of exchanged messages 1426 while also receiving messages from the terrestrial core network 112 for UE 1 102 which it then transmits or forwards to UE 3 106 for transmission to UE 1 102 over the D2D connection/link. In step 1428, network equipment in the terrestrial core network 112 receives messages from UE 1 102 transmits messages to UE 1 102. These messages are included in the messages 1426 exchanged between WBS 1 110 and terrestrial core network 112. End to end connectivity between UE 1 102 and the terrestrial core network has thus been established using the D2D communications link between UE 1 102 and UE 3 106.

Returning to operations occurring in connection with WBS 1 110, in step 1430 shown on FIG. 11E, WBS 1 110 generates message 1434 based on information included in message 1386. The message 1434 provides a confirmation for the UE N 108 to UE 2 104 D2D link to be established and identifies the RF resources to be used for the D2D wireless communications link to be established between UE N 108 and UE 2 104. Operation proceeds from step 1430 to step 1432. In step 1432, WBS 1 110 transmits message 1434 to UE N 108. Operation proceeds from step 1432 to step 1436.

In step 1436, UE N 108 receives and processes message 1434. Operation proceeds from step 1436 to step 1438. In step 1438, UE N 108 determines based on message 1434 that the UE N 108 to UE 2 103 D2D wireless link has been confirmed to be established and the RF resources that are to be used for the D2D link between UE N 108 and UE 2 104. Operation proceeds from step 1438 to step 1440. In step 1440, UE N 108 generates and transmits D2D connectivity establishment signal message 1442 to UE 2 104. The establishment signal message 1442 includes information for the establishment of the D2D wireless link between UE N 108 and UE 2 104 including the identification of the RF resources to be used for the D2D link. Operation proceeds from step 1440 to step 1444. In step 1444, the UE 2 104 receives and processes the D2D connectivity establishment signal message 1442. Operation proceeds from step 1444 to step 1446. In step 1446, UE 2 104 generates response message 1450 responding to the D2D connectivity establishment signal message 1442. The message 1450 acknowledging that it has received the D2D establishment message 1442 with the information identifying the RF resources to be used for the D2D connection to be established between UE 2 104 and UE N 108. Operation proceeds from step 1446 to step 1448. In step 1448, UE 2 104 transmits message 1450 to the UE N 108. Operation proceeds from step 1448 to step 1452. In step 1452, UE N 108 receives and processes response message 1450. Operation proceeds from step 1452 to steps 1454 and 1458. In steps 1458 and 1458 the D2D connectivity is established between UE N 108 and UE 2 104 using the RF resources identified by the CMCS 114 for the UE N 108 to UE 2 104 D2D communications link. Once the D2D connectivity has been established messages 1456 are exchanged between UE 2 104 and UE N 108 using the RF identified resources.

Once the D2D wireless communications link between UE 2 104 and UE N 108 have been established, end to end connectivity from UE 2 104 to the terrestrial core network 112 is established through the UE N 108 relaying messages from WBS 1 110 to UE 2 104 and from UE 2 104 to WBS 1 110. In steps 1454 and 1458, the D2D wireless connection UE 2 104 and UE N 108 is used to exchange messages 1456 over the established D2D wireless communications link using the identified RF resources. In step 1454, UE 2 104 receives messages from UE N 108 and transmits messages to UE N 108. In step 1458, UE N 108 receives messages from UE 2 104 and transmits those messages or the information contained in those messages to WBS 1 110 over the wireless communications link between UE N 108 and the WBS 1 110 as part of the messages 1460 exchanged between UE N 108 and WBS 1 110. In step 1458, UE N 108 also receives messages from WBS 1 110 for UE 2 104 which are part of the messages 1460 exchanged between WBS 1 and UE N 108 and transmits those received message or the information in those received messages to UE 2 104. The UE N 108 acting as a relay for UE 2 104. In step 1462, WBS 1 110 acts as a relay receiving messages including in messages 1460 from UE 2 104 via UE N 108 and transmitting those messages to the terrestrial core network 112 as part of exchanged messages 1464 while also receiving messages from the terrestrial core network 112 for UE 2 104 which it then transmits or forwards to UE N 108 for transmission to UE 2 104 over the D2D connection/link. In step 1466, network equipment in the terrestrial core network 112 receives messages from UE 2 104 and transmits messages to UE 2 104. These messages are included in the messages 1462 exchanged between WBS 1 110 and terrestrial core network 112. End to end connectivity between UE 2 104 and the terrestrial core network 112 has thus been established using the D2D communications link between UE 2 104 and UE N 108.

In step 1468 shown on FIG. 11F, WBS 1 110 generates and transmits and/or broadcasts reference signal 1470 to UEs which can receive it (e.g., UEs within its coverage area). WBS 1 110 transmits and/or broadcasts a reference signal on a periodic on-going basis. The reference signal 1470 is one instance of the transmission of the reference signal from WBS 1 110 occurring after the D2D link between UE 1 102 and UE 3 106 has been established. Operation proceeds from step 168 to step 1472. In step 1472, the UE 1 102 receives and processes the reference signal 1470. This may be the result of UE 1 102 moving to a new location or position where the signal from WBS 1 110 is no longer blocked by clutter or terrain. For example, UE 1 102 may have been located in the interior of a building with a number of walls, floors, and/or ceils blocking the WBS 1 110 signal and has now moved to a location that next to an exterior wall or window of the building or exited the building and is the WBS 1 110 signal is no longer being blocked by the building's structure. In another example, the UE 1 102 may have been high up on mountain and moved down the mountain to an area within the transmission range of the WBS 1 110. Similarly, UE 1 102 could have been on one floor of a building which does not receive the WBS 1 110 signal because of clutter (e.g., building infrastructure) but has moved to a different floor of the building that does receive the WBS 1 110 signal. Operation proceeds from step 1472 to step 1474. In step 1474, the UE 1 102 makes the determination that it once again has direct connectivity with WBS 1 110 based on the received reference signal from WBS 1 110 and commences taking measurements on the received references and generating metrics about the received reference signal from WBS 1 110. Operation proceeds from step 1474 to step 1476.

In step 1476, the UE 1 102 generates and transmits messages 1478 to UE 3 106 indicating that UE 1 102 is directly receiving WBS 1 110 reference signal and providing measurements and metrics about the received reference signal (e.g., signal strength measurements, signal to noise measurements, Reference Signal Received Power (RSRP), Reference Signal Strength Indicator (RSSI), Signal-to-Noise and Interference Ratio (SNIR), signal quality metrics). The messages 1478 are transmitted over the D2D wireless communications link between UE 1 102 and UE 3 106. In step 1480, the UE 3 106 receives the messages 1478 and generates message 1482 based on and/or to include the information included in the message 1478. In step 1480, the UE 3 106 also transmits the generated message 1482 to the WBS 1 110. In some embodiments, the UE 3 106 forwards message 1478 to the WBS 1 110 instead of generating message 1482 and/or encapsulates message 1478 in message 1482. In step 1484, WBS 1 110 receives the messages 1482 and generates message 1486 based on and/or to include the information included in the message 1482. In step 1484, WBS 1 110 also transmits the generated message 1486 to network equipment in the terrestrial core network 112. In some embodiments, WBS 1 110 forwards message 1482 to the WBS 1 110 instead of generating message 1486 and/or encapsulates message 1486 in message 1486. In some embodiments, the message 1482 and 1486 are forwarded copies of message 1478. In step 1488, network equipment in the terrestrial core network 112 receives and processes message 1486. Operation proceeds from step 1488 to step 1490.

In step 1490, network equipment in the terrestrial core network 112 determines that direct wireless connectivity has been restored between WBS 1 112 and UE 1 102 based on the information contained in the message 1486 which indicates that the WBS 1 reference signal has been reported as being received by the UE 1 102 in messages 1486. Operation proceeds from step 1490 to step 1492. In step 1492, network equipment in the terrestrial core network 112 collect and/or generate metrics on the reference signal being received by UE 1 102 from WBS 1 110 based on the measurements and metrics reported by UE 1 102 and included in the messages being sent from the UE 1 102 via the D2D wireless communications link to the terrestrial core network 112. Operation proceeds from step 1492 to step 1494. In step 1494, network equipment in the terrestrial core network 112 generate a UE 1 102 connectivity report including metrics and include the information in message 1496 which is transmitted to CMCS 114. Operation proceeds from step 1494 to step 1498. In step 1498, the CMCS 114 receives and processes message 1496. Operation proceeds from step 1498 to step 1500. In step 1500, CMCS 114 monitors Key Performance Indicators (e.g., including the metrics and/or performance indicators generated by the WBS 1 110 and/or the CMCS 114 based on the reported metrics) for a period of time on the direct wireless connectivity between WBS 1 110 and UE 1 110 as reported to the CMCS 114 by UE 1 102 via the D2D communications link between UE 1 102 and UE 3 106. In some embodiments, the KPIs include signal strength, power, and noise measurements and/or performance metrics of the received reference signal at the UE 1 102 over the monitored period of time (e.g., RSRP measurements/performance metrics over a time period, SNIR measurements/performance metrics over a time period). Operation proceeds from step 1500 to step 1502 shown on FIG. 11G.

In step 1502, the CMCS 114 determines based on the monitored KPIs and/or the reported UE 1 measurements and/or metrics to re-instate a direct terrestrial wireless communication connection/link between WBS 1 110 and UE 1 102. Operation proceeds 1502 to step 1504. In step 1504, the CMCS generates instructions to re-instate the direct terrestrial wireless communication connection/link between WBS 1 110 and UE 1 102 and then terminate the D2D connection/link between UE 3 106 and UE 1 102 and release and/or free up the UE 3 106 to UE 1 102 D2D RF resources. Operation proceeds from step 1504 to step 1506. In step 1506, the CMCS 114 generates message 1508 which includes the instructions generated in step 1506. Operation proceeds from step 1504 to step 1510. In step 1510, network equipment in the terrestrial core network 112 receives and processes the message 1508 which includes the instruction generated in step 1504. Operation proceeds from step 1510 to step 1512. In step 1512, network equipment in the terrestrial core network 112 generated message 1518 based on message 1508. Message 1508 includes the instructions generated in step 1504. In some embodiments message 1518 is a copy of or includes message 1508 which is then forwarded by network equipment in the terrestrial core network 112 to WBS 1 110 in step 1516. Operation proceeds from step 1512 to step 1516. In step 1516, the message 1518 is transmitted to WBS 1 110. Operation proceeds from step 1516 to step 1520. In step 1520, WBS 1 110 receives and processes message 1518, and generates message 1522 based on message 1518 and transmits the message 1522 to UE 3 106. The message 1522 includes the instructions generated in step 1504. In some embodiments, message 1522 is message 1518 which is forwarded to UE 3 106 in step 1522. Operation proceeds from step 1520 to step 1524. In step 1524, the UE 3 106 receives the message 1522 from WBS 1 110, determines the message 1522 is for UE 1 102 and generates message 1526 based on message 1522 and transmits message 1526 to UE 1 102 over the D2D communications link. Message 1526 includes the instructions generated in step 1504. In some embodiments, message 1526 is a message 1522. Operation proceeds from step 1524 to step 1528. In step 1528, UE 1 102 receives and processes message 1526. Operation proceeds from step 1528 to step 1530.

In step 1530, the UE 1 102 determines from the instructions included in message 1526 that UE 1 102 is re-instate a direct connection with WBS-1 110 and then terminate the D2D communications connection/link between UE 1 102 and UE 3 106 and free up the RF resources being used for the D2D connection. Operation proceeds from step 1530 to step 1532. In step 1532, UE 1 102 generates message 1534 and transmits the message 1534 directly to WBS 1 110 without going through the D2D connection. The message 1534 includes an establish connectivity initiation request (e.g., a Random Access Channel (RACH) request). Operation proceeds from step 1532 to step 1536. In step 1536, the WBS 1 110 directly receives message 1534 from UE 1 110. The message 1534 not being sent via the D2D connection. Operation proceeds from step 1536 to step 1538. In step 1538, WBS 1 110 generates establish connectivity initiation response message 1542. In some embodiments, the message 1542 includes information identifying the RF resources to be used for the wireless connection/link being established between UE 1 102 and the WBS 1 110. Operation proceeds from step 1538 to step 1540. In step 1540, WBS 1 110 transmits the message 1542 directly to the UE 1 102 in response to message 1534. The message 1542 is not sent through the D2D connection between UE 3 106 and UE 1 102. Operation proceeds from step 1540 to step 1544. In step 1544, the UE 1 102 receives and processes the establishment connectivity initiation response message 1542 from WBS 1 110. Operation proceeds from step 1544 to step 1546 and 1552 where a direct terrestrial wireless connection is established between UE 1 102 and WBS 1 110 (e.g., using the identified RF resources included in the message 1542) through the exchange of message 1550. In step 1552 WBS 1 110 also exchanges messages 1554 with network equipment in the terrestrial core network 112 in step 1556 thereby establishing a communications link for the UE 1 102 to communicate with the terrestrial core network 112 without using the D2D communications link. Exchanging messages including transmitting and receiving messages. In some embodiments, the link between the WBS 1 110 and terrestrial core network 112 is unchanged other than that the messages 1554 are now message received by the WBS 1 110 directly from the UE 1 110 as opposed to being received from UE 3 106 after being communicated over the D2D link and the link between UE 3 106 and WBS 1 110. Operation proceeds to step 1558 shown on FIG. 11H.

In step 1558, the UE 1 102 determines that the direct terrestrial wireless connection/link between UE 1 102 and WBS 1 110 has been successfully established (e.g., based on metrics and measurements of the signals being received from the WBS 1 and acknowledgement from WBS 1 110 on the signals that WBS 1 110 are receiving from UE 1 102 over the established wireless channel. In response to determining that the direct terrestrial wireless connection/link between UE 1 102 and WBS 1 110 has been successfully established, UE 1 102 in step 1560 generates and transmits message 1562 to UE 3 106 over the D2D wireless communications link/connection. The message 1562 indicates that the D2D connection between UE 1 102 and UE 3 106 is terminated. Operation proceeds from step 1560 to step 1564. In step 1564, UE 3 106 receives and processes the message 1562. Operation proceeds from step 1564 to step 1566. In step 1566, UE 3 106 terminates the D2D connection/link to UE 1 102 and generates message 1570. Message 1570 includes information reporting that the D2D connection/link between UE 1 102 and UE 3 106 has been terminated per an instruction from UE 1 102. Operation proceeds from step 1566 to step 1568. In step 1568, UE 3 106 transmits message 1570 to WBS 1 110. Operation proceeds from step 1568 to step 1572. In step 1572, WBS 1 110 receives and processes message 1572. Operation proceeds from step 1572 to step 1578. In step 1578, WBS 1 110 determines based on the information reported in message 1570 that the D2D wireless communications link/connection between UE 3 106 and UE 1 102 has been terminated based on instructions from UE 1 102.

Returning to operations occurring at UE 1 102, in step 1574 UE 1 102 makes the determination to terminate the satellite connection based on the establishment of the direct terrestrial wireless connectivity between UE 1 102 to WBS 1 110. In some embodiments, the determination is further based on metrics and measurements made with respect to the direct terrestrial wireless connectivity between UE 1 102 and WBS 1 110 (e.g., the metrics and measurements used in determining to terminate the D2D connection with UE 3 106.) Operation proceeds from step 1574 to step 1576. In step 1576, UE 1 102 terminates its satellite connection to satellite 116 and disables the satellite service functionality enabled in step 1144. In some embodiments, UE 1 102 sends a satellite service termination message to the satellite 116 and then terminates the connection to the satellite 116. The satellite service termination message including an indication that UE 1 102 is intentionally terminating the satellite connection so that the satellite 116 can gracefully terminate the service and report the termination to the satellite core network 118. The UE 1 102 in step 1576 also disables the satellite connection functionality which was enabled in step 1144 as part of terminating the satellite connection.

In step 1590, satellite 116 detects UE 1 satellite connection termination. In some embodiments, the satellite 116 receives a message from the UE 1 102 indicating that the satellite connection and service is to be terminated/disabled. Operation proceeds from step 1590 to step 1592. In step 1592, satellite 116 generates message 1596. Message 1596 includes information reporting the termination of the wireless connection between UE 1 102 and satellite 116. Operation proceeds from step 1592 to step 1594. In step 1594, satellite 116 transmits message 1596 to the satellite core network 118. Operation proceeds from step 1594 to step 1598. In step 1598, the satellite core network 118 receives the message 1596 and updates its records to indicate that the connection between UE 1 102 and satellite 116 has been terminated. If the satellite 116 also reports that the termination was intentionally per a message from the UE 1 102 this information is also included in the records maintained by the satellite core network 118. Satellite core network 118 terminates tracking of UE 1 102 and updates it records to reflect that tracking of the location of UE 1 102 has been terminated. Operation proceeds from step 1598 to step 1600. In step 1600, network equipment in the satellite core network 118 generate message 1602 and transmit message 1602 to the CMCS 114. The message 1602 includes information reporting that the UE 1 satellite connection has been terminated. The message 1602 also in some embodiments includes information indicating that the connection was intentionally terminated by the UE 1 102. In some embodiments, the message 1602 further includes information that satellite network is no longer tracking UE 1 102's location and that the prior reported location information is now outdated/stale. Operation proceeds from step 1600 to step 1604. In step 1604, the CMCS 114 receives and processes message 1602.

Returning to operations occurring at the WBS 1 110, operation proceeds from step 1572 to step 1578. In step 1578, the WBS 1 110 determines that the UE 3 106 to UE 1 102 D2D connection/link has been terminated based on the information included in message 1570. Operation proceeds from step 1578 to step 1580. In step 1580, the WBS 1 110 in response to determining that the D2D connection/link between UE 3 106 and UE 2 102 has been terminated, releases the RF resources for the terminated D2D connection/link between UE 3 106 and UE 1 102 for use by other wireless devices in the terrestrial wireless network. Operation proceeds from step 1580 to step 1582. In step 1582, WBS 1 110 generates notification message 1586 which includes information indicating that the UE 1 102 to UE 3 106 D2D connection/link has been terminated and that the direct terrestrial wireless connection between WBS 1 110 to UE 1 102 has been established. The message 1586 in some embodiments also includes information that the RF resources being used for the D2D connection/link between UE 3 106 and UE 1 102 have been released. Operation proceeds from step 1582 to step 1584. In step 1584, WBS 1 110 transmits notification message 1586 to network equipment in the terrestrial core network 112. Operation proceeds from step 1584 to step 1588. In step 1588, network equipment in the terrestrial core network 112 receive and process the notification message 1586. Operation proceeds from step 1588 to step 1606. In step 1606, network equipment in the terrestrial core network 112 generates and transmits message 1608 to CMCS 114. The message 1608 includes information reporting that the UE 1 102 to WBS 1 110 terrestrial wireless connectivity has been successfully re-instated and that the D2D connection/link between UE 3 106 and UE 1 102 has been terminated. In some embodiments, the message 1608 also includes information reporting that the RF resources for the D2D connection/link between UE 3 106 and UE 1 102 have been released for use by other wireless entities in the terrestrial wireless network. Operation proceeds from step 1606 to step 1610.

In step 1610, the CMCS 114 receives and processes the message 1608 from network equipment in the terrestrial core network 112. Operation proceeds from step 1610 to step 1612. In step 1612, CMCS 114 updates the records for UE 1 terrestrial and satellite connectivity stored in its memory/storage and/or a storage system connected to the CMCS 114. The UE 1 connectivity information is updated to indicate that UE 1 102 has terrestrial wireless connectivity and that UE 1 102 has terminated its satellite connectivity. The updated terrestrial wireless connectivity information for UE 1 102 is based on the information reported in message 1608. The updated satellite wireless connectivity is based on information reported in message 1602. Operation proceeds from step 1612 to step 1614. In step 1614, the CMCS 114 updates the records for UE 3 106 to UE 1 102 D2D connection/link to indicate that it has been terminated and the RF resources for the D2D connection has been released. This information is based on the message 1608 received from the terrestrial core network 112.

Returning to operation being performed at UE 2 104. In step 1616 shown on FIG. 11I, UE 2 104 makes the determination to power down the UE 2 104 device based on user input to the device. For example, in the case where the user of UE 2 104 is a hiker the user inputs a power down command to turn off the user equipment device UE 2 104 to save power. Operation proceeds from step 1616 to step 1618. In step 1618, before powering down UE 2 104 generates and transmits a D2D connection/link termination message 1620 to UE N 108. The message 1620 notifies UE N 108 that UE 2 104 is terminating the D2D connection/link between UE 2 104 and UE N 108. Operation proceeds from step 1618 to step 1622. In step 1622, the UE N 108 receives and processes the message 1620. Operation proceeds from step 1622 to step 1624.

In step 1624, UE N 108 also terminates the D2D connection/link to UE 2 104 and generates message 1630. Message 1630 includes information reporting that the D2D connection/link between UE 2 104 and UE N 108 has been terminated per an instruction from UE 2 104. Operation proceeds from step 1624 to step 1628. In step 1628, UE N 108 transmits message 1630 to WBS 1 110. Operation proceeds from step 1628 to step 1632. In step 1632, WBS 1 110 receives and processes message 1630. Operation proceeds from step 1632 to step 1638. In step 1638, WBS 1 110 determines based on the information reported in message 1630 that the D2D wireless communications link/connection between UE N 108 and UE 2 104 has been terminated based on instructions from UE 2 104.

Returning to operations occurring at UE 2 104, in step 1634 UE 2 104 makes the determination to terminate the satellite connection based on the user input to power down. Operation proceeds from step 1634 to step 1636. In step 1636, UE 2 104 terminates its satellite connection to satellite 116 and disables the satellite service functionality enabled in step 1218. In some embodiments, UE 2 104 sends a satellite service termination message to the satellite 116 and then terminates the connection to the satellite 116. The satellite service termination message includes an indication that UE 2 104 is intentionally terminating the satellite connection so that the satellite 116 can gracefully terminate the service and report the termination to the satellite core network 118. The UE 2 104 in step 1636 also disables the satellite connection functionality which was enabled in step 1218 as part of terminating the satellite connection. Operation proceeds from step 1636 to step 1637. In step 1637, UE 2 104 powers down.

In step 1650, satellite 116 detects UE 2 104 satellite connection termination. In some embodiments, the satellite 116 receives a message from the UE 2 104 indicating that the satellite connection and service is to be terminated/disabled. Operation proceeds from step 1650 to step 1652. In step 1652, satellite 116 generates message 1656. Message 1656 includes information reporting the termination of the wireless connection between UE 2 104 and satellite 116. Operation proceeds from step 1652 to step 1654. In step 1654, satellite 116 transmits message 1656 to the satellite core network 118. Operation proceeds from step 1654 to step 1658. In step 1658, the satellite core network 118 receives the message 1656 and updates its records to indicate that the connection between UE 2 104 and satellite 116 has been terminated. If the satellite 116 also reports that the termination was intentionally per a message from the UE 2 104 this information is also included in the records maintained by the satellite core network 118. Satellite core network 118 terminates tracking of UE 2 104 and updates it records to reflect that tracking of the location of UE 2 104 has been terminated. Operation proceeds from step 1658 to step 1660. In step 1660, network equipment in the satellite core network 118 generate message 1662 and transmit message 1662 to the CMCS 114. The message 1662 includes information reporting that the UE 2 104 satellite connection has been terminated. The message 1662 also in some embodiments includes information indicating that the connection was intentionally terminated by the UE 2 104. In some embodiments, the message 1662 further includes information that satellite network is no longer tracking UE 2 104's location and that the prior reported location information is now outdated/stale. Operation proceeds from step 1660 to step 1664. In step 1664, the CMCS 114 receives and processes message 1662.

Returning to operations occurring at the WBS 1 110, operation proceeds from step 1632 to step 1638. In step 1638, the WBS 1 110 determines that the UE N 108 to UE 2 104 D2D connection/link has been terminated based on the information included in message 1630. Operation proceeds from step 1638 to step 1640. In step 1640, the WBS 1 110 in response to determining that the D2D connection/link between UE N 108 and UE 2 104 has been terminated, releases the RF resources for the terminated D2D connection/link between UE N 108 and UE 2 104 for use by other wireless devices in the terrestrial wireless network. Operation proceeds from step 1640 to step 1642. In step 1642, WBS 1 110 generates notification message 1646 which includes information indicating that the UE 2 104 to UE N 108 D2D connection/link has been terminated. In some embodiments, the message 1646 also including information reporting that the direct terrestrial wireless connection between WBS 1 110 to UE 2 104 has not been re-established. The message 1646 in some embodiments also includes information that the RF resources being used for the D2D connection/link between UE N 108 and UE 2 104 have been released. Operation proceeds from step 1642 to step 1644. In step 1644, WBS 1 110 transmits notification message 1646 to network equipment in the terrestrial core network 112. Operation proceeds from step 1644 to step 1648. In step 1648, network equipment in the terrestrial core network 112 received and processes the notification message 1646. Operation proceeds from step 1648 to step 1666. In step 1666, network equipment in the terrestrial core network 112 generates and transmits message 1668 to CMCS 114. The message 1668 includes information reporting that the D2D connection/link between UE N 108 and UE 2 104 has been terminated. In some embodiments, the message 1668 also reports that the UE 2 104 to WBS 1 110 terrestrial wireless connectivity has not been re-instated. In some embodiments, the message 1668 also includes information reporting that the RF resources for the D2D connection/link between UE N 108 and UE 2 104 have been released for use by other wireless entities in the terrestrial wireless network. Operation proceeds from step 1666 to step 1670.

In step 1670, the CMCS 114 receives and processes the message 1668 from network equipment in the terrestrial core network 112. Operation proceeds from step 1670 to step 1672. In step 1672, CMCS 114 updates the records for UE 2 terrestrial and satellite connectivity stored in its memory/storage and/or a storage system connected to the CMCS 114. The UE 2 connectivity information is updated to indicate that UE 2 104 does not have terrestrial wireless connectivity and that UE 2 104 has terminated its satellite connectivity. The updated terrestrial wireless connectivity information for UE 2 104 is based on the information reported in message 1668. The updated satellite wireless connectivity is based on information reported in message 1662. Operation proceeds from step 1672 to step 1674. In step 1674, the CMCS 114 updates the records for UE N 108 to UE 2 104 D2D connection/link to indicate that it has been terminated and the RF resources for the D2D connection has been released. This information is based on the message 1668 received from the terrestrial core network 112.

While the method 1100 illustrated in FIG. 11, has been explained with respect to just a few user equipment devices, a single wireless base station, a single satellite the method may be, and typically is implemented for many user equipment devices, e.g., mobile devices, with a terrestrial wireless system having a plurality of base stations and the satellite system having a plurality of satellites. In some embodiments, for example the satellite assisted terrestrial wireless device-to-device connection may be a user equipment device with a link to a different wireless base station then the wireless base station from which UE 1 lost its wireless connection or the UE 1 may being receiving reference signals from a different wireless base station than the wireless base station connected to the user equipment device providing the wireless device-to-device connection to UE 1. In some embodiments, the CMCS may determine that multiple UEs will provide wireless device-to-device communications connections to UE 1 to provide additional bandwidth for UE 1.

It should be understood that the operation(s), step(s), and function(s) described in connection with the satellite core network 112, the satellite core network 118, the continuous mobile communications system 114, and the propagation generator and link estimator 111 may be implemented by network entities such as network equipment device(s), network service function(s) and/or other components or systems. Furthermore, in some embodiments, the continuous communications system 114 and/or propagation generator and link estimator 111 may obtain information directly from the terrestrial core network 112 or from the OSS 146 (e.g., information on user equipment devices such as location, movement, connectivity, load and wireless link information for the user equipment devices and the network). The storage system 128 can be and in some embodiments is used store such information as device-to-device connection information for quick access by the CMCS 114 and the propagation generator and link estimator 111. In various embodiments, the first and second user equipment device operate in two modes of operation. The first mode of operation is when the user equipment device has direct wireless connectivity or a direct wireless connection with a base station of the terrestrial wireless network system. In this mode of operation, satellite communications are not enabled. In the second mode of operation, the user equipment device does not have direct wireless connectivity or a direct wireless connection with a base station of the terrestrial wireless network system. In such instance

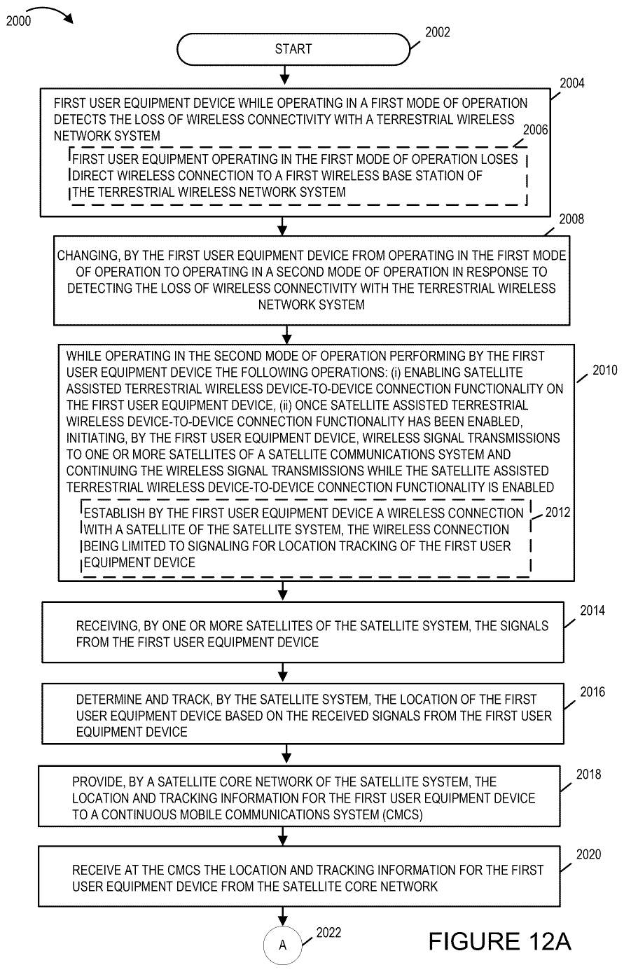

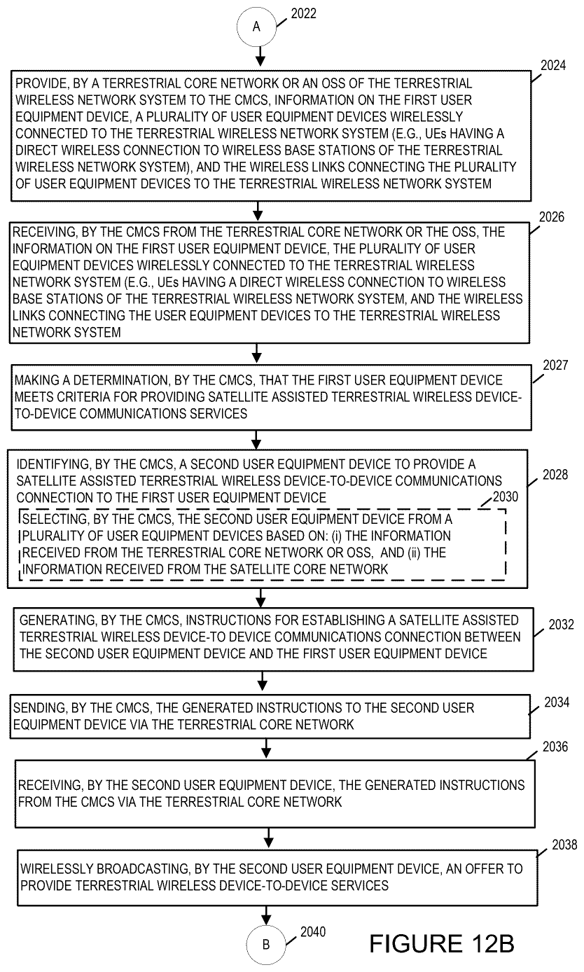

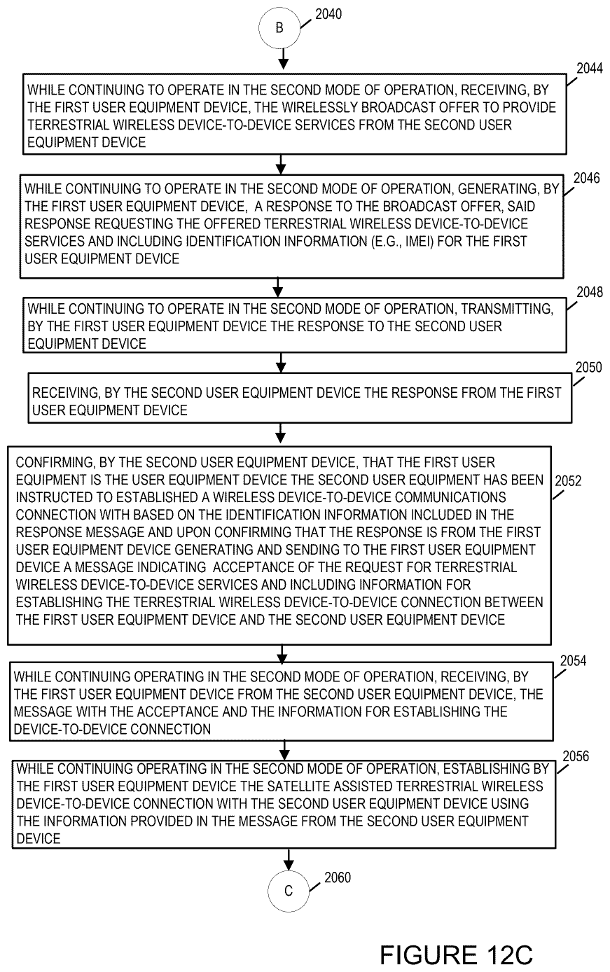

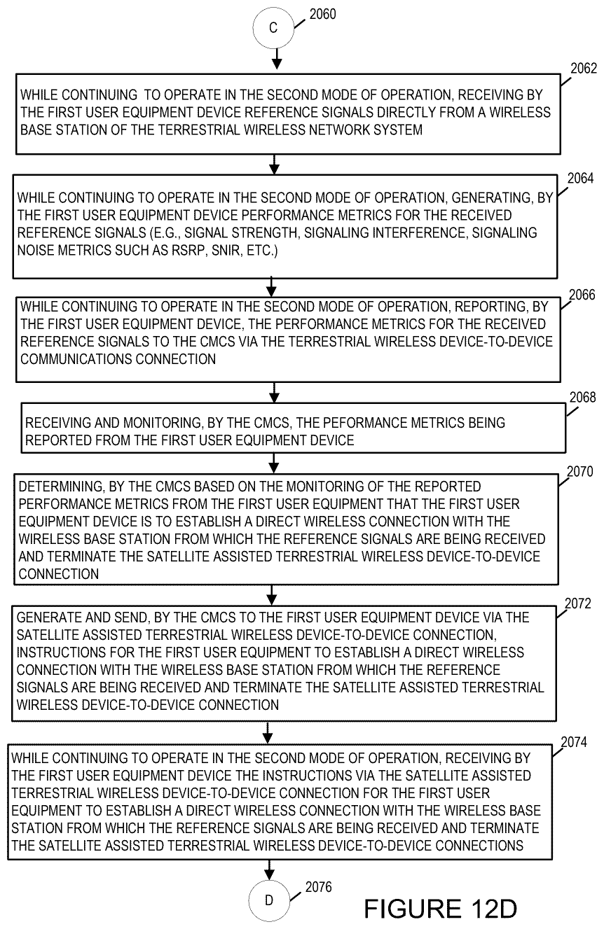

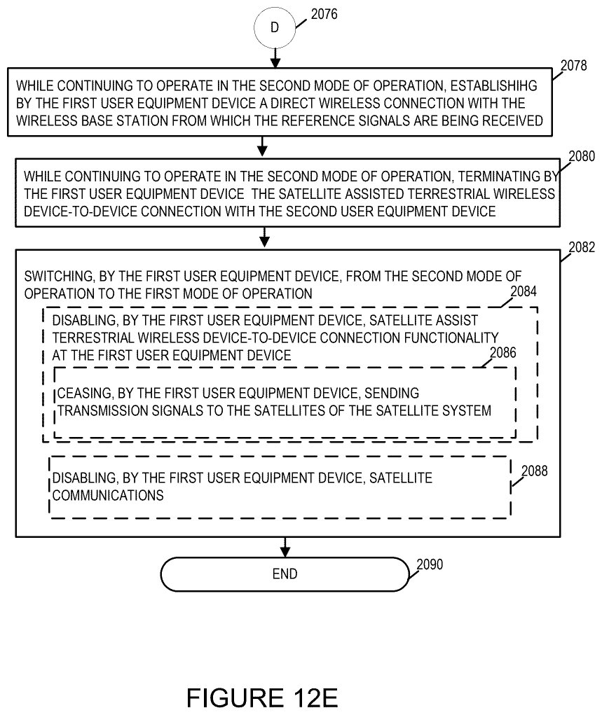

FIG. 12 comprises FIG. 12A, FIG. 12B, FIG. 12C, FIG. 12D, and FIG. 12E. FIG. 12A is the first part of a flowchart of an exemplary method 2000 in accordance with an embodiment of the present invention. FIG. 12B is the second part of a flowchart of an exemplary method 2000 in accordance with an embodiment of the present invention. FIG. 12C is the third part of a flowchart of an exemplary method 2000 in accordance with an embodiment of the present invention. FIG. 12D is the fourth part of a flowchart of an exemplary method 2000 in accordance with an embodiment of the present invention. FIG. 12E is the fifth part of a flowchart of an exemplary method 2000 in accordance with an embodiment of the present invention.

While it will be readily understood that additional steps are performed in connection with communicating information, data, and messages between devices, the method 2000 focuses on and discusses the steps for understanding the invention. The method 2000 will be discussed in connection with the exemplary system 100 but is not limited to being implemented on system 100 shown in FIG. 10 and can be implemented on other systems and other system architectures. For example, the method 200 can be, and in some embodiments is implemented on system 300 shown in FIG. 3.

The method 2000 starts at start step 2002 shown on FIG. 11A. Operation proceeds from start step 2002 to step 2004. In step 2004, the first user equipment device (e.g., UE 1 102 of system 10) while operating in a first mode of operating in a first mode of operation detects the loss of wireless connectivity with a terrestrial wireless network system (e.g., loss of connectivity with the Radio Access Network 209 including the wireless base stations of the Radio Access Network 209 of terrestrial wireless network system 101). In some embodiments, step 2004 includes sub-step 2006. In sub-step 2006, the first user equipment device operating in the first mode of operation loses its direct wireless connection to a first wireless base station (e.g., WBS 1 110 of system 100) of the terrestrial wireless network system. Operation proceeds from step 2004 to step 2008. In step 2008, the first user equipment device changes from operating in the first mode of operation to operating in a second mode of operation in response to detecting the loss of wireless connectivity with the terrestrial wireless network (e.g., the loss of the direct wireless connection with the first wireless base station). In various embodiments, the first mode of operation is a terrestrial wireless only mode of operation in which satellite communications are not enabled at the first user equipment device and the second mode of operations is a mode of operation in which the first user equipment device is enabled to communicate with wirelessly communicate with other communications devices (e.g., user equipment devices and wireless base stations) of the terrestrial wireless network system and satellites of a satellite communications system. In various embodiments, while operating in the first mode of operation the first user equipment device can implement a satellite communications connection with a satellite of the satellite system, a terrestrial wireless connection with a base station of the terrestrial wireless network system, and a wireless device-to-device communications connection with another user equipment device of the terrestrial wireless network system simultaneously. Operation proceeds from step 2008 to step 2010.

In step 2010, the first user equipment device while operating in the second mode of operation performs the following operations: (i) enabling satellite assisted terrestrial wireless device-to-device connection functionality on the first user equipment device, (ii) once satellite assisted terrestrial wireless device-to-device functionality has been enabled, the first user equipment device initiates wireless signal transmissions to one or more satellites of a satellite communications system and continues the wireless signal transmissions while the satellite assisted terrestrial wireless device-to-device connection functionality is enabled. In some embodiments, step 2010 includes sub-step 2012. In sub-step 2012, the first user equipment device establishes a wireless connection with a satellite of the satellite communications system. The wireless connection established with the satellite is limited to signaling for location tracking of the first user equipment device. Operation proceeds from step 2010 to step 2014. In step 2014, one or two or more satellites (e.g., satellite 116) of the satellite system receive the signals from the first user equipment device. Operation proceeds from step 2014 to step 2016. In step 2016, the satellite system determines and tracks the location of the first user equipment device based on the received signals from the first user equipment device (e.g., using triangulation or other methods). The satellite system having a plurality of satellites (e.g., hundreds or thousands of satellites deployed in a low earth orbit). Operation proceeds from step 2016 to step 2018. In step 2018, a satellite core network (e.g., satellite core network 118 of system 100) of the satellite communications system provides the location and tracking information for the first user equipment device to a continuous mobile communications system (CMCS) (e.g., CMCS 114 of system 100). Operation proceeds from step 2018 to step 2020. In step 2020, the CMCS receives the location and tracking information for the first user equipment device from the satellite core network. In some embodiments, the location and tracking information include a plurality of geographical coordinates with timestamps indicating when the first user equipment device was determined to be at the geographical coordinate. In some embodiments, the location and tracking information further includes speed and direction of movement of the first user equipment device while in other cases this information is derived by the CMCS from the tracking information provided by the satellite core network. Operation proceeds from step 2020 via connection node A 2022 to step 2024 shown on FIG. 12B.

In step 2024, the terrestrial core network or Operational Support Systems (OSS) (e.g., OSS 124) of the terrestrial wireless network 101 provide to the CMCS information on: (i) the first user equipment device, (ii) a plurality of user equipment devices wirelessly connected to the Radio Access Network of terrestrial wireless network system (e.g., UEs such as UE 3 106, UE 4 107, . . . , UE N 108 connected to the WBS 1 110 of RAN 209 of the terrestrial wireless network system 101), and (iii) the wireless links connecting the user equipment device to the terrestrial wireless network system. In some embodiments, the information may be provided by a combination of the terrestrial wireless core network and the OSS. Operation proceeds from step 2024 to step 2026. In step 2026, the CMCS receives from the terrestrial core network or the OSS the information on: (i) the first user equipment device, (ii) a plurality of user equipment devices wirelessly connected to the Radio Access Network of terrestrial wireless network system (e.g., UEs such as UE 3 106, UE 4 107, . . . , UE N 108 connected to the WBS 1 110 of RAN 209 of the terrestrial wireless network system 101), and (iii) the wireless links connecting the user equipment device to the terrestrial wireless network system. In some embodiments, the information is received from a combination of the terrestrial wireless core network and the OSS. Operation proceeds from step 2026 to step 2027.

In step 2027, the CMCS makes a determination that the first user equipment device meets criteria for providing satellite assisted terrestrial wireless device-to-device communications services. In some embodiments, the criteria is based on whether the first user equipment device is subscribed for satellite assisted terrestrial wireless device-to-device communications services. This information being obtained from the UDM function of the terrestrial wireless core network of the terrestrial wireless network system. In some embodiments, the criteria further includes determining that the first user equipment device has lost its connectivity or connection with the terrestrial wireless network system for example via a notification from the terrestrial wireless network core or by receiving information on the location of the first user equipment device from the satellite system. In some embodiments, the criteria includes: (i) the first user equipment device is moving at a speed less than a first speed threshold amount (e.g., the speed threshold identifying stationary or slow moving user equipment devices—such as the speed of an individual who is stationary or walking such as for example a speed of less than 2 miles an hour), (ii) the first user equipment device has a subscription to a terrestrial wireless network and a subscription to a satellite wireless network, and (iii) the first user equipment device does not have wireless connectivity with the terrestrial wireless network (i.e., the first user equipment device does not have capability to establish a wireless connection or link to the terrestrial wireless network (e.g., the first user equipment device is outside the coverage area of the base stations of the terrestrial wireless network or is in a location where the wireless signal of the base stations of the terrestrial wireless network are being blocked (e.g., by terrain or clutter or the signals from the first user equipment device to the terrestrial wireless network are being blocked (e.g., by terrain or clutter)))). Operation proceeds from step 2027 to step 2028.

In step 2028, the CMCS identifies a second user equipment device (e.g., UE 3 106 of system 100) to provide a satellite assisted terrestrial wireless device-to-device communications connection to the first user equipment device from the plurality of user equipment devices for which information was provided to the CMCS using the provided information. In some embodiments, step 2028 including sub-step 2030. In sub-step 2030, the CMCS selects the second user equipment device from a plurality of user equipment devices based on: (i) the information received the terrestrial wireless core network and/or the OSS, and (ii) information received from the satellite core network (e.g., location and tracking information provided on the first user equipment device). In some embodiments, the identification is further based on information provided by a propagation generator and link estimator including information about which of the plurality of user equipment devices are capable of supporting a wireless device-to-device communications link to the first user equipment device and attributes about the device-to-device communications link which could be supported (e.g., bandwidth, bit rate, signal path loss, etc.).

In some embodiments, identifying the second user equipment device to provide the satellite assisted terrestrial wireless device-to-device communications connection includes: selecting the second user equipment device from a plurality of user equipment devices having a terrestrial wireless connection to a wireless base station of a terrestrial wireless network to which the first user equipment device is subscribed based on one or more or any combination of the following: (i) distance between the first user equipment and user equipment devices of the plurality of user equipment devices, (ii) signal interference information, (iii) modulation rates supported by user equipment devices of the plurality of user equipment devices, (iv) load on the network, (v) individual load on the user equipment devices of the plurality of user equipment devices, (vi) user equipment device category of the first user equipment device, (vii) user equipment device capabilities of the first user equipment device, (viii) user equipment device type of the first user equipment device; (ix) user equipment device category of user equipment devices of the plurality of user equipment devices, (x) user equipment device capabilities of the user equipment devices of the plurality of user equipment devices, (xi) user equipment device type of the user equipment devices of the plurality of user equipment devices, (xii) information on the wireless links connecting the user equipment devices of the plurality of user equipment devices to terrestrial wireless base stations, (xiii) information on the movement (e.g., direction and/or speed) of the first user equipment device, (xiv) information on the movement (e.g., direction and/or speed) of the user equipment devices of the plurality of user equipment devices, (xv) contracted for quality of service of the first user equipment device, (xvi) contracted for quality of service of the user equipment devices of the user equipment devices of the plurality of user equipment devices, (xvii) estimated quality of service of wireless device-to-device connections that could be provided by user equipment devices of the plurality of user equipment devices, (xviii) measured received signal strength of signals from user equipment devices of the plurality of user equipment devices provided by the base stations to which the user equipment devices are connected. Operation proceeds from step 2028 to step 2032.

In step 2032, the CMCS generates instructions for establishing a satellite assisted terrestrial wireless device-to-device communications connection between the second user equipment device and the first user equipment device. Operation proceeds from step 2032 to step 2034. In step 2034, the CMCS sends the generated instructions for establishing a satellite assisted terrestrial wireless device-to-device communications connection between the second user equipment device and the first user equipment device to the second user equipment device via the terrestrial wireless core network. The generated instructions traverse the path from the CMCS to terrestrial wireless core network to a wireless base station (e.g., WBS 1 110) to which the second user equipment device (e.g., UE 3 106 of system 100) and from that wireless base station to the second user equipment device. Operation proceeds from step 2034 to step 2036. In step 2036, the second user equipment device receives the instructions for generating the satellite assisted terrestrial wireless device-to-device communications connection between the second user equipment device and the first user equipment device. Operation proceeds from step 2036 to step 2038. In step 2038, the second user equipment device generates and wirelessly broadcasts or announces an offer to provide terrestrial wireless device-to-device services in accordance with the received instructions (e.g., using a proximity services discovery announcement message to wireless devices in the second user equipment devices proximity). In some embodiments, the radio frequencies used for the broadcast are specifically designated for the device-to-device discovery messaging and the first user equipment device after enabling the satellite assisted terrestrial wireless device-to-device service began listening on the designated frequencies for a broadcast or announcement offering device-to-device wireless services. Operation proceeds from strep 2038 via connection node B 2040 to step 2044 shown on FIG. 12C.

In step 2044, while continuing to operate in the second mode of operation, the first user equipment device receives the wirelessly broadcast or announced offer to provide terrestrial wireless device-to-device services from the second user equipment device. Operation proceeds from step 2044 to step 2046. In step 2046, while continuing to operate in the second mode of operation, the first user equipment device generates a response (e.g., a response message) to the broadcast or announced offer, said response requesting the offered terrestrial wireless device-to-device services and including identified information (e.g., IMEI (International Mobile Equipment Identifier) for the first user equipment device. Operation proceeds from step 2046 to step 2048. In step 2048 while continuing to operate in the second mode of operation, the first user equipment device transmits the response to the second user equipment device. Operation proceeds from step 2048 to step 2050. In step 2050, the second user equipment device receives the response from the first user equipment device. Operation proceeds from step 2050 to step 2052. In step 2052, the second user equipment device confirms that the first user equipment device is the user equipment device the second user equipment device has been instructed to establish a terrestrial wireless device-to-device communications connection with based on the identification information included in the response message from the first user equipment device. Upon confirming that the response is from the first user equipment device generating and sending to the first user equipment device a message indicating acceptance of the request for terrestrial wireless device-to-device services. The message includes information for establishing the terrestrial wireless device-to-device communications connection between the first user equipment device and the second user equipment device. The information includes identification of radio resource to be used and configuration parameters (e.g., radio frequency spectrum or channel, data rate, modulation scheme) for the device-to-device connection. The radio resource information and configuration parameters having been provided in part or in totality by the CMCS in the instructions sent by the CMCS to the second user equipment device. Operation proceeds from step 2052 to step 2054.

In step 2054, while continuing to operate in the second mode of operation, receiving by the first user equipment device from the second user equipment device, the message with the acceptance and the information for establishing the device-to-device communications connection between the second user equipment device and the first user equipment device. Operation proceeds from step 2054 to step 2056. In step 2056, while continuing to operate in the second mode of operation, establishing by the first user equipment device the satellite assisted terrestrial wireless device-to-device connection with the second user equipment device using the information provided in the message from the second user equipment device. Operation proceeds from step 2056 to step 2062 shown on FIG. 12D via connection node C 2060.

In step 2062, while continuing to operate in the second mode of operation, the first user equipment device receives reference signals directly from a wireless base station of the terrestrial wireless network system (e.g., wireless base station 1 110 of system 100). The receipt of the reference signals can be and in some embodiments is the result of the first user equipment device moving a different location where the reference signal from the first wireless base station is not blocked by clutter or terrain. Operation proceeds from step 2062 to step 2064. In step 2064, while continuing to operate in the second mode of operation, the first user equipment device generates performance metrics for the received reference signals (e.g., signal strength, signaling interference, signaling noise metrics such as for example Reference Signal Received Strength (RSRP) metrics, Signal-to-Noise and Interference Ratio (SNIR) metrics), etc.). Operation proceeds from step 2064 to step 2066. In step 2066, while continuing to operate in the second mode of operation, the first user equipment device reports (e.g., sends) the performance metrics for the received reference signals to the CMCS via the terrestrial wireless device-to-device communications connection. For example, by reporting the performance metrics to the terrestrial wireless core network which in turn reports them to the CMCS. Operation proceeds from step 2066 to step 2068. In step 2068, the CMCS receives and monitors the performance metrics being reported from the first user equipment device (e.g., for a period of time). Operation proceeds from step 2068 to step 2070. In step 2070, the CMCS determines based on the monitoring of the reported performance metrics from the first user equipment device that the first user equipment device is to establish a direct wireless connection with the wireless base station from which the reference signals are being received and terminate the satellite assisted terrestrial wireless device-to-device connection. In some embodiments, the determination is made based on the RSRP being above a threshold RSRP level for a first continuous duration or period of time and/or the SNIR being above a SNIR threshold level for the same first continuous duration or period of time. The threshold RSRP level and SNIR level with the continuous period of time indicating that a wireless connection if established would be stable for signals sent to the first user equipment device from the wireless base station. Operation proceeds from step 2070 to step 2072.

In step 2072, the CMCS generates and sends to the first user equipment device via the satellite assisted terrestrial wireless device-to-device connection instructions for the first user equipment device to establish a direct wireless connection with wireless base station from which the reference signals are being received and terminate the satellite assisted terrestrial wireless device-to-device connection with the second user equipment device. Operation proceeds from step 2072 to step 2074. In step 2074, while continuing to operate in the second mode of operation, the first user equipment devices receives via the satellite assisted terrestrial wireless device-to-device connection with the second user equipment device the instructions to establish a direct wireless connection with wireless base station from which the reference signals are being received and terminate the satellite assisted terrestrial wireless device-to-device connection with the second user equipment device. Operation proceeds from step 2074 via connection node D 2076 to step 2078 shown on FIG. 12E.

In step 2078, while continuing to operate in the second mode of operation, the first user equipment device establishes a direct wireless connection with the wireless base station form which the reference signals are being received (e.g., wireless base station 1 110 of system 100). Operation proceeds from step 2078 to step 2080. In step 2080, while operating in the second mode of operation, the first user equipment device terminates the satellite assisted terrestrial wireless device-to-device communications connection with the second user equipment device. Operation proceeds from step 2080 to step 2082. In step 2082, the first user equipment device switches form the second mode of operation back to the first mode of operation. In some embodiments, step 2082 includes one more sub-steps 2084, 2086 and 2088. In sub-step 2084, the first user equipment disables the satellite assist terrestrial wireless device-to-device connection functionality at the first user equipment device. In some embodiments sub-step 2084 includes sub-step 2086. In sub-step 2086, the first user equipment device ceases sending transmission signals to the satellites of the satellite communications system. In sub-step 2088, the first user equipment device disables satellite communications (e.g., by powering down the first user equipment device satellite transmitter and/or receiver). Operation proceeds from step 2082 to end step 2090 where the method 2000 completes. If the first user equipment device loses connectivity with the terrestrial wireless network system again the process is repeated with the CMCS identifying the best UE from the plurality of UEs of the system to provide a new satellite assisted terrestrial wireless device-to-device connection to the first user equipment device. It should be understood that the satellite assisted terrestrial device-to-device communications connection once established can be used for voice call services and/or data services with other communications devices connected and/or coupled to the terrestrial wireless network system.

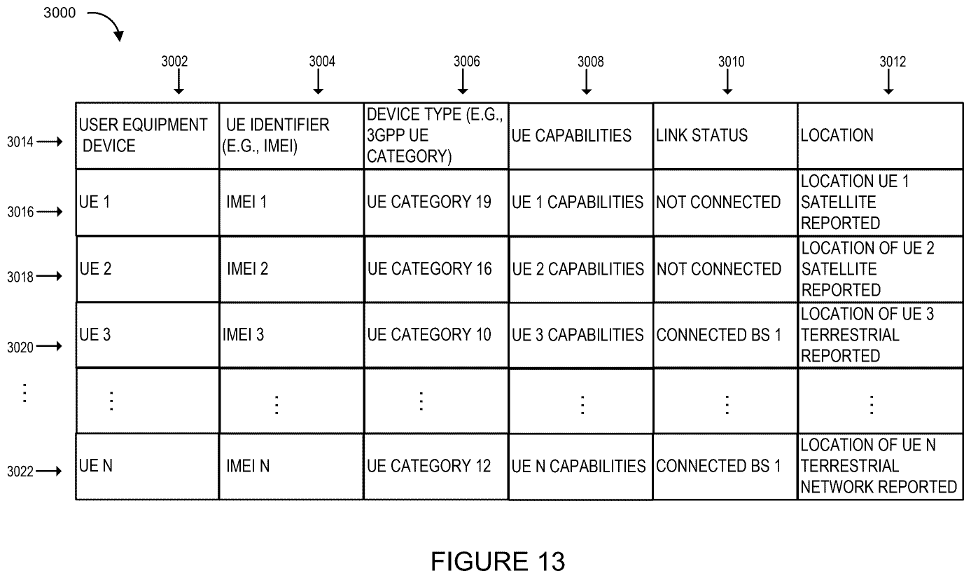

Table 3000 of FIG. 13 illustrates exemplary user equipment device information and link status information used by a Continuous Mobile Communications System to determine whether a user equipment device meets the criteria for being provided satellite assisted terrestrial device-to-device communications services. The information in table 3000 is also used by the Continuous Mobile Communications System to identify user equipment devices to provide satellite assisted terrestrial wireless device-to-device services to other user equipment devices which do not have terrestrial wireless connectivity. The Continuous Mobile Communications System (CMCS) has overall picture of the terrestrial wireless network system and can therefore identify the best UE to provide a satellite assisted terrestrial wireless device-to-device connection as well as the radio resources and configuration for the device-to-device link (e.g., radio frequency spectrum channels to use, bandwidth for the link, data rate for the link, etc.) This allows for and facilities the CMCS ability to maximize the use of the terrestrial wireless network's radio resources in an efficient and effective manner. The information included in the table is only exemplary and other information as discussed herein may be, and in some embodiments is, also included in the table such as information about each of the wireless links of the terrestrial wireless network system.

The table 3000 includes columns 3002, 3004, 3006, 3008, 3010, 3012, and rows 3014, 3016, 3018, 3020, . . . , 3022. The entries in row 3014 are labels indicating the information contained in each column. Entries in column 3002 are user equipment devices (entry row 3014, column 3002). Entries in column 3004 are the user equipment device identifier for the UE in the same row (e.g., International Mobile Equipment Identifier (IMEI) for the UE (entry row 3014, column 3004). Entries in column 3006 are the UE device type for the UE in the same row (e.g., 3GPP UE category) (entry row 3014, column 3006). Entries in column 3008 are the UE capabilities for the UE in the same row (entry row 3014, column 3008). The entries in column 3010 are link status for the UE in the same row (entry row 3014, column 3010). The entries in column 3012 are location information for the UE in the same row (entry row 3014, column 3012. Table 3000 provides information for UE 1 (entries in row 3016), UE 2 (entries in row 3018), UE 3 (entries in row 3020), . . . , UE N (entries in row 3020).

The entries in each row include information corresponding to the user equipment device in column 3002 of the row. For example, row 3002 includes information for user equipment device 1 (UE 1) (entry row 3016, column 3002). The entries in row 3016 indicate that UE 1 (entry row 3016, column 3002) has identifier IMEI 1 (entry row 3016, column 3004), device type UE category 19 (entry row 3016, column 3006), UE 1 capabilities which represent the capabilities of UE 1 such as supported dates, modulation schemes, spectrum frequencies, device-to-device capabilities, wireless communications capabilities (e.g., terrestrial only, satellite and terrestrial, satellite assisted terrestrial wireless device-to-device capabilities, radio spectrum supported, data rate supported, bandwidth steering support, wireless protocols supported, etc.) (entry row 3016, column 3008), UE 1 link status is not connected that is it does not have connectivity with a terrestrial wireless base station of the terrestrial wireless network system at the present time (if the UE 1 had been connected the link status would include connected and information about the link such as bandwidth, data rate, base station to which it is connected, load on the link, radio resources being used for the link) (entry row 3016, column 3010), and UE 1 location information (e.g., geographical coordinates and a time stamp for UE 1 with an indication that the information was reported by the satellite system (entry row 3016, column 3012). This information may be, and in some embodiments, is stored at the CMCS or in a storage system accessible to the CMCS such as for example storage system 126 of system 100.

FIG. 4 is a drawing of an exemplary terrestrial wireless base station 400 (e.g., a gNodeB (gNB)) in accordance with an exemplary embodiment. The wireless base station 400 supports operations for user equipment device to device wireless operations and Proximity Service (ProSe) requirements and operations. Exemplary wireless base station 400 includes a wireless interface 404, a network interface 405, e.g., a wired or optical interface, a processor 406, e.g., a CPU, an assembly of hardware components 408, e.g., an assembly of circuits, and I/O interface 410, timer, e.g. reference clock 411 including a local oscillator 413, and memory 412 coupled together via a bus 409 over which the various elements may interchange data and information. Wireless base station 400 further includes a speaker 452, a display 454, switches 456, keypad 458 and mouse 459 coupled to I/O interface 410, via which the various I/O devices (452, 454, 456, 458, 459) may communicate with other elements (404, 405, 406, 408, 411, 412) of the wireless base station 400. Network interface 405 includes a receiver 478 and a transmitter 480. In some embodiments, receiver 478 and transmitter 480 are part of a transceiver 484. Wireless interfaces 404 include a plurality of wireless interfaces including first wireless interface 424, second wireless interface 450, . . . , Kth wireless interface 455. The wireless interfaces are used to communicate with the wireless devices, e.g., user equipment device, e.g., DSDS user equipment devices. The first wireless interface 424 is used for example to communicate with a first user equipment device using a first spectrum band. The second wireless interface can be used to communicate with a second user equipment device using a second spectrum band. The first wireless interface 424 includes wireless receiver 438 and a wireless transmitter 440. In some embodiments, receiver 438 and transmitter 440 are part of a transceiver. In various embodiments, the first wireless interface 424 includes a plurality of wireless receivers and a plurality of wireless transmitters. Wireless receiver 438 is coupled to a plurality of receive antennas (receive antenna 1 439, . . . , receive antenna M 441), via which wireless base station 400 can receive wireless signals from other wireless communications devices including a second wireless communications device, e.g., a user equipment device. Wireless transmitter 440 is coupled to a plurality of wireless transmit antennas (transmit antenna 1 443, . . . , transmit antenna N 445) via which the wireless base station 400 can transmit signals to other wireless communications devices including a second wireless communications device, e.g., a user equipment device.

The second wireless interface 450 includes wireless receiver 452 and a wireless transmitter 454. In some embodiments, receiver 452 and transmitter 454 are part of a transceiver. In various embodiments, the second wireless interface 450 includes a plurality of wireless receivers and a plurality of wireless transmitters. Wireless receiver 452 is coupled to one or more receive antennas (receive antenna 1 456, . . . , receive antenna M 457), via which wireless base station 400 can receive wireless signals from other wireless communications devices including a second wireless communications device, e.g., a UE device, using the same or a different wireless protocol than the first wireless interface. Wireless transmitter 454 is coupled to one or more wireless transmit antennas (transmit antenna 1 458, . . . , transmit antenna N 460) via which the wireless base station 400 can transmit signals to other wireless communications devices including a second wireless communications device. The wireless base station network interface 405 may be coupled to a cable modem, a terrestrial core network, other networks, e.g., internet, or other wireless base stations.

Memory 412 includes an assembly of components 414, e.g., an assembly of software components, and data/information 416. Data/information 416 includes UE information 460, link information 461, and D2D information 462. The UE information includes information on the user equipment devices attached/connected to the wireless base station either directly or via a UE hosted D2D link. The link information 461 includes information on the links between the user equipment devices and the wireless base station as well as information on the D2D links which the user equipment devices are hosting/supporting (e.g., data rate, bandwidth, radio frequency resources being utilized, channel assignments, link speed, congestion information, link capacity, load on the link). The D2D information 462 includes information on the D2D links being supported by the UEs which are connected to the wireless base station as well as instructions received from the CMCS by the wireless base station for the establishment of a satellite assisted terrestrial wireless device-to-device connection to be established by user equipment device connected to the wireless base station.

While the details of the first and second wireless interfaces are shown, the other wireless interfaces of the wireless base station, e.g., wireless interface K where K is an integer greater than 2 also include multiple receivers and transmitters so that the wireless base station 400 can provide wireless services to for example a plurality of wireless devices such as user equipment devices. In some embodiments, one or more of the wireless base stations discussed and/or shown in the Figures and/or in connection with the methods discussed herein are implemented in accordance with the wireless base station 400. For example, the terrestrial wireless base stations 303 and 304 of system 300 shown in FIG. 3, the terrestrial wireless base stations 1 110, . . . , X 113, X being an integer greater than 1 of system 100 of FIG. 10, the wireless base station 1 110 illustrated in FIG. 11 may be, and in some embodiments are, implemented in accordance with the terrestrial wireless base station 400.

FIG. 5 is a drawing of an exemplary user equipment (UE) device 500 in accordance with an exemplary embodiment. UE device 500 is, e.g., a wireless device, e.g., a mobile device such as a cell phone, a smart phone, wireless tablet or wireless notebook. UE device 500 is a multi-SIM dual subscriber device that is enabled to communicate with terrestrial wireless base stations and satellite systems utilizing different wireless spectrum and/or wireless protocols, e.g., 5G wireless protocol, satellite protocols, cellular wireless protocol. In various embodiments, the multi-SIM dual subscriber UE 500 serves as an intermediary device providing wireless device-to-device connections between a terrestrial wireless base station and another user equipment device which does not terrestrial wireless connectivity. In various embodiments, multi-SIM dual subscriber UE 500 has satellite assisted terrestrial wireless device-to-device capabilities. Exemplary UE device 500 includes wireless interfaces 504, a network interface 505, a processor 506, e.g., a CPU, an assembly of hardware components 508, e.g., an assembly of circuits, and I/O interface 510, a GPS or GNSS receiver 502 coupled to a GPS/GNSS antenna 507, a multi-SIM card interface 570 including a first SIM card, SIM card 1 571, corresponding a first service provider which terrestrial wireless communications services, and a second SIM card, SIM card 2 572 corresponding to a second service provider which provides satellite service (e.g., satellite assist terrestrial D2D services, satellite voice communications services, satellite data services and/or satellite location tracking services), and memory 512 coupled together via a bus 509 over which the various elements may interchange data and information. UE device 500 further includes a microphone 560, camera 561, speaker 562, a display 564, e.g., a touch screen display, switches 566, keypad 568 and mouse 569 coupled to I/O interface 510, via which the various I/O devices (560, 561, 562, 564, 566, 568, 569) may communicate with other elements (502, 504, 505, 506, 508, 512, 570) of the UE device. Network interface 505 includes a receiver 578 and a transmitter 580. The network interface 505 can be coupled to routers within the home or customer premises or to wired (e.g., cable) or optical (e.g., fiber-optic) networks. In some embodiments, receiver 578 and transmitter 580 are part of a transceiver 584. In some embodiments, the assembly of hardware components 508 includes a connection manager component 573.

Wireless interfaces 504 include a plurality of wireless interfaces including first wireless interface 536 and a second wireless interface 550. The first wireless interface 536 is, e.g., used to communicate with wireless devices (e.g., terrestrial wireless base stations and other user equipment device) in a first service provider's communications network, e.g., cellular, e.g., gNB base stations of the first service provider's communications network, e.g., using a first set of spectrum and a first communications protocol corresponding to the first service provider. The second wireless interface is, e.g., used to communicate with a wireless device, e.g., a satellite, of a second service provider's communications network. For example, the second wireless interface is used to communicate with satellites of the second service provider using a second set of spectrum and a second communication protocol corresponding to the second service provider. The first wireless interface 536 includes wireless receiver 538 and a wireless transmitter 540. In some embodiments, receiver 538 and transmitter 540 are part of a transceiver. In various embodiments, the first wireless interface 536 includes a plurality of wireless receivers and a plurality of wireless transmitters. Wireless receiver 538 is coupled to a plurality of receive antennas (receive antenna 1 539, . . . , receive antenna M 541), via which user equipment device 500 can receive wireless signals from other wireless communications devices including wireless base stations, e.g., a terrestrial wireless base station of the first service provider and other user equipment devices (e.g., wireless device-to-device communications signals). Wireless transmitter 540 is coupled to a plurality of wireless transmit antennas (transmit antenna 1 543, . . . , transmit antenna N 545) via which the user equipment device 500 can transmit signals to other wireless communications devices including a terrestrial wireless base station of the first service provider. The antennas 539, . . . , 541 and 543, . . . , 545 are typically mounted inside the housing of the wireless device but in some embodiments are located outside the user equipment device housing. In some embodiments the various antennas form an antenna array with the antennas pointing in different directions. In some embodiments, one or more of the antennas are included inside the housing of the user equipment device and the user equipment device includes one or more connections to which exterior antennas may be connected.

The second wireless interface 550 includes wireless receiver 552 and a wireless transmitter 554. In some embodiments, receiver 552 and transmitter 554 are part of a transceiver. In various embodiments, the second wireless interface 550 includes a plurality of wireless receivers and a plurality of wireless transmitters. Wireless receiver 552 is coupled to one or more receive antennas (receive antenna 1 556, . . . , receive antenna M 557), via which user device 500 can receive wireless signals from other wireless communications devices including, e.g. satellites of a second service provider such as a satellite service provider. Wireless transmitter 554 is coupled to one or more wireless transmit antennas (transmit antenna 1 558, . . . , transmit antenna N 560) via which the user equipment device 500 can transmit signals to other wireless communications devices including, e.g. satellites of a second service provider. The user equipment device network interface 505 may be coupled to LAN or WAN networks or routers so that the user equipment device can also obtain services via a hardwired connection in addition to through the wireless interfaces, e.g. when the UE device 500 is at a location where such a connection is possible.

Memory 512 includes an assembly of components 514, e.g., an assembly of software components, and data/information 516. In some embodiments, the assembly of software components 514 includes a satellite assist terrestrial wireless device-to-device component 574. Data/information 516 includes service provider 1 subscription information 517, e.g. credentials for a first terrestrial wireless network service provider, service provider 2 subscription information 518, e.g. credentials and for satellite communications service provider, device-to-device information 520, and reference signal performance metrics 521. The device-to-device information 520 includes information for each D2D connection established including the messages for broadcasting offers of device-to-device connection services, messages for requesting and accepting offers and requests for D2D services, instructions pertaining to D2D connections, radio resources and configuration information for each D2D connection. The reference signal performance metrics 521 are metrics generated by the user equipment device on the reference signals received from wireless base stations including reference signal strength, noise and interference metrics.

In some embodiments, the user equipment devices discussed in the Figures and/or in connection with the embodiments of the present invention described are implemented in accordance with user equipment device 500. For example, UE 1 102, UE 2 104, UE 3 106, UE 4 107, . . . , UE N 108 of system 100 shown in FIGS. 10 and 11, UE A 305, UE B 306, UE C 307, UE D 308, UE E 309, UE F 310 of system 300 shown in FIG. 3 may be, and in some embodiments are, implemented in accordance with user equipment device 500.

FIG. 6 is a drawing of an exemplary network equipment device/system/server (e.g., Continuous Mobile Communications System, Propagation Generator and Link Estimator, terrestrial core network system, satellite core network system, storage system) in accordance with an exemplary embodiment. The network equipment device/system/server 600 will be referred to as network equipment device 600 but it can be and in some embodiments is implemented as a system or a server. The network equipment device includes a plurality of network interfaces 605, . . . , 690, e.g., a wired or optical interface, a processor(s) 606 (e.g., one or more processors), e.g., a CPU, an assembly of hardware components 608, e.g., an assembly of circuits, and I/O interface 610 and memory 612 coupled together via a bus 609 over which the various elements may interchange data and information. The network equipment device 600 further includes a speaker 652, a display 654, switches 656, keypad 658 and mouse 659 coupled to I/O interface 610, via which the various I/O devices (652, 654, 656, 658, 659) may communicate with other elements (605, . . . , 690, 606, 608, 612) of the network equipment device 600. Network interface 605 includes a receiver 678 and a transmitter 680. The network interface 605 is typically used to communicate with other devices, systems or serves, e.g., antenna system, a cable modem termination system, a wireless base station, a terrestrial core network system, a satellite core network system, a Continuous Mobile Communications System, a storage system, a propagation generator and link estimator, etc. In some embodiments, receiver 678 and transmitter 680 are part of a transceiver 684. Network interface 690 includes a receiver 694 and a transmitter 696. The network interface 690 is typically used to communicate with other devices, e.g., other network nodes or components in a core, etc. In some embodiments, receiver 694 and transmitter 696 are part of a transceiver 692. Memory 612 includes an assembly of component 614, e.g., an assembly of software components, and data/information 616.

Data/information 616 includes UE information 630, D2D information 632, link status information 634, link estimate information 635, and propagation model information. The UE information 630 includes for example the information on UEs from the terrestrial wireless network such as UE identification information, connectivity status, UE capabilities, UE type (e.g., UE category), UE location, UE movement information as well as UE information from the satellite system such as UE location and tracking information, UE D2D information, and UE load, UE link information. The D2D information 632 includes information for any D2D connections under evaluation, to be established or which are established including instructions and radio resources and configurations assigned to the D2D connection along with UE information for the D2D connection and base station information for the D2D (i.e., information on the base station to which the UE hosting the D2D is connected). The link status information 634 includes information on each of the links of the terrestrial wireless network. The link estimate information 635 includes information on the potential D2D links including estimated path loss, signaling requirements, link capacity, link speed, etc. determined for example by the propagation generator and link estimator. The propagation model information 636 includes propagation models and terrain and clutter information for evaluating radio signal paths which can be established between user equipment devices as satellite assisted terrestrial wireless device-to-device connections.

In some embodiments, the network equipment devices discussed in the Figures and/or in connection with the embodiments of the present invention described are implemented in accordance with network equipment device/system/server 600. For example, the Continuous Mobile Communications System (CMCS) 114, the storage system 126, the propagation generator and link estimator 111, the OSS 124, satellite core network 118, the network equipment devices NE 1 121, . . . NE Y 122 of the satellite core network 118, the terrestrial wireless core network 112 and the devices/components of the terrestrial wireless core network 112 shown in system 100 of FIG. 10 and the terrestrial core network system 324, propagation generator and link estimator 322, Continuous Mobile Communications System 320, and satellite network core system 326 of system 300 shown in FIG. 3, may be, and in some embodiments are, implemented in accordance with the network equipment device/system/server 600.

FIG. 7 is a drawing of an exemplary satellite 700 in accordance with an exemplary embodiment of the present invention. Satellite 700 is, e.g., a communications satellite with UE position tracking capabilities. Satellite 700 is enabled to communicate and track the position of terrestrial user equipment such as for example the user equipment devices of system 300 and system 100.

Exemplary satellite 700 includes wireless interfaces 704, a network interface 705, processor(s) 706, e.g., a CPU, an assembly of hardware components 708, e.g., an assembly of circuits, and I/O interface 710, a GPS or GNSS component/device 702 coupled to a GPS/GNSS antenna 707, a solar panel system 711 which provides power to the satellite, and propulsion system 770 which is used to move or propel the satellite to different positions or orbits in space, and memory 712 coupled together via a bus 709 over which the various elements may interchange data and information. Satellite 700 further includes a microphone 760, camera 761, speaker 762, a display 764, e.g., a touch screen display, switches 766, coupled to I/O interface 710, via which the various I/O devices (760, 761, 762, 764, 766) may communicate with other elements (702, 704, 705, 706, 708, 711, 770) of the satellite. Network interface 705 includes a receiver 778 and a transmitter 780. The network interface 705 can be coupled to wired (e.g., cable) or optical (e.g., fiber-optic) networks while the satellite is on the ground or troubleshooting/test equipment while the satellite is in space. In some embodiments, receiver 778 and transmitter 780 are part of a transceiver 784. In some embodiments, the assembly of hardware components 712 includes a control routines component 774 that controls the operation of the satellite.

Wireless interfaces 704 include a plurality of wireless interfaces including first wireless interface 736 and a second wireless interface 750. The first wireless interface 736 is, e.g., used to communicate with wireless devices (e.g., terrestrial wireless user equipment devices), e.g., using a first set of spectrum and a first communications protocol. The second wireless interface 750 is, e.g., used to communicate with other wireless devices using a second set of spectrum and a second communications protocol, e.g., other satellites or a satellite ground system or a satellite core network system. In some embodiments, the first and second communications protocols and first and second spectrum are the same. The first wireless interface 736 includes wireless receiver 738 and a wireless transmitter 740. In some embodiments, receiver 738 and transmitter 740 are part of a transceiver. In various embodiments, the first wireless interface 736 includes a plurality of wireless receivers and a plurality of wireless transmitters. Wireless receiver 738 is coupled to a plurality of receive antennas (receive antenna 1 739, . . . , receive antenna M 741), via which user equipment device 700 can receive wireless signals from other wireless communications devices including terrestrial wireless equipment devices. Wireless transmitter 740 is coupled to a plurality of wireless transmit antennas (transmit antenna 1 743, . . . , transmit antenna N 745) via which the satellite 700 can transmit signals to other wireless communications devices including terrestrial user equipment devices. In some embodiments the various antennas form an antenna array with the antennas pointing in different directions. In some embodiments, one or more of the antennas are moveable and can be positioned in different directions based on commands received from other satellites or a satellite communications ground system.

The second wireless interface 750 includes wireless receiver 752 and a wireless transmitter 754. In some embodiments, receiver 752 and transmitter 754 are part of a transceiver. In various embodiments, the second wireless interface 750 includes a plurality of wireless receivers and a plurality of wireless transmitters. Wireless receiver 752 is coupled to one or more receive antennas (receive antenna 1 756, . . . , receive antenna M 757), via which user device 700 can receive wireless signals from other wireless communications devices including, e.g. other satellites and satellite ground systems. Wireless transmitter 754 is coupled to one or more wireless transmit antennas (transmit antenna 1 758, . . . , transmit antenna N 760) via which the satellite 700 can transmit signals to other wireless communications devices including, e.g. satellites or satellite ground systems. The network interface 705 may be coupled to LAN or WAN networks when the satellite is on the ground or to test or trouble shooting equipment when in space.

Memory 712 includes an assembly of components 714, e.g., an assembly of software components, and data/information 716. In some embodiments, the assembly of software components 714 includes a control routines component controls the operation of the satellite 700. Data/information 716 includes UE information 717 and UE location and tracking information 718. The UE information 717 includes information on UEs including request for satellites connections and/or services, connection establishment information, and connection termination information. The UE location and tracking information 718 includes information on UE locations with timestamps and tracking information indicating the change in locations over time.

In some embodiments, the satellites discussed in the Figures and/or in connection with the embodiments of the present invention described are implemented in accordance with satellite 700. For example, satellite 116 of system 100 shown in FIG. 10, and satellites 301 and 302 of system 300 shown in FIG. 3 may be, and in some embodiments are, implemented in accordance with satellite 700.

FIG. 8 is a drawing of an exemplary assembly of components 800 which may be included in an exemplary user equipment (UE) device, e.g., UE device 500 of FIG. 5, in accordance with an exemplary embodiment. The components in the assembly of components 800 can, and in some embodiments are, implemented fully in hardware within a processor, e.g., processor 506, e.g., as individual circuits. The components in the assembly of components 800 can, and in some embodiments are, implemented fully in hardware within the assembly of hardware components 508, e.g., as individual circuits corresponding to the different components. In other embodiments some of the components are implemented, e.g., as circuits, within processor 506 with other components being implemented, e.g., as circuits within assembly of components 508, external to and coupled to the processor 506. As should be appreciated the level of integration of components on the processor and/or with some components being external to the processor may be one of design choice. Alternatively, rather than being implemented as circuits, all or some of the components may be implemented in software and stored in the memory 512 of the UE device 500, with the components controlling operation of UE device 500 to implement the functions corresponding to the components when the components are executed by a processor e.g., processor 506. In some such embodiments, the assembly of components 800 is included in the memory 512 as assembly of software components 514. In still other embodiments, various components in assembly of components 800 are implemented as a combination of hardware and software, e.g., with another circuit external to the processor providing input to the processor which then under software control operates to perform a portion of a component's function. When implemented in software the components include code, which when executed by a processor, e.g., processor 506, configure the processor to implement the function corresponding to the component. In embodiments where the assembly of components 800 is stored in the memory 512, the memory 512 is a computer program product comprising a computer readable medium comprising code, e.g., individual code for each component, for causing at least one computer, e.g., processor 506, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 8 control and/or configure the UE device 500 or elements therein such as the processor 506, to perform the functions of corresponding steps illustrated and/or described in the method of one or more of the flowcharts, signaling diagrams and/or described with respect to any of the Figures. Thus the assembly of components 800 includes various components that perform functions of corresponding one or more described and/or illustrated steps of an exemplary method.

Assembly of components 800 includes a control routines component 802, a communications component 804, a message generator component 806, a message processing component 808, a determinator component 810, a first SIM component 812, a second SIM component 814, a storage component 816, a proximity service component 818, a mode of operation component 820, a satellite assist terrestrial wireless device-to-device component 822, and a performance metrics component 824.

The control routines component 802 is configured to control operation of the UE. The communications component 804 is configured to handle communications, e.g., receipt and transmission of signals and provide protocol signal processing for one or more protocols for the UE. The message generator component 806 is configured to generate messages for transmission to terrestrial wireless base stations, user equipment devices, and satellites such as messages including request and response messages, etc. In some embodiments, the message generator component 806 is a sub-component of the communications component 804.

The message processing component 808 processes received messages, e.g., requests for information. In some embodiments, the message processing component 808 is a sub-component of the communications component 804.

The determinator component 810 makes determination for the user equipment devices such as for example, determining whether to respond to a D2D discovery offer message received from another user equipment device, determining whether terrestrial connectivity with a terrestrial wireless system or base station has been lost, determining whether a terrestrial wireless connection has been lost, determining whether to switch modes of operation, determining whether to enable satellite assist wireless device-to-device functionality on the user equipment device, determining whether to terminate a satellited assisted wireless device-to-device connection, determining performance metrics for reference signals received from a terrestrial wireless base station, determining location information.

The first SIM component 812 is configured to store Subscriber Identity Information, e.g., a first set of credentials for obtaining access to a first service provider/operator's terrestrial wireless network. The second SIM component 814 is configured to store Subscriber Identity Information, e.g., a second set of credentials, for obtaining access to a second service provider/operator's satellite wireless network.

The storage component 816 is configured to perform all operations in storing and retrieving information, e.g., synchronization information, from memory and/or storage devices (e.g., SIMs) located in the user equipment device.

The proximity service component 818 is configured to perform all operation relating to proximity services including receiving, processing, and responding to proximity service offers, generating proximity service requests and responses to requests, exchanging proximity service messages with a Proximity Service function element, performing operations to establish proximity service D2D connections with other devices, e.g., user equipment devices, and execute operations to perform proximity service applications such as establishing proximity service satellite assisted terrestrial wireless device-to-device connections.

The mode of operation component 820 is configured to operate the user equipment device in different modes of operation and determine when to switch between modes of operation and what operations are to be performed when switching between modes of operation.

The satellite assist terrestrial wireless device-to-device component 822 is configured to operate the user equipment device to provide satellite assist terrestrial wireless device-to-device services including: determining when a satellite assist terrestrial wireless device-to-device connection is needed, enabling satellite communications, sending satellite transmissions, establishing satellite connections, responding to terrestrial wireless device-to-device service offerings, establishing wireless device-to-device connections, terminating wireless device-to-device connections, and disabling satellite communications.

The performance metrics component 824 generates performance metrics for wireless connectivity and signaling including received reference signal strength, noise and interference metrics (e.g., RSRP, SNIR) for reference signals received from terrestrial wireless base stations.

FIG. 9 is a drawing of an exemplary assembly of components 900 which may be included in a network equipment device/system/server 600 of FIG. 6, in accordance with an exemplary embodiment. The components in the assembly of components 900 can, and in some embodiments are, implemented fully in hardware within a processor or one or more processors, e.g., processor(s) 606, e.g., as individual circuits. The components in the assembly of components 900 can, and in some embodiments are, implemented fully in hardware within the assembly of hardware components 608, e.g., as individual circuits corresponding to the different components. In other embodiments some of the components are implemented, e.g., as circuits, within processor(s) 606 with other components being implemented, e.g., as circuits within assembly of components 608, external to and coupled to the processor(s) 606. As should be appreciated the level of integration of components on the processor and/or with some components being external to the processor may be one of design choice. Alternatively, rather than being implemented as circuits, all or some of the components may be implemented in software and stored in the memory 612 of the network equipment device 600, with the components controlling operation of the network equipment device 600 to implement the functions corresponding to the components when the components are executed by a processor e.g., processor 606. In some such embodiments, the assembly of components 900 is included in the memory 612 as assembly of software components 614. In still other embodiments, various components in assembly of components 900 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 606, configure the processor(s) to implement the function corresponding to the component. In embodiments where the assembly of components 900 is stored in the memory 612, the memory 612 is a computer program product comprising a computer readable medium comprising code, e.g., individual code for each component, for causing at least one computer, e.g., processor 606, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 9 control and/or configure the network equipment device 600 or elements therein such as the processor(s) 606, to perform the functions of corresponding steps illustrated and/or described in the method of one or more of the flowcharts, signaling diagrams and/or described with respect to any of the Figures. Thus the assembly of components 900 includes various components that perform functions of corresponding one or more described and/or illustrated steps of an exemplary method.

Assembly of components 900 includes a control routines component 902, a communications component 904, a message generator component 906, a message processing component 908, a satellite assist terrestrial wireless device-to-device component 910, a determinator component 912, a storage component 914, a proximity service function component 916, a resource allocation component 918, a continuous mobile communications service component 920, a propagation generator and link estimator component 922, and a link status report component.

The control routines component 902 is configured to control operation of the network equipment device.

The communication component 904 is configured to handle communications, e.g., transmission and reception of messages, and protocol signaling for the network equipment device.

The message generator component 906 is configured to generate messages for transmission to other devices.

The message processing component 908 is configured to process messages and implement procedures/operations in response to messages or based on the contents of messages. This includes messages received from other devices, e.g., messages from terrestrial core network, satellite core network, wireless base stations, user equipment devices, satellites, other network equipment devices, systems or serves.

The satellite assist terrestrial wireless device-to-device component 910 is configured to operate the network equipment device/system/server to provide satellite terrestrial wireless device-to-device services including generating and/or analyzing satellite system and terrestrial wireless system providing information and data including UE location and movement data, UE category data, UE capability data, link status information on UE connectivity and link capabilities, UE load data, network load data to identify user equipment devices to provide satellite assisted terrestrial wireless device-to-device communications connections to user equipment devices without connectivity or connections to a terrestrial wireless network system as well as identify radio resources to be used for the device-to-devices so as to efficiently utilize network radio resources. The satellite assist terrestrial wireless device-to-device component 910 also generates instructions for devices to implement the satellite assist terrestrial wireless device-to-device connections and determines based on monitored performance metrics when the device-to-device connection is to be terminated and a direct wireless connection to a wireless base station of the terrestrial system is to be established.

The determinator component 912 is configured to make determinations and decisions for the network equipment device.

The storage component 914 is configured to manage the storage, and retrieval of data and/or instructions to/and from memory, and/or storage devices coupled and/or connected to the network equipment device.

The proximity service function component 914 is configured to perform proximity service operations such as responding to proximity service requests or sending out offers to provide services or responding to service request offers, establishing wireless device-to-device connections and terminating device-to-devices connections.

The resource allocation component 918 is configured to assign or allocate resources to user equipment devices, e.g., for satellite assisted terrestrial wireless device-to-device communications connections.

The continuous mobile communications service component 920 executes the functions and performs the operations described herein in connection with the continuous mobile communications system including the CMCS 114 of system 100 and the CMCS 320 of system 300.

The propagation generator and link estimator component 922 is performs functions and operations described herein in connection with the propagation generator and link estimator including the propagation generator and link estimator 111 of system 100 and 322 of system 300. In some embodiments, the propagation generator and link estimator component is a sub-component of the continuous mobile communications service component 922.

The link status report component 924 generates reports on the status of various wireless links between communications devices (e.g., user equipment devices and wireless base stations) in a terrestrial wireless system including direct wireless links between user equipment devices and wireless base station, wireless device-to-device communications links, and potential wireless device-to-device communications links that can be implemented to support satellite assisted terrestrial wireless user equipment device-to-user equipment device connections. The link status reports also provides information about each of the links such as for example radio resources or spectrum being utilized for the link, bandwidth of the link, data rate, devices the links connect, location of the devices connected by the link, load on the link, capacity of the link, path loss for the link, etc.

The specific components of the assembly of components 900 included in any particular network equipment device may, and typically does vary depending on the specific network equipment device and the functionality required for the device and/or the operations the network equipment device is responsible for performing.

Various exemplary numbered embodiments illustrating different features of the present invention will now be discussed. The various features discussed may be used in a variety of different combinations. The numbered embodiments are only exemplary and are not meant to be limiting to the scope of the invention. The various method embodiments may be, and in some embodiments are, implemented on system 300 of FIG. 3 or system 100 of FIG. 10.

### List of Exemplary Numbered Method Embodiments

Method Embodiment 1. A method comprising: making a determination, by a Continuous Mobile Communications System (CMCS), that a first user equipment device meets criteria for providing satellite assisted terrestrial wireless device-to-device communications; identifying, by the CMCS, a second user equipment device to provide a satellite assisted terrestrial wireless device-to-device communications connection to the first user equipment device; and sending, by the CMCS, instructions to a terrestrial wireless core network for establishing a satellite assisted terrestrial wireless device-to-device communications connection between the second user equipment device and the first user equipment device.

Method Embodiment 1A. The method of Method Embodiment 1, further comprising: receiving at the terrestrial wireless core network the instructions for establishing a satellite assisted terrestrial wireless device-to-device communications connection between the second user equipment device and the first user equipment device; in response to receiving at the terrestrial wireless core network the instructions for establishing a satellite assisted terrestrial wireless device-to-device communications connection between the second user equipment device and the first user equipment device: sending, by the terrestrial wireless core network instructions to a first base station for the second user equipment device to establish a satellite assisted terrestrial wireless device-to-device communications connection with the first user equipment device, said first base station having a direct wireless connection with the second user equipment device; and receiving, by the first base station, from the terrestrial wireless core network the instructions to a first base station for the second user equipment device to establish a satellite assisted terrestrial wireless device-to-device communications connection with the first user equipment device, said first base station having a direct wireless connection with the second user equipment device.

Method Embodiment 1B. The method of Method Embodiment claim 1A, further comprising: in response to receiving by the first wireless base station the instructions for establishing a satellite assisted terrestrial wireless device-to-device communications connection between the second user equipment device and the first user equipment device: sending, by the first wireless base station to the second user equipment device instructions to establish to establish a satellite assisted terrestrial wireless device-to-device communications connection with the first user equipment device.

Method Embodiment 1C. The method of Method Embodiment 1B, further comprising: receiving, by the second user equipment device the instructions to establish a satellite assisted terrestrial wireless device-to-device communications connection with the first user equipment device; and in response to receiving by the second user equipment device the instructions to establish a satellite assisted terrestrial wireless device-to-device communications connection with the first user equipment device, wirelessly broadcasting a message offering device-to-device services (e.g., broadcasting a proximity service discovery message offering wireless device-to-device services to user equipment devices receiving the message).

Method Embodiment 1D. The method of Method Embodiment 1C, further comprising: receiving, by the first user equipment device, the message offering wireless device-to-device services from the second user equipment device; and in response to receiving the message offering device-to-device services from the second user equipment device, responding with a message requesting the offered wireless device-to-device services, said message requesting the offered wireless device-to-device services including an identifier for the first user equipment device (e.g., IMEI or GUTI).

Method Embodiment 1E. The method of Method Embodiment 1D, receiving, by the second user equipment device, said response from said first user equipment device; and establishing, by the second user equipment device, the satellite assisted wireless device-to-device connection with the first user equipment device.

Method Embodiment 1E1. The method of Method Embodiment 1E, further comprising: prior to establishing, by the second user equipment device, the satellite assisted wireless device-to-device connection with the first user equipment device, confirming that the identifier included in the response is for the first user equipment device.

Method Embodiment 1E2. The method of Method Embodiment 1E1, wherein said confirming that the identifier included in the response is for the first user equipment device includes: comparing, by the second user equipment device, the identifier received in the response from the first user equipment device with an identifier for the first user equipment device included in the instructions received from the first wireless base station for establishing the satellite assisted terrestrial wireless device-to-device communications connection, or sending the response received from the first user equipment device to the first base station or to the terrestrial wireless core network; and receiving from the terrestrial wireless core network a message indicating that the confirmation that identifier included in the response from the first user equipment device is for the first user equipment device and that the second user equipment device is to establish the satellite assisted wireless device-to-device connection with the first user equipment device.

Method Embodiment 1F. The method of Method Embodiment 1D, receiving, by the second user equipment device, a plurality of responses from different user equipment devices requesting the offered wireless device-to-device services, each of the responses including information identifying the user equipment device from which the response was received, said response from said first user equipment device being one of said plurality of responses; and determining, by the second user equipment device, from the plurality of different user equipment device responses to establish a satellite assisted terrestrial wireless device-to-device connection with the first user equipment device based on the identifier included in the first user equipment device response; and establishing, by the second user equipment device, the satellite assisted terrestrial wireless device-to-device connection with the first user equipment device using radio resources included in the instructions received from the first wireless base station.

Method Embodiment 1G. The method of Method Embodiment 1F, wherein the instructions received from the first base station include the identifier for the first user equipment device.

Method Embodiment 2. The method of Method Embodiment 1, wherein said determination that the first user equipment device meets criteria for providing satellite assisted terrestrial wireless device-to-device communications is based on location information for the first user equipment device provided to the CMCS from a satellite core network.

Method Embodiment 2A. The method of Method Embodiment 2, wherein said location information for the first user equipment device includes geographical coordinates (e.g., longitude, latitude, altitude with respect to the Earth) for the first user equipment device.

Method Embodiment 2B. The method of Method Embodiment 2, further comprising: determining, by the CMCS, whether or not the first user equipment device is moving based on the location information provided by the satellite core network; and when the CMCS determines that the first user equipment device is moving, determining, by the CMCS, a speed and a direction of the movement of the first user equipment device based on the location information provided by the satellite core network.

Method Embodiment 2C. The method of Method Embodiment 2B, wherein said location information provided by the first includes: a first location at which the first user equipment device is located and information (e.g., a timestamp) indicating when the first user equipment was located at the first location, and a second location at which the first user equipment device is located and information (e.g., a timestamp) indicating when the first user equipment was located at the second location.

Method Embodiment 2C. The method of Method Embodiment 2, wherein said criteria includes the distance from the location of the first user equipment device to a user equipment device that can provide satellite assisted terrestrial wireless device-to-device communications for the first user equipment device being less than a maximum distance of separation, said maximum distance of separation being based on a maximum transmit power level that can be utilized by a user equipment device for a terrestrial wireless device-to-device communications connection.

Method Embodiment 3. The method of Method Embodiment 2, wherein said determination that the first user equipment device meets criteria for providing satellite assisted terrestrial wireless device-to-device communications is further based on movement information for the first user equipment device provided to the CMCS from the satellite core network or derived from the location information for the first user equipment device provided to the CMCS from the satellite core network, said movement information including speed information for the first user equipment device, said speed information being the speed at which the first user equipment device is moving.

Method Embodiment 3C. The method of Method Embodiment 3, wherein said movement information further includes the direction of movement of the first user equipment device.

Method Embodiment 4. The method of Method Embodiment 3, wherein said criteria includes: (i) the first user equipment device is moving at a speed less than a first speed threshold amount, (ii) the first user equipment device has a subscription to a terrestrial wireless network and a subscription to a satellite wireless network, and (iii) the first user equipment device does not have wireless connectivity with the terrestrial wireless network (i.e., the first user equipment device does not have capability to establish a wireless connection or link to the terrestrial wireless network (e.g., the first user equipment device is outside the coverage area of the base stations of the terrestrial wireless network or is in a location where the wireless signal of the base stations of the terrestrial wireless network are being blocked (e.g., by terrain or clutter or the signals from the first user equipment device to the terrestrial wireless network are being blocked (e.g., by terrain or clutter)))).

Method Embodiment 4A. The method of Method Embodiment 1, wherein said criteria includes the first user equipment device having a satellite subscription to satellite assisted terrestrial wireless device-to-device communications services.

Method Embodiment 4B. The method of Method Embodiment 4A, wherein said criteria further includes that the first user equipment device can be provided a satellite assisted terrestrial wireless device-to-device communications connection with a quality of service above a first quality of service threshold level.

Method Embodiment 4C. The method of Method Embodiment 4B, further comprising: determining, by the CMCS, a quality of service for a potential satellite assisted terrestrial wireless device-to-device communications connection based on terrestrial wireless link information provided by a propagation generator and link estimator.

Method Embodiment 4C1. The method of Method Embodiment 4C, wherein the first quality of service threshold level is based on: link bandwidth and link data rate that can be provided by the wireless device-to-device communications connection or link.

Method Embodiment 4D. The method of Method Embodiment 4B, wherein the first quality of service threshold level is based on: an amount of bandwidth that can be provided by the wireless device-to-device communications connection.

Method Embodiment 4E. The method of Method Embodiment 4D, wherein the first quality of service threshold level is further based on:
(i) data rate of the wireless device-to-device communications connection that can be provided, and (ii) reliability of the wireless device-to-device connection that can be provided.

Method Embodiment 4F. The method of Method Embodiment 1, wherein said criteria includes that the first user equipment device has a subscription to satellite assisted terrestrial wireless device-to-device communications services and does not have a subscription to satellite voice communications services (i.e., the first user equipment device subscription does not include satellite voice communications services because if it does then the satellite voice services will be used by the user equipment device which has lost its terrestrial connectivity instead of satellite assisted terrestrial wireless device-to-device services).

Method Embodiment 5. The method of Method Embodiment 1, wherein said first user equipment device is a dual subscription wireless device capable of simultaneously wirelessly communicating with: (i) satellites of a satellite wireless network, and (ii) wireless communications devices of a terrestrial wireless network, said terrestrial wireless core network being part of the terrestrial wireless network.

Method Embodiment 5A. The method of Method Embodiment 1, wherein the wireless communications devices of the terrestrial wireless network include wireless base stations and user equipment devices.

Method Embodiment 5B. The method of Method Embodiment 5, wherein the first user equipment device wirelessly communicates with the wireless base stations of the terrestrial wireless network using a first frequency range and the first user equipment device wirelessly communicates with the satellites of the satellite wireless network using a second frequency range.

Method Embodiment 5C. The method of Method Embodiment 5, wherein said satellite wireless network provides user equipment device location tracking services (e.g., ability to determine a user equipment device's location, change of location, speed, and direction of movement typically provided with timestamp information so as to be able to track position vs time and/or movement and direction vs time-based on signals transmitted from the user equipment device which are received by the satellites of the satellite wireless network).

Method Embodiment 5D. The method of Method Embodiment 5C, wherein said satellite wireless network provides user equipment device voice services to user equipment devices (e.g., voice call capability via satellite) having subscriptions for satellite voice call capabilities.

Method Embodiment 5E. The method of Method Embodiment 5B or Method Embodiment 5C, wherein said satellite wireless network provides user equipment device data services to user equipment device (e.g., data messaging services) having subscriptions for satellite data services.

Method Embodiment 6. The method of Method Embodiment 1, further comprising: prior to sending instructions to the first terrestrial core network for establishing a satellite assisted terrestrial wireless device-to-device communications connection between the second user equipment device and the first user equipment device, generating, by the CMCS, said instructions, said instructions including: (i) identification information for the first user equipment device (e.g., GUTI or IMEI for the first user equipment device) which is to be the target of the satellite assisted terrestrial wireless device-to-device communications connection, (ii) identification information for the second user equipment device (e.g., GUTI or IMEI) which is to host the satellite assisted terrestrial wireless device-to-device communications connection, and (iii) radio resource information for the satellite assisted terrestrial wireless device-to-device communications connection to be established (e.g., radio frequency spectrum to be used, radio frequency bandwidth to be used, radio frequency channels to be used for the D2D connection, transmission power levels, timing synchronization information, modulation and coding scheme, time slot allocation).

Method Embodiment 6A. The method of Method Embodiment 6, wherein the radio resource information includes information identifying the radio frequency spectrum to be utilized for the satellite assisted terrestrial wireless device-to-device communications connection to be established between the second user equipment device and the first user equipment device.

Method Embodiment 6B. The method of Method Embodiment 6A, wherein the radio resource information includes one or more or any combination of the following: amount of bandwidth, data rate, modulation and codes schemes to be utilized for the satellite assisted terrestrial wireless device-to-device connection.

Method Embodiment 7. The method of Method Embodiment 1, wherein said identifying, by the CMCS, the second user equipment device includes: selecting the second user equipment device from a plurality of user equipment devices having a terrestrial wireless connection to a wireless base station of a terrestrial wireless network to which the first user equipment device is subscribed based on information provided by a propagation generator and link estimator, said information provided by the propagation generator and link estimator including information about which of the plurality of user equipment devices are capable of supporting a device-to-device communications link to the first user equipment device and attributes about the device-to-device communications link which could be supported (e.g., bandwidth, bit rate, signal path loss, etc.).

Method Embodiment 7A. The method of Method Embodiment 7, further comprising: generating, by the propagation generator and link estimator, said information about which of the plurality of user equipment devices are capable of supporting a device-to-device communications link to the first user equipment device and attributes about the device-to-device communications link which could be supported (e.g., path loss, bandwidth, bit rate, etc.) using information obtained from the terrestrial core network, information obtained from the satellite core system, and one or more radio signal propagation models.

Method Embodiment 7B. The method of Method Embodiment 7A, wherein said information obtained from the terrestrial core network includes: (i) location information on the user equipment devices of the plurality of user equipment devices, (ii) link information on the user equipment devices of the plurality of user equipment devices (information on the link connecting the user equipment device to base station link-e.g., signal strength metrics (e.g., Reference Signal Receive Strength), signal noise and interference metrics SNIR), bandwidth, bit rate, modulation and coding scheme), and (iii) user equipment device properties of the user equipment devices of the plurality of user equipment devices and the first user equipment device (e.g., user equipment category type and/or capabilities of the user equipment devices of the plurality of user equipment devices and the first user equipment device).

Method Embodiment 7C. The method of Method Embodiment 7B, wherein said information obtained from the satellite core system includes location and/or tracking information for the first user equipment device.

Method Embodiment 7D. The method of Method Embodiment 7C, wherein at least one of the propagation models utilized to determine attributes about the device-to-device communications links which could be supported utilize one or more of the following to determine path loss for the radio frequency propagation paths from the first user equipment device to user equipment devices of the plurality of user equipment devices: (i) terrain information or (ii) clutter information, said path loss being one of the attributes about the device-to-device communications links.

Method Embodiment 8. The method of Method Embodiment 1, wherein said identifying, by the CMCS, the second user equipment device to provide a satellite assisted terrestrial wireless device-to-device communications connection to the first user equipment device further includes: selecting the second user equipment device from a plurality of user equipment devices having a terrestrial wireless connection to a wireless base station of a terrestrial wireless network to which the first user equipment device is subscribed based on one or more or any combination of the following: (i) distance between the first user equipment and user equipment devices of the plurality of user equipment devices, (ii) signal interference information, (iii) modulation rates supported by user equipment devices of the plurality of user equipment devices, (iv) load on the network, (v) individual load on the user equipment devices of the plurality of user equipment devices, (vi) user equipment device category of the first user equipment device, (vii) user equipment device capabilities of the first user equipment device, (viii) user equipment device type of the first user equipment device; (ix) user equipment device category of user equipment devices of the plurality of user equipment devices, (x) user equipment device capabilities of the user equipment devices of the plurality of user equipment devices, (xi) user equipment device type of the user equipment devices of the plurality of user equipment devices, (xii) information on the wireless links connecting the user equipment devices of the plurality of user equipment devices to terrestrial wireless base stations, (xiii) information on the movement (e.g., direction and/or speed) of the first user equipment device, (xiv) information on the movement (e.g., direction and/or speed) of the user equipment devices of the plurality of user equipment devices, (xv) contracted for quality of service of the first user equipment device, (xvi) contracted for quality of service of the user equipment devices of the user equipment devices of the plurality of user equipment devices, (xvii) estimated quality of service of wireless device-to-device connections that could be provided by user equipment devices of the plurality of user equipment devices, (xviii) measured received signal strength of signals from user equipment devices of the plurality of user equipment devices provided by the base stations to which the user equipment devices are connected.

Method Embodiment 9. The method of Method Embodiment 1, wherein said identifying, by the CMCS, the second user equipment device to provide a satellite assisted terrestrial wireless device-to-device communications connection to the first user equipment device further includes: determining that the second user equipment device is a best match for providing a satellite assisted terrestrial wireless device-to-device communications connection to the first user equipment device from a plurality of user equipment devices having a terrestrial wireless connection to a wireless base station of a terrestrial wireless network to which the first user equipment device is subscribed based on: (i) location information for the first user equipment device, (ii) location information for the second user equipment device, (iii) movement of the second user equipment device with respect to the first user equipment device, (iv) traffic load on the second user equipment device, (v) estimated propagation path loss for a potential wireless device-to-device communications link connecting the second user equipment device to the first user equipment device.

Method Embodiment 10. The method of Method Embodiment 1, further comprising: prior to said making a determination, by a Continuous Mobile Communications System (CMCS), that a first user equipment device meets criteria for providing satellite assisted terrestrial wireless device-to-device communications, receiving, by the CMCS, from the terrestrial wireless core network information indicating that the first user equipment device has lost a terrestrial wireless connection to a first wireless base station.

Method Embodiment 11. The method of Method Embodiment 1, further comprising: identifying, by the CMCS, a third user equipment device to provide a second satellite assisted terrestrial wireless device-to-device communications connection to the first user equipment device based on a change in location of one or more of the following: (i) first user equipment device, or (ii) the second user equipment device (e.g., the distance between the first and second user equipment devices indicates that the wireless device-to-device communications link/connection will be lost).

Method Embodiment 11A. The method of Method Embodiment 1, further comprising: identifying, by the CMCS, a third user equipment device to provide a second satellite assisted terrestrial wireless device-to-device communications connection to the first user equipment device based on a change in location of one or more or any combination of the following: (i) first user equipment device, (ii) the second user equipment device, or (iii) third user equipment device (e.g., third user equipment device moves closer to the first user equipment device than the second user equipment device and can provide a better quality of service D2D link and/or the second user equipment device moves further away from the first user equipment device than the third user equipment device such that the third user equipment device can provide a better quality of service D2D link).

Method Embodiment 11A1. The method of Method Embodiment 1, further comprising after establishing the satellite assisted terrestrial wireless device-to-device communications connection between the second user equipment device and the first user equipment device: identifying, by the CMCS, a third user equipment device to provide a second satellite assisted terrestrial wireless device-to-device communications connection to the first user equipment device based on a change in location of one or more or any combination of the following: (i) first user equipment device, (ii) the second user equipment device, or (iii) third user equipment device (e.g., third user equipment device moves closer to the first user equipment device than the second user equipment device and can provide a better quality of service D2D link and/or the second user equipment device moves further away from the first user equipment device than the third user equipment device such that the third user equipment device can provide a better quality of service D2D link).

Method Embodiment 11B. The method of Method Embodiment 11A or 11A1, further comprising: sending, by the CMCS, instructions to the terrestrial core network for establishing a satellite assisted terrestrial wireless device-to-device communications connection between the third user equipment device and the first user equipment device.

Method Embodiment 12. The method of Method Embodiment 1, further comprising: prior to said making the determination, by a Continuous Mobile Communications System (CMCS), that the first user equipment device meets criteria for providing satellite assisted terrestrial wireless device-to-device communications, changing, by the first user equipment device from a first mode of operation to a second mode of operation, in response to losing wireless connectivity with the first wireless base station of the terrestrial wireless network system, said first mode of operation being a terrestrial wireless only mode of operation in which satellite communications are not enabled, said second mode of operation being a mode of operation in which the first user equipment device is enabled to communicate with other user equipment devices and wireless base stations of the terrestrial wireless network system and satellites of a satellite communications system.

Method Embodiment 13. The method of Method Embodiment 12, further comprising: establishing, by a second user equipment device of the terrestrial wireless network system, a satellite assisted wireless device-to-device communications connection with the first wireless device in response to instructions provided by the CMCS.

Method Embodiment 14. The method of Method Embodiment 13, further comprising: receiving, by the first user equipment device, directly from a first wireless base station of the terrestrial wireless network system reference signals; collecting, by the first user equipment device, performance metrics (e.g., first wireless base station reference signal received strength, signaling noise measurements) on the reference signals being received by the first user equipment device from the first wireless base station of the terrestrial wireless network system; sending, by the first user equipment device, the collected performance metrics to the terrestrial wireless core network via the satellite assisted device-to-device communications connection; and sending, by the terrestrial wireless core network, the collected performance metrics to the CMCS; monitoring, by the CMCS, the collected performance metrics for a period of time; and based on the monitored performance metrics over the period of time determining, by the CMCS, to terminate the satellite assisted terrestrial wireless device-to-device communications connection between the first user equipment device and the second user equipment device.

Method Embodiment 15. The method of Method Embodiment 14, further comprising: generating, by the CMCS, instructions for the first user equipment device to re-establish a direct terrestrial wireless connection between the first user equipment device and the first wireless base station and then terminate the satellite assisted terrestrial wireless device-to-device communications connection between the first user equipment device and the second user equipment device; and communicating to the first user equipment device via the satellite assisted terrestrial wireless device-to-device communications connection, by the CMCS, the generated instructions for the first user equipment device to re-establish a direct terrestrial wireless connection between the first user equipment device and the first wireless base station and then terminate the satellite assisted terrestrial wireless device-to-device communications connection between the first user equipment device and the second user equipment device.

Method Embodiment 16. The method of Method Embodiment 15, further comprising: receiving, by the first user equipment device, the instructions for the first user equipment device to re-establish a direct terrestrial wireless connection between the first user equipment device and the first wireless base station and then terminate the satellite assisted terrestrial wireless device-to-device communications connection between the first user equipment device and the second user equipment device to the first user equipment device via the satellite assisted terrestrial wireless device-to-device communications connection; re-establishing, by the first user equipment device, a direct terrestrial wireless connection between the first user equipment device and the first wireless base station; and after re-establishing the direct terrestrial wireless connection, (i) terminating, by the first user equipment device, the satellite assisted terrestrial wireless device-to-device communications connection between the first user equipment device and the second user equipment device; and (ii) switching, by the first user equipment device, from the second mode of operation back to the first mode of operation, said switching from the second mode of operation back to the first mode of operation includes disabling the enabled satellite communications.

Method Embodiment 17. The method of Method Embodiment 16, wherein switching from the first mode of operation to the second mode of operation includes powering on a transmitter and a receiver of the first user equipment device for satellite communications; and wherein switching back from the second mode of operation to the first mode of operation includes powering off the transmitter and the received of the first user equipment device for satellite communications.

Method Embodiment 18. The method of Method Embodiment 1, further comprising: after the satellite assisted terrestrial wireless device-to-device communications connection between the first user equipment device and the second user equipment device has been established, determining, by the CMCS, when to terminate the satellite assisted terrestrial wireless device-to-device communications connection between the first user equipment device and the second user equipment device based on signaling information provided by the first user equipment device to the CMCS via the satellite assisted terrestrial wireless device-to-device communications connection between the first user equipment device and the second user equipment device.

Method Embodiment 19. The method of Method Embodiment 18, wherein said signaling information includes reference signal received power measurements made by the first user equipment device on reference signals received by the first user equipment device from a first wireless base station of a terrestrial wireless network to which the terrestrial wireless core network is a part.

Method Embodiment 20. The method of Method Embodiment 20, wherein the signaling information further includes signaling noise and interference information (e.g., SNIR) for the reference signals received by the first user equipment device from the first wireless base station.

Method Embodiment 21. A method comprising: detecting, by a first user equipment device operating in a first mode of operation, the loss of wireless connectivity with a terrestrial wireless network system; changing, by the first user equipment device, from the first mode of operation to a second mode of operation, in response to detecting the loss of wireless connectivity with the terrestrial wireless network system; and wherein said first mode of operation is a terrestrial wireless only mode of operation in which satellite communications are not enabled; and wherein said second mode of operation is a mode of operation in which the first user equipment device is enabled to communicate with other user equipment devices and wireless base stations of the terrestrial wireless network system and satellites of a satellite communications system.

Method Embodiment 22. The method of Method Embodiment 21, wherein said detecting, by the first user equipment device operating in the first mode of operation, the loss of wireless connectivity with the terrestrial wireless network system includes: detecting, by the first user equipment device, the inability to receive signals from or communicate with any wireless base stations of the terrestrial wireless network system.

Method Embodiment 23. The method of Method Embodiment 22, further comprising: while operating in the second mode of operation, performing the following operations by the first user equipment device: (i) enabling satellite assisted terrestrial wireless device-to-device connection functionality on the first user equipment device; and (ii) once satellite assisted terrestrial wireless device-to-device connection functionality on the first user equipment device has been enabled, initiating, by the first user equipment device, wireless signal transmissions to one or more satellites of a satellite communications system for user equipment device location tracking by the satellite communications system; and (iii) continuing the wireless signal transmissions to the one or more satellites while said satellite assisted terrestrial wireless device-to-device connection functionality is enabled.

Method Embodiment 24. The method of Method Embodiment 22, further comprising: while operating in the second mode of operation, performing the following operations by the first user equipment device: (i) enabling satellite assisted terrestrial wireless device-to-device connection functionality on the first user equipment device; and (ii) after enabling satellite assisted terrestrial wireless device-to-device connection functionality on the first user equipment device, establishing a wireless communications connection with a satellite of a satellite communications system, said wireless communications connection limited to signaling for location tracking of the first user equipment device by the satellite communications system.

Method Embodiment 24A. The method of Method Embodiment 24, wherein the wireless communications connection established by the first user equipment device and the satellite is not used for voice communications.

Method Embodiment 25. The method of Method Embodiment 23 or 24, further comprising: while continuing to operate in the second mode of operation, performing the following additional operations by the first user equipment device: wirelessly receiving, from a second user equipment device, a broadcast message offering terrestrial wireless device-to-device services, said second user equipment device having a wireless connection to a wireless base station of the terrestrial wireless network system; and generating a response to the broadcast message, said response requesting the offered terrestrial wireless device-to-device services and including identification information for the first user equipment device (e.g., GUTI or IMEI for the first user equipment device); wirelessly transmitting the generated response to the second user equipment device; receiving from the second user equipment device a message indicating acceptance of the request for the offered terrestrial wireless device-to-device services and including information for establishing the terrestrial wireless device-to-device connection between the first user equipment device and the second user equipment device.

Method Embodiment 25A. The method of Method Embodiment 25, wherein the second user equipment device has been selected by a Continuous Mobile Communications System (CMCS) to provide satellite assisted terrestrial wireless device-to-device connection to the first user equipment device from a plurality of user equipment devices wireless connected to the terrestrial wireless network system, said selection being based on information received from the terrestrial wireless network system and the satellite communications system; and wherein the second user equipment device received instructions from the CMCS to send the broadcast message offering terrestrial wireless device-to-device services.

Method Embodiment 25B. The method of Method Embodiment 25A, wherein the information received by the CMCS from the terrestrial wireless network system on which the second user equipment device selection was based includes one or more or any combination of: (i) distance between the first user equipment and user equipment devices of the plurality of user equipment devices, (ii) signal interference information, (iii) modulation rates supported by user equipment devices of the plurality of user equipment devices, (iv) load on the network, (v) individual load on the user equipment devices of the plurality of user equipment devices, (vi) user equipment device category of the first user equipment device, (vii) user equipment device capabilities of the first user equipment device, (viii) user equipment device type of the first user equipment device; (ix) user equipment device category of user equipment devices of the plurality of user equipment devices, (x) user equipment device capabilities of the user equipment devices of the plurality of user equipment devices, (xi) user equipment device type of the user equipment devices of the plurality of user equipment devices, (xii) information on the wireless links connecting the user equipment devices of the plurality of user equipment devices to terrestrial wireless base stations, (xiii) information on the movement (e.g., direction and/or speed) of the first user equipment device, (xiv) information on the movement (e.g., direction and/or speed) of the user equipment devices of the plurality of user equipment devices, (xv) contracted for quality of service of the first user equipment device, (xvi) contracted for quality of service of the user equipment devices of the user equipment devices of the plurality of user equipment devices, (xvii) estimated quality of service of wireless device-to-device connections that could be provided by user equipment devices of the plurality of user equipment devices, (xviii) measured received signal strength of signals from user equipment devices of the plurality of user equipment devices provided by the base stations to which the user equipment devices are connected.

Method Embodiment 25B1. The method of Method Embodiment 25A, wherein the information received by the CMCS from the satellite system on which the second user equipment device selection was based includes: position and/or tracking information for the first user equipment device generated by the satellite communications system based on the transmission signals received from the first user equipment device by one or more satellites of the satellite communications system.

Method Embodiment 25C. The method of Method Embodiment 25B, wherein said selection of the second user equipment device being further based on information received from a propagation generator and link estimator device which provides potential user equipment device candidates for the satellite assisted terrestrial wireless device-to-device connection and information on the potential satellite assisted terrestrial wireless device-to-device links which could be supported by the candidate user equipment devices (e.g., link data rate, bandwidth, modulation scheme and coding that can be supported by the candidate user equipment device).

Method Embodiment 25D. The method of Method Embodiment 25C, wherein the propagation generator and link estimator uses propagation models and information on the first user equipment device and information on the user equipment devices of the plurality of user equipment devices to determine the potential user equipment device candidates and information on the potential satellite assisted terrestrial wireless device-to-device links which could be supported by the candidate user equipment devices; wherein the information on the first user equipment device includes location information and UE category information; and wherein the information on the user equipment devices of the plurality of user equipment devices includes location information and UE category information for the user equipment devices of the plurality of the user equipment devices.

Method Embodiment 26. The method of Method Embodiment 25, wherein the information for establishing the terrestrial wireless device-to-device connection including radio resource information, said radio resource information including: one or more or any combination of the following: information identifying radio frequency spectrum for the terrestrial wireless device-to-device connection, information on the data rate to be used for the or the terrestrial wireless device-to-device connection, information on the bandwidth available for the terrestrial wireless device-to-device connection, information on the modulation scheme and coding for the terrestrial wireless device-to-device connection.

Method Embodiment 26A. The method of Method Embodiment 26, wherein CMCS generates the instructions received by the second user equipment device to send the broadcast message offering terrestrial wireless device-to-device services using information generated by a propagation generator and link estimator device, said instructions including the identification information for the first user equipment device and radio resources to be utilized for the terrestrial wireless device-to-device connection to be established between the second user equipment device and the first user equipment device.

Method Embodiment 27. The method of Method Embodiment 25, further comprising: while continuing to operate in the second mode of operation, performing the following additional operations by the first user equipment device: establishing, the terrestrial wireless device-to-device connection with the second user equipment device; establishing, a voice call, using the terrestrial wireless device-to-device connection to a third user equipment device.

Method Embodiment 28. The method of Method Embodiment 27, wherein said third user equipment device is not a subscriber of the terrestrial wireless network system.

Method Embodiment 29. The method of Method Embodiment 25, further comprising: while continuing to operate in the second mode of operation, performing the following additional operations by the first user equipment device: establishing, the terrestrial wireless device-to-device connection with the second user equipment device; and establishing, a voice call, using the terrestrial wireless device-to-device connection to a third user equipment device, said third user equipment device being connected to a wireless base station of the terrestrial wireless network system which is different than the wireless base station to which the second user equipment device is connected.

Method Embodiment 30. The method of Method Embodiment 25, further comprising: while continuing to operate in the second mode of operation, performing the following additional operations by the first user equipment device: receiving reference signals directly from a wireless base station of the terrestrial wireless network; generating performance metrics on the received reference signals (e.g., signal strength, signaling interference, signaling noise metrics such as RSRP, SNIR, etc.); reporting the performance metrics for the received reference signals to a Continuous Mobile Communications System (CMCS) via the terrestrial wireless device-to-device communications connection.

Method Embodiment 31. The method of Method Embodiment 30, wherein the performance metrics are generated and reported until instructions are received from the CMCS via the terrestrial wireless device-to-device connection to establish or re-establish a direct wireless connection with the wireless base station from which the reference signals are being received and terminate the satellite assisted terrestrial wireless device-to-device connection.

Method Embodiment 31A. The method of Method Embodiment 31, wherein the CMCS receives and monitors the reported performance metrics from the first user equipment device; and wherein the CMCS determines based on the monitoring of the reported performance metrics from the first user equipment device that the first user equipment is to establish the direct wireless connection with the wireless base station from which the reference signals are being received and terminate the satellite assisted terrestrial wireless device-to-device connection; and wherein the CMCS in response to determining that the first user equipment is to establish the direct wireless connection with the wireless base station from which the reference signals are being received and terminate the satellite assisted terrestrial wireless device-to-device connection generates and sends to the first user equipment the instructions to establish the direct wireless connection with the wireless base station from which the reference signals are being received and terminate the satellite assisted terrestrial wireless device-to-device connection.

Method Embodiment 32. The method of Method Embodiment 30, further comprising: while continuing to operate in the second mode of operation, performing the following additional operations by the first user equipment device: receiving instructions from the CMCS via the terrestrial wireless device-to-device connection to establish or re-establish (e.g., if one had been previously established and lost) a direct wireless connection with the wireless base station from which the reference signals are being received and then terminate the satellite assisted terrestrial wireless device-to-device connection; establishing a direct wireless connection with the wireless base station from which the reference signals are being received; terminating the satellite assisted terrestrial wireless device-to-device connection with the second user equipment device.

Method Embodiment 33. The method of Method Embodiment 32, further comprising: switching, by the first user equipment device, from the second mode of operation to the first mode of operation; and wherein switching from the second mode of operation to the first mode of operation includes: (i) disabling, by the first user equipment device, satellite assist terrestrial wireless device-to-device connection functionality at the first user equipment, and (ii) disabling, by the first user equipment device, satellite communications.

Method Embodiment 34. The method of Method Embodiment 33, wherein disabling satellite assist terrestrial wireless device-to-device connection functionality includes ceasing sending transmission signals to the satellites of the satellite system.

Method Embodiment 35. The method of Method Embodiment 34, wherein enabling, by the first user equipment device, satellite communications includes powering on a satellite transmitter and receiver; and wherein disabling, by the first user equipment device, satellite communications includes powering off all satellite transmitters and receivers at the first user equipment device.

Method Embodiment 36. The method of Method Embodiment 35, wherein the terrestrial wireless network system is operated by a first operator and the satellite system is operated by a second different operator, wherein the satellite system offers satellite voice communications services and satellite assisted terrestrial wireless device-to-device services, said satellite voice communications services costing more than said satellite assisted terrestrial wireless device-to-device services.

Method Embodiment 36A. The method of Method Embodiment 36, wherein the satellite assisted terrestrial wireless device-to-device services are limited to user equipment device position or location tracking services, said user equipment device position or location tracking services including the satellite system determining, tracking and reporting a user equipment device's position or location to the Continuous Mobile Communications System based on signals received from the user equipment device by one or more satellites of the satellite system (e.g., user equipment device's geographical coordinates and a timestamp).

Method Embodiment 37. The method of Method Embodiment 36, wherein the satellite voice communications services provide utilize more satellite radio frequency spectrum than said satellite assisted terrestrial wireless device-to-device services.

### List of Exemplary Numbered Apparatus/system Embodiments

System Embodiment 1. A system comprising: a Continuous Mobile Communications System (CMCS), said CMCS including memory and a first processor, said first processor controlling the CMCS to perform the following operations: making a determination, by a Continuous Mobile Communications System (CMCS), that a first user equipment device meets criteria for providing satellite assisted terrestrial wireless device-to-device communications; identifying, by the CMCS, a second user equipment device to provide a satellite assisted terrestrial wireless device-to-device communications connection to the first user equipment device; and sending, by the CMCS, instructions to a terrestrial wireless core network for establishing a satellite assisted terrestrial wireless device-to-device communications connection between the second user equipment device and the first user equipment device.

System Embodiment 2. The system of System Embodiment 1, wherein said determination that the first user equipment device meets criteria for providing satellite assisted terrestrial wireless device-to-device communications is based on location information for the first user equipment device provided to the CMCS from a satellite core network.

System Embodiment 2A. The system of System Embodiment 2, wherein said location information for the first user equipment device includes geographical coordinates (e.g., longitude, latitude, altitude with respect to the Earth) for the first user equipment device.

System Embodiment 2B. The system of System Embodiment 2, wherein said first processor further controls the CMCS to perform the following additional operations: determining, by the CMCS, whether or not the first user equipment device is moving based on the location information provided by the satellite core network; and when the CMCS determines that the first user equipment device is moving, determining, by the CMCS, a speed and a direction of the movement of the first user equipment device based on the location information provided by the satellite core network.

System Embodiment 2C. The system of System Embodiment 2B, wherein said location information provided by the first includes: a first location at which the first user equipment device is located and information (e.g., a timestamp) indicating when the first user equipment was located at the first location, and a second location at which the first user equipment device is located and information (e.g., a timestamp) indicating when the first user equipment was located at the second location.

System Embodiment 2C. The system of System Embodiment 2, wherein said criteria includes the distance from the location of the first user equipment device to a user equipment device that can provide satellite assisted terrestrial wireless device-to-device communications for the first user equipment device being less than a maximum distance of separation, said maximum distance of separation being based on a maximum transmit power level that can be utilized by a user equipment device for a terrestrial wireless device-to-device communications connection.

System Embodiment 3. The system of System Embodiment 2, wherein said determination that the first user equipment device meets criteria for providing satellite assisted terrestrial wireless device-to-device communications is further based on movement information for the first user equipment device provided to the CMCS from the satellite core network or derived from the location information for the first user equipment device provided to the CMCS from the satellite core network, said movement information including speed information for the first user equipment device, said speed information being the speed at which the first user equipment device is moving.

System Embodiment 3C. The system of System Embodiment 3, wherein said movement information further includes the direction of movement of the first user equipment device.

System Embodiment 4. The system of System Embodiment 3, wherein said criteria includes: (i) the first user equipment device is moving at a speed less than a first speed threshold amount, (ii) the first user equipment device has a subscription to a terrestrial wireless network and a subscription to a satellite wireless network, and (iii) the first user equipment device does not have wireless connectivity with the terrestrial wireless network (i.e., the first user equipment device does not have capability to establish a wireless connection or link to the terrestrial wireless network (e.g., the first user equipment device is outside the coverage area of the base stations of the terrestrial wireless network or is in a location where the wireless signal of the base stations of the terrestrial wireless network are being blocked (e.g., by terrain or clutter or the signals from the first user equipment device to the terrestrial wireless network are being blocked (e.g., by terrain or clutter)))).

System Embodiment 4A. The system of System Embodiment 1, wherein said criteria includes the first user equipment device having a satellite subscription to satellite assisted terrestrial wireless device-to-device communications services.

System Embodiment 4B. The system of System Embodiment 4A, wherein said criteria further includes that the first user equipment device can be provided a satellite assisted terrestrial wireless device-to-device communications connection with a quality of service above a first quality of service threshold level.

System Embodiment 4C. The system of System Embodiment 4B, wherein the first processor further controls the CMCS to perform the following additional operations: determining, by the CMCS, a quality of service for a potential satellite assisted terrestrial wireless device-to-device communications connection based on terrestrial wireless link information provided by a propagation generator and link estimator.

System Embodiment 4C1. The system of System Embodiment 4C, wherein the first quality of service threshold level is based on: link bandwidth and link data rate that can be provided by the wireless device-to-device communications connection or link.

System Embodiment 4D. The system of System Embodiment 4B, wherein the first quality of service threshold level is based on: an amount of bandwidth that can be provided by the wireless device-to-device communications connection.

System Embodiment 4E. The system of System Embodiment 4D, wherein the first quality of service threshold level is further based on: (i) data rate of the wireless device-to-device communications connection that can be provided, and (ii) reliability of the wireless device-to-device connection that can be provided.

System Embodiment 4F. The system of System Embodiment 1, wherein said criteria includes that the first user equipment device has a subscription to satellite assisted terrestrial wireless device-to-device communications services and does not have a subscription to satellite voice communications services (i.e., the first user equipment device subscription does not include satellite voice communications services because if it does then the satellite voice services will be used by the user equipment device which has lost its terrestrial connectivity instead of satellite assisted terrestrial wireless device-to-device services).

System Embodiment 5. The system of System Embodiment 1, wherein said first user equipment device is a dual subscription wireless device capable of simultaneously wirelessly communicating with: (i) satellites of a satellite wireless network, and (ii) wireless communications devices of a terrestrial wireless network, said terrestrial wireless core network being part of the terrestrial wireless network.

System Embodiment 5A. The system of System Embodiment 1, wherein the wireless communications devices of the terrestrial wireless network include wireless base stations and user equipment devices.

System Embodiment 5B. The system of System Embodiment 5, wherein the first user equipment device wirelessly communicates with the wireless base stations of the terrestrial wireless network using a first frequency range and the first user equipment device wirelessly communicates with the satellites of the satellite wireless network using a second frequency range.

System Embodiment 5C. The system of System Embodiment 5, wherein said satellite wireless network provides user equipment device location tracking services (e.g., ability to determine a user equipment device's location, change of location, speed, and direction of movement typically provided with timestamp information so as to be able to track position vs time and/or movement and direction vs time-based on signals transmitted from the user equipment device which are received by the satellites of the satellite wireless network).

System Embodiment 5D. The system of System Embodiment 5C, wherein said satellite wireless network provides user equipment device voice services to user equipment devices (e.g., voice call capability via satellite) having subscriptions for satellite voice call capabilities.

System Embodiment 5E. The system of System Embodiment 5B or 5C, wherein said satellite wireless network provides user equipment device data services to user equipment device (e.g., data messaging services) having subscriptions for satellite data services.

System Embodiment 6. The system of System Embodiment 1, wherein the first processor further controls the CMCS to perform the following additional operations: prior to sending instructions to the first terrestrial core network for establishing a satellite assisted terrestrial wireless device-to-device communications connection between the second user equipment device and the first user equipment device, generating, by the CMCS, said instructions, said instructions including: (i) identification information for the first user equipment device (e.g., GUTI or IMEI for the first user equipment device) which is to be the target of the satellite assisted terrestrial wireless device-to-device communications connection, (ii) identification information for the second user equipment device (e.g., GUTI or IMEI) which is to host the satellite assisted terrestrial wireless device-to-device communications connection, and (iii) radio resource information for the satellite assisted terrestrial wireless device-to-device communications connection to be established (e.g., radio frequency spectrum to be used, radio frequency bandwidth to be used, radio frequency channels to be used for the D2D connection, transmission power levels, timing synchronization information, modulation and coding scheme, time slot allocation).

System Embodiment 6A. The system of System Embodiment 6, wherein the radio resource information includes information identifying the radio frequency spectrum to be utilized for the satellite assisted terrestrial wireless device-to-device communications connection to be established between the second user equipment device and the first user equipment device.

System Embodiment 6B. The system of System Embodiment 6A, wherein the radio resource information includes one or more or any combination of the following: amount of bandwidth, data rate, modulation and codes schemes to be utilized for the satellite assisted terrestrial wireless device-to-device connection.

System Embodiment 7. The system of System Embodiment 1, wherein said identifying, by the CMCS, the second user equipment device includes: selecting the second user equipment device from a plurality of user equipment devices having a terrestrial wireless connection to a wireless base station of a terrestrial wireless network to which the first user equipment device is subscribed based on information provided by a propagation generator and link estimator, said information provided by the propagation generator and link estimator including information about which of the plurality of user equipment devices are capable of supporting a device-to-device communications link to the first user equipment device and attributes about the device-to-device communications link which could be supported (e.g., bandwidth, bit rate, signal path loss, etc.).

System Embodiment 7A. The system of System Embodiment 7, further comprising: a propagation generator and link estimator, said propagation generator and link estimator having memory and a second processor, said second processor controlling the propagation generator to perform the following additional operations: generating, by the propagation generator and link estimator, said information about which of the plurality of user equipment devices are capable of supporting a device-to-device communications link to the first user equipment device and attributes about the device-to-device communications link which could be supported (e.g., path loss, bandwidth, bit rate, etc.) using information obtained from the terrestrial core network, information obtained from the satellite core system, and one or more radio signal propagation models.

System Embodiment 7B. The system of System Embodiment 7A, wherein said information obtained from the terrestrial core network includes: (i) location information on the user equipment devices of the plurality of user equipment devices, (ii) link information on the user equipment devices of the plurality of user equipment devices (information on the link connecting the user equipment device to base station link-e.g., signal strength metrics (e.g., Reference Signal Receive Strength), signal noise and interference metrics SNIR), bandwidth, bit rate, modulation and coding scheme), and (iii) user equipment device properties of the user equipment devices of the plurality of user equipment devices and the first user equipment device (e.g., user equipment category type and/or capabilities of the user equipment devices of the plurality of user equipment devices and the first user equipment device).

System Embodiment 7C. The system of System Embodiment 7B, wherein said information obtained from the satellite core system includes location and/or tracking information for the first user equipment device.

System Embodiment 7D. The system of System Embodiment 7C, wherein at least one of the propagation models utilized to determine attributes about the device-to-device communications links which could be supported utilize one or more of the following to determine path loss for the radio frequency propagation paths from the first user equipment device to user equipment devices of the plurality of user equipment devices: (i) terrain information or (ii) clutter information, said path loss being one of the attributes about the device-to-device communications links.

System Embodiment 8. The system of System Embodiment 1, wherein said identifying, by the CMCS, the second user equipment device to provide a satellite assisted terrestrial wireless device-to-device communications connection to the first user equipment device further includes: selecting the second user equipment device from a plurality of user equipment devices having a terrestrial wireless connection to a wireless base station of a terrestrial wireless network to which the first user equipment device is subscribed based on one or more or any combination of the following: (i) distance between the first user equipment and user equipment devices of the plurality of user equipment devices, (ii) signal interference information, (iii) modulation rates supported by user equipment devices of the plurality of user equipment devices, (iv) load on the network, (v) individual load on the user equipment devices of the plurality of user equipment devices, (vi) user equipment device category of the first user equipment device, (vii) user equipment device capabilities of the first user equipment device, (viii) user equipment device type of the first user equipment device; (ix) user equipment device category of user equipment devices of the plurality of user equipment devices, (x) user equipment device capabilities of the user equipment devices of the plurality of user equipment devices, (xi) user equipment device type of the user equipment devices of the plurality of user equipment devices, (xii) information on the wireless links connecting the user equipment devices of the plurality of user equipment devices to terrestrial wireless base stations, (xiii) information on the movement (e.g., direction and/or speed) of the first user equipment device, (xiv) information on the movement (e.g., direction and/or speed) of the user equipment devices of the plurality of user equipment devices, (xv) contracted for quality of service of the first user equipment device, (xvi) contracted for quality of service of the user equipment devices of the user equipment devices of the plurality of user equipment devices, (xvii) estimated quality of service of wireless device-to-device connections that could be provided by user equipment devices of the plurality of user equipment devices, (xviii) measured received signal strength of signals from user equipment devices of the plurality of user equipment devices provided by the base stations to which the user equipment devices are connected.

System Embodiment 9. The system of System Embodiment 1, wherein said identifying, by the CMCS, the second user equipment device to provide a satellite assisted terrestrial wireless device-to-device communications connection to the first user equipment device further includes: determining that the second user equipment device is a best match for providing a satellite assisted terrestrial wireless device-to-device communications connection to the first user equipment device from a plurality of user equipment devices having a terrestrial wireless connection to a wireless base station of a terrestrial wireless network to which the first user equipment device is subscribed based on: (i) location information for the first user equipment device, (ii) location information for the second user equipment device, (iii) movement of the second user equipment device with respect to the first user equipment device, (iv) traffic load on the second user equipment device, (v) estimated propagation path loss for a potential wireless device-to-device communications link connecting the second user equipment device to the first user equipment device.

System Embodiment 10. The system of System Embodiment 1, wherein said first processor further controls the CMCS to perform the following additional operations: prior to said making a determination, by a Continuous Mobile Communications System (CMCS), that a first user equipment device meets criteria for providing satellite assisted terrestrial wireless device-to-device communications, receiving, by the CMCS, from the terrestrial wireless core network information indicating that the first user equipment device has lost a terrestrial wireless connection to a first wireless base station.

System Embodiment 11. The system of System Embodiment 1, wherein said first processor further controls the CMCS to perform the following additional operations: identifying, by the CMCS, a third user equipment device to provide a second satellite assisted terrestrial wireless device-to-device communications connection to the first user equipment device based on a change in location of one or more of the following: (i) first user equipment device, or (ii) the second user equipment device (e.g., the distance between the first and second user equipment devices indicates that the wireless device-to-device communications link/connection will be lost).

System Embodiment 11A. The system of System Embodiment 1, wherein said first processor further controls the CMCS to perform the following additional operations: identifying, by the CMCS, a third user equipment device to provide a second satellite assisted terrestrial wireless device-to-device communications connection to the first user equipment device based on a change in location of one or more or any combination of the following: (i) first user equipment device, (ii) the second user equipment device, or (iii) third user equipment device (e.g., third user equipment device moves closer to the first user equipment device than the second user equipment device and can provide a better quality of service D2D link and/or the second user equipment device moves further away from the first user equipment device than the third user equipment device such that the third user equipment device can provide a better quality of service D2D link).

System Embodiment 11A1. The system of System Embodiment 1, wherein said first processor further after the establishment of the satellite assisted terrestrial wireless device-to-device connection between the second user equipment device and the first user equipment device controls the CMCS to perform the following additional operations: identifying, by the CMCS, a third user equipment device to provide a second satellite assisted terrestrial wireless device-to-device communications connection to the first user equipment device based on a change in location of one or more or any combination of the following: (i) first user equipment device, (ii) the second user equipment device, or (iii) third user equipment device (e.g., third user equipment device moves closer to the first user equipment device than the second user equipment device and can provide a better quality of service D2D link and/or the second user equipment device moves further away from the first user equipment device than the third user equipment device such that the third user equipment device can provide a better quality of service D2D link).

System Embodiment 11B. The system of System Embodiment 11A or 11A1, wherein said first processor further controls the CMCS to perform the following additional operations: sending, by the CMCS, instructions to the terrestrial core network for establishing a satellite assisted terrestrial wireless device-to-device communications connection between the third user equipment device and the first user equipment device.

System Embodiment 12. The system of System Embodiment 1, wherein said first processor further controls the CMCS to perform the following additional operations: prior to said making the determination, by a Continuous Mobile Communications System (CMCS), that the first user equipment device meets criteria for providing satellite assisted terrestrial wireless device-to-device communications, changing, by the first user equipment device from a first mode of operation to a second mode of operation, in response to losing wireless connectivity with the first wireless base station of the terrestrial wireless network system, said first mode of operation being a terrestrial wireless only mode of operation in which satellite communications are not enabled, said second mode of operation being a mode of operation in which the first user equipment device is enabled to communicate with other user equipment devices and wireless base stations of the terrestrial wireless network system and satellites of a satellite communications system.

System Embodiment 13. The system of System Embodiment 12, wherein said first processor further controls the CMCS to perform the following additional operations: establishing, by a second user equipment device of the terrestrial wireless network system, a satellite assisted wireless device-to-device communications connection with the first wireless device in response to instructions provided by the CMCS.

System Embodiment 14. The system of System Embodiment 13, wherein said first processor further controls the CMCS to perform the following additional operations: receiving, by the first user equipment device, directly from a first wireless base station of the terrestrial wireless network system reference signals; collecting, by the first user equipment device, performance metrics (e.g., first wireless base station reference signal received strength, signaling noise measurements) on the reference signals being received by the first user equipment device from the first wireless base station of the terrestrial wireless network system; sending, by the first user equipment device, the collected performance metrics to the terrestrial wireless core network via the satellite assisted device-to-device communications connection; and sending, by the terrestrial wireless core network, the collected performance metrics to the CMCS; monitoring, by the CMCS, the collected performance metrics for a period of time; and based on the monitored performance metrics over the period of time determining, by the CMCS, to terminate the satellite assisted terrestrial wireless device-to-device communications connection between the first user equipment device and the second user equipment device.

System Embodiment 15. The system of System Embodiment 14, wherein said first processor further controls the CMCS to perform the following additional operations: generating, by the CMCS, instructions for the first user equipment device to re-establish a direct terrestrial wireless connection between the first user equipment device and the first wireless base station and then terminate the satellite assisted terrestrial wireless device-to-device communications connection between the first user equipment device and the second user equipment device; and communicating to the first user equipment device via the satellite assisted terrestrial wireless device-to-device communications connection, by the CMCS, the generated instructions for the first user equipment device to re-establish a direct terrestrial wireless connection between the first user equipment device and the first wireless base station and then terminate the satellite assisted terrestrial wireless device-to-device communications connection between the first user equipment device and the second user equipment device.

System Embodiment 16. The system of System Embodiment 15, wherein the first user equipment device receives the instructions for the first user equipment device to re-establish a direct terrestrial wireless connection between the first user equipment device and the first wireless base station and then terminate the satellite assisted terrestrial wireless device-to-device communications connection between the first user equipment device and the second user equipment device to the first user equipment device via the satellite assisted terrestrial wireless device-to-device communications connection; and wherein the first user equipment device re-establishes a direct terrestrial wireless connection between the first user equipment device and the first wireless base station; and wherein after re-establishing the direct terrestrial wireless connection, the first user equipment device performs the operations of: (i) terminating, by the first user equipment device, the satellite assisted terrestrial wireless device-to-device communications connection between the first user equipment device and the second user equipment device; and (ii) switching, by the first user equipment device, from the second mode of operation back to the first mode of operation, said switching from the second mode of operation back to the first mode of operation includes disabling the enabled satellite communications.

System Embodiment 17. The system of System Embodiment 16, wherein switching from the first mode of operation to the second mode of operation includes powering on a transmitter and a receiver of the first user equipment device for satellite communications; and wherein switching back from the second mode of operation to the first mode of operation includes powering off the transmitter and the received of the first user equipment device for satellite communications.

System Embodiment 18. The system of System Embodiment 1, wherein said first processor further controls the CMCS to perform the following additional operation after the satellite assisted terrestrial wireless device-to-device communications connection between the first user equipment device and the second user equipment device has been established: determining, by the CMCS, when to terminate the satellite assisted terrestrial wireless device-to-device communications connection between the first user equipment device and the second user equipment device based on signaling information provided by the first user equipment device to the CMCS via the satellite assisted terrestrial wireless device-to-device communications connection between the first user equipment device and the second user equipment device.

System Embodiment 19. The system of System Embodiment 18, wherein said signaling information includes reference signal received power measurements made by the first user equipment device on reference signals received by the first user equipment device from a first wireless base station of a terrestrial wireless network to which the terrestrial wireless core network is a part.

System Embodiment 20. The system of System Embodiment 20, wherein the signaling information further includes signaling noise and interference information (e.g., SNIR) for the reference signals received by the first user equipment device from the first wireless base station.

System Embodiment 21. A first user equipment device comprising: memory, and a first processor, said first processor configured to control the first user equipment device to perform the following operations: detecting, by a first user equipment device while operating in a first mode of operation, the loss of wireless connectivity with a terrestrial wireless network system; changing, by the first user equipment device, from the first mode of operation to a second mode of operation, in response to detecting the loss of wireless connectivity with the terrestrial wireless network system; and wherein said first mode of operation is a terrestrial wireless only mode of operation in which satellite communications are not enabled; and wherein said second mode of operation is a mode of operation in which the first user equipment device is enabled to communicate with other user equipment devices and wireless base stations of the terrestrial wireless network system and satellites of a satellite communications system.

Apparatus Embodiment 22. The first user equipment device of Apparatus Embodiment 21, wherein said detecting, by the first user equipment device operating in the first mode of operation, the loss of wireless connectivity with the terrestrial wireless network system includes: detecting, by the first user equipment device, the inability to receive signals from or communicate with any wireless base stations of the terrestrial wireless network system.

Apparatus Embodiment 23. The first user equipment device of Apparatus Embodiment 22, wherein the first processor further controls the first user equipment device to perform the following additional operations while operating in the second mode of operation: (i) enabling satellite assisted terrestrial wireless device-to-device connection functionality on the first user equipment device; and (ii) once satellite assisted terrestrial wireless device-to-device connection functionality on the first user equipment device has been enabled, initiating, by the first user equipment device, wireless signal transmissions to one or more satellites of a satellite communications system for user equipment device location tracking by the satellite communications system; and (iii) continuing the wireless signal transmissions to the one or more satellites while said satellite assisted terrestrial wireless device-to-device connection functionality is enabled.

Apparatus Embodiment 24. The first user equipment device of Apparatus Embodiment 22, wherein the first processor further controls the first user equipment device while operating in the second mode of operation to perform the following operations: (i) enabling satellite assisted terrestrial wireless device-to-device connection functionality on the first user equipment device; and (ii) after enabling satellite assisted terrestrial wireless device-to-device connection functionality on the first user equipment device, establishing a wireless communications connection with a satellite of a satellite communications system, said wireless communications connection limited to signaling for location tracking of the first user equipment device by the satellite communications system.

Apparatus Embodiment 24A. The first user equipment device of Apparatus Embodiment 24, wherein the wireless communications connection established by the first user equipment device and the satellite is not used for voice communications.

Apparatus Embodiment 25. The first user equipment device of Apparatus Embodiment 23 or 24, wherein the first processor further controls the first user equipment device while continuing to operate in the second mode of operation to perform the following additional operations: wirelessly receiving, from a second user equipment device, a broadcast message offering terrestrial wireless device-to-device services, said second user equipment device having a wireless connection to a wireless base station of the terrestrial wireless network system; and generating a response to the broadcast message, said response requesting the offered terrestrial wireless device-to-device services and including identification information for the first user equipment device (e.g., GUTI or IMEI for the first user equipment device); wirelessly transmitting the generated response to the second user equipment device; receiving from the second user equipment device a message indicating acceptance of the request for the offered terrestrial wireless device-to-device services and including information for establishing the terrestrial wireless device-to-device connection between the first user equipment device and the second user equipment device.

Apparatus Embodiment 25A. The first user equipment device of Apparatus Embodiment 25, wherein the second user equipment device has been selected by a Continuous Mobile Communications System (CMCS) to provide satellite assisted terrestrial wireless device-to-device connection to the first user equipment device from a plurality of user equipment devices wireless connected to the terrestrial wireless network system, said selection being based on information received from the terrestrial wireless network system and the satellite communications system; and wherein the second user equipment device received instructions from the CMCS to send the broadcast message offering terrestrial wireless device-to-device services.

Apparatus Embodiment 25B. The first user equipment device of Apparatus Embodiment 25A, wherein the information received by the CMCS from the terrestrial wireless network system on which the second user equipment device selection was based includes one or more or any combination of: (i) distance between the first user equipment and user equipment devices of the plurality of user equipment devices, (ii) signal interference information, (iii) modulation rates supported by user equipment devices of the plurality of user equipment devices, (iv) load on the network, (v) individual load on the user equipment devices of the plurality of user equipment devices, (vi) user equipment device category of the first user equipment device, (vii) user equipment device capabilities of the first user equipment device, (viii) user equipment device type of the first user equipment device; (ix) user equipment device category of user equipment devices of the plurality of user equipment devices, (x) user equipment device capabilities of the user equipment devices of the plurality of user equipment devices, (xi) user equipment device type of the user equipment devices of the plurality of user equipment devices, (xii) information on the wireless links connecting the user equipment devices of the plurality of user equipment devices to terrestrial wireless base stations, (xiii) information on the movement (e.g., direction and/or speed) of the first user equipment device, (xiv) information on the movement (e.g., direction and/or speed) of the user equipment devices of the plurality of user equipment devices, (xv) contracted for quality of service of the first user equipment device, (xvi) contracted for quality of service of the user equipment devices of the user equipment devices of the plurality of user equipment devices, (xvii) estimated quality of service of wireless device-to-device connections that could be provided by user equipment devices of the plurality of user equipment devices, (xviii) measured received signal strength of signals from user equipment devices of the plurality of user equipment devices provided by the base stations to which the user equipment devices are connected.

The first user equipment device of Apparatus Embodiment 25B1, wherein the information received by the CMCS from the satellite system on which the second user equipment device selection was based includes: position and/or tracking information for the first user equipment device generated by the satellite communications system based on the transmission signals received from the first user equipment device by one or more satellites of the satellite communications system.

Apparatus Embodiment 25C. The first user equipment device of Apparatus Embodiment 25B, wherein said selection of the second user equipment device being further based on information received from a propagation generator and link estimator device which provides potential user equipment device candidates for the satellite assisted terrestrial wireless device-to-device connection and information on the potential satellite assisted terrestrial wireless device-to-device links which could be supported by the candidate user equipment devices (e.g., link data rate, bandwidth, modulation scheme and coding that can be supported by the candidate user equipment device).

Apparatus Embodiment 25D. The first user equipment device of Apparatus Embodiment 25C, wherein the propagation generator and link estimator uses propagation models and information on the first user equipment device and information on the user equipment devices of the plurality of user equipment devices to determine the potential user equipment device candidates and information on the potential satellite assisted terrestrial wireless device-to-device links which could be supported by the candidate user equipment devices; wherein the information on the first user equipment device includes location information and UE category information; and wherein the information on the user equipment devices of the plurality of user equipment devices includes location information and UE category information for the user equipment devices of the plurality of the user equipment devices.

Apparatus Embodiment 26. The first user equipment device of Apparatus Embodiment 25, wherein the information for establishing the terrestrial wireless device-to-device connection including radio resource information, said radio resource information including: one or more or any combination of the following: information identifying radio frequency spectrum for the terrestrial wireless device-to-device connection, information on the data rate to be used for the or the terrestrial wireless device-to-device connection, information on the bandwidth available for the terrestrial wireless device-to-device connection, information on the modulation scheme and coding for the terrestrial wireless device-to-device connection.

Apparatus Embodiment 26A. The first user equipment device of Apparatus Embodiment 26, wherein CMCS generates the instructions received by the second user equipment device to send the broadcast message offering terrestrial wireless device-to-device services using information generated by a propagation generator and link estimator device, said instructions including the identification information for the first user equipment device and radio resources to be utilized for the terrestrial wireless device-to-device connection to be established between the second user equipment device and the first user equipment device.

Apparatus Embodiment 27. The first user equipment device of Apparatus Embodiment 25, wherein the first processor further controls the first user equipment device while continuing to operate in the second mode of operation to perform the following additional operations: establishing the terrestrial wireless device-to-device connection with the second user equipment device; establishing a voice call using the terrestrial wireless device-to-device connection to a third user equipment device.

Apparatus Embodiment 28. The first user equipment device of Apparatus Embodiment 27, wherein said third user equipment device is not a subscriber of the terrestrial wireless network system.

Apparatus Embodiment 29. The first user equipment device of Apparatus Embodiment 25, wherein the first processor further controls the first user equipment device while continuing to operate in the second mode of operation to perform the following additional operations: establishing, the terrestrial wireless device-to-device connection with the second user equipment device; and establishing, a voice call, using the terrestrial wireless device-to-device connection to a third user equipment device, said third user equipment device being connected to a wireless base station of the terrestrial wireless network system which is different than the wireless base station to which the second user equipment device is connected.

Apparatus Embodiment 30. The first user equipment device of Apparatus Embodiment 25, wherein the first processor further controls the first user equipment device while continuing to operate in the second mode of operation to perform the following additional operations: receiving reference signals directly from a wireless base station of the terrestrial wireless network; generating performance metrics on the received reference signals (e.g., signal strength, signaling interference, signaling noise metrics such as RSRP, SNIR, etc.); reporting the performance metrics for the received reference signals to a Continuous Mobile Communications System (CMCS) via the terrestrial wireless device-to-device communications connection.

Apparatus Embodiment 31. The first user equipment device of Apparatus Embodiment 30, wherein the performance metrics are generated and reported until instructions are received from the CMCS via the terrestrial wireless device-to-device connection to establish or re-establish a direct wireless connection with the wireless base station from which the reference signals are being received and terminate the satellite assisted terrestrial wireless device-to-device connection.

Apparatus Embodiment 31A. The first user equipment device of Apparatus Embodiment 31, wherein the CMCS receives and monitors the reported performance metrics from the first user equipment device; and wherein the CMCS determines based on the monitoring of the reported performance metrics from the first user equipment device that the first user equipment is to establish the direct wireless connection with the wireless base station from which the reference signals are being received and terminate the satellite assisted terrestrial wireless device-to-device connection; and wherein the CMCS in response to determining that the first user equipment is to establish the direct wireless connection with the wireless base station from which the reference signals are being received and terminate the satellite assisted terrestrial wireless device-to-device connection generates and sends to the first user equipment the instructions to establish the direct wireless connection with the wireless base station from which the reference signals are being received and terminate the satellite assisted terrestrial wireless device-to-device connection.

Apparatus Embodiment 32. The first user equipment device of Apparatus Embodiment 30, wherein the first processor further controls the first user equipment device while continuing to operate in the second mode of operation to perform the following additional operations: receiving instructions from the CMCS via the terrestrial wireless device-to-device connection to establish or re-establish (e.g., if one had been previously established and lost) a direct wireless connection with the wireless base station from which the reference signals are being received and then terminate the satellite assisted terrestrial wireless device-to-device connection; establishing a direct wireless connection with the wireless base station from which the reference signals are being received; terminating the satellite assisted terrestrial wireless device-to-device connection with the second user equipment device.

Apparatus Embodiment 33. The first user equipment device of Apparatus Embodiment 32, wherein the first processor controls the first user equipment device to perform the following additional operations: switching, by the first user equipment device, from the second mode of operation to the first mode of operation; and wherein switching from the second mode of operation to the first mode of operation includes: (i) disabling, by the first user equipment device, satellite assist terrestrial wireless device-to-device connection functionality at the first user equipment, and (ii) disabling, by the first user equipment device, satellite communications.

Apparatus Embodiment 34. The first user equipment device of Apparatus Embodiment 33, wherein disabling satellite assist terrestrial wireless device-to-device connection functionality includes ceasing sending transmission signals to the satellites of the satellite system.

Apparatus Embodiment 35. The first user equipment device of Apparatus Embodiment 34, wherein enabling, by the first user equipment device, satellite communications includes powering on a satellite transmitter and receiver; and wherein disabling, by the first user equipment device, satellite communications includes powering off all satellite transmitters and receivers at the first user equipment device.

Apparatus Embodiment 36. The first user equipment device of Apparatus Embodiment 35, wherein the terrestrial wireless network system is operated by a first operator and the satellite system is operated by a second different operator, wherein the satellite system offers satellite voice communications services and satellite assisted terrestrial wireless device-to-device services, said satellite voice communications services costing more than said satellite assisted terrestrial wireless device-to-device services.

Apparatus Embodiment 36A. The first user equipment device of Apparatus Embodiment 36, wherein the satellite assisted terrestrial wireless device-to-device services are limited to user equipment device position or location tracking services, said user equipment device position or location tracking services including the satellite system determining, tracking and reporting a user equipment device's position or location to the Continuous Mobile Communications System based on signals received from the user equipment device by one or more satellites of the satellite system (e.g., user equipment device's geographical coordinates and a timestamp).

Apparatus Embodiment 37. The first user equipment device of Apparatus Embodiment 36, wherein the satellite voice communications services provide utilize more satellite radio frequency spectrum than said satellite assisted terrestrial wireless device-to-device services.

Apparatus Embodiment 38. The first user equipment device of Apparatus Embodiment 21, further comprising: a first satellite transmitter; a first satellite receiver; a first terrestrial wireless transmitter; a first terrestrial wireless receiver; and a satellite assist terrestrial wireless device-to-device application.

### List of Exemplary Numbered Non-transitory Computer Readable Medium Embodiments

Non-transitory Computer Readable Medium Embodiment 1. A non-transitory computer readable medium including a first set of computer executable instructions which when executed by a processor of a Continuous Mobile Communications System cause the Continuous Mobile Communications System to perform the steps of: making a determination that a first user equipment device meets criteria for providing satellite assisted terrestrial wireless device-to-device communications; identifying a second user equipment device to provide a satellite assisted terrestrial wireless device-to-device communications connection to the first user equipment device; and sending instructions to a terrestrial wireless core network for establishing a satellite assisted terrestrial wireless device-to-device communications connection between the second user equipment device and the first user equipment device.

Non-transitory Computer Readable Medium Embodiment 2. A non-transitory computer readable medium including a first set of computer executable instructions which when executed by a processor of a first user equipment device cause the first user equipment device to perform the steps of: detecting, by the first user equipment device while operating in a first mode of operation, the loss of wireless connectivity with a terrestrial wireless network system; changing, by the first user equipment device, from the first mode of operation to a second mode of operation, in response to detecting the loss of wireless connectivity with the terrestrial wireless network system; and wherein said first mode of operation is a terrestrial wireless only mode of operation in which satellite communications are not enabled; and wherein said second mode of operation is a mode of operation in which the first user equipment device is enabled to communicate with other user equipment devices and wireless base stations of the terrestrial wireless network system and satellites of a satellite communications system.

The techniques of various embodiments may be implemented using software, hardware and/or a combination of software and hardware. Various embodiments are directed to apparatus, e.g., Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements. Various embodiments are also directed to methods, e.g., method of controlling and/or operating Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements or steps are implemented using hardware circuitry.

In various embodiments devices, e.g., Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements described herein are implemented using one or more components to perform the steps corresponding to one or more methods, for example, generating or creating messages, implementing and/or connections, message reception, message transmission, switching modes, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements are configured to perform the steps of the methods described as being performed by Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements, with a processor which includes a component corresponding to each of the steps of the various described methods performed by the device in which the processor is included. In some but not all embodiments a device, e.g., Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a Continuous Mobile Communications Systems, Propagation Generator and Link Estimator, terrestrial wireless base stations, wireless devices, mobile terminals, network equipment, gNBs, tower base stations, smart devices, user equipment devices, user devices, computers, smartphones, tablets, mobile phones, laptops, PDAs, subscriber devices, terrestrial core network systems, satellites, satellite core network system, satellite ground systems, operational support systems, storage system, ProSe entities, servers, nodes, and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method comprising:
making a determination, by a Continuous Mobile Communications System (CMCS), that a first user equipment device meets criteria for providing satellite assisted terrestrial wireless device-to-device communications;
identifying, by the CMCS, a second user equipment device to provide a satellite assisted terrestrial wireless device-to-device communications connection to the first user equipment device; and
sending, by the CMCS, instructions to a terrestrial wireless core network for establishing a satellite assisted terrestrial wireless device-to-device communications connection between the second user equipment device and the first user equipment device.

2. The method of claim 1,
wherein said determination that the first user equipment device meets criteria for providing satellite assisted terrestrial wireless device-to-device communications is based on location information for the first user equipment device provided to the CMCS from a satellite core network.

3. The method of claim 2, wherein said determination that the first user equipment device meets criteria for providing satellite assisted terrestrial wireless device-to-device communications is further based on movement information for the first user equipment device provided to the CMCS from the satellite core network or derived from the location information for the first user equipment device provided to the CMCS from the satellite core network, said movement information including speed information for the first user equipment device, said speed information being the speed at which the first user equipment device is moving.

4. The method of claim 3, wherein said criteria includes: (i) the first user equipment device is moving at a speed less than a first speed threshold amount, (ii) the first user equipment device has a subscription to a terrestrial wireless network and a subscription to a satellite wireless network, and (iii) the first user equipment device does not have wireless connectivity with the terrestrial wireless network.

5. The method of claim 1, wherein said first user equipment device is a dual subscription wireless device capable of simultaneously wirelessly communicating with: (i) satellites of a satellite wireless network, and (ii) wireless communications devices of a terrestrial wireless network, said terrestrial wireless core network being part of the terrestrial wireless network.

6. The method of claim 1, further comprising:
prior to sending instructions to the first terrestrial core network for establishing a satellite assisted terrestrial wireless device-to-device communications connection between the second user equipment device and the first user equipment device, generating, by the CMCS, said instructions, said instructions including: (i) identification information for the first user equipment device which is to be the target of the satellite assisted terrestrial wireless device-to-device communications connection, (ii) identification information for the second user equipment device which is to host the satellite assisted terrestrial wireless device-to-device communications connection, and (iii) radio resource information for the satellite assisted terrestrial wireless device-to-device communications connection to be established.

7. The method of claim 1,
wherein said identifying, by the CMCS, the second user equipment device includes:
selecting the second user equipment device from a plurality of user equipment devices having a terrestrial wireless connection to a wireless base station of a terrestrial wireless network to which the first user equipment device is subscribed based on information provided by a propagation generator and link estimator, said information provided by the propagation generator and link estimator including information about which of the plurality of user equipment devices are capable of supporting a device-to-device communications link to the first user equipment device and attributes about the device-to-device communications link which could be supported.

8. The method of claim 1,
wherein said identifying, by the CMCS, the second user equipment device to provide a satellite assisted terrestrial wireless device-to-device communications connection to the first user equipment device includes:
determining that the second user equipment device is a best match for providing a satellite assisted terrestrial wireless device-to-device communications connection to the first user equipment device from a plurality of user equipment devices having a terrestrial wireless connection to a wireless base station of a terrestrial wireless network to which the first user equipment device is subscribed based on: (i) location information for the first user equipment device, (ii) location information for the second user equipment device, (iii) information on movement of the second user equipment device with respect to the first user equipment device, (iv) traffic load on the second user equipment device, and (v) estimated propagation path loss for a potential wireless device-to-device communications link connecting the second user equipment device to the first user equipment device.

9. The method of claim 1, further comprising:
prior to said making a determination, by a Continuous Mobile Communications System (CMCS), that a first user equipment device meets criteria for providing satellite assisted terrestrial wireless device-to-device communications, receiving, by the CMCS, from the terrestrial wireless core network information indicating that the first user equipment device has lost a terrestrial wireless connection to a first wireless base station.

10. The method of claim 1, further comprising:
identifying, by the CMCS, a third user equipment device to provide a second satellite assisted terrestrial wireless device-to-device communications connection to the first user equipment device based on a change in location of one or more of the following: (i) first user equipment device, or (ii) the second user equipment device.

11. The method of claim 1, further comprising:
prior to said making the determination, by the CMCS, that the first user equipment device meets criteria for providing satellite assisted terrestrial wireless device-to-device communications,
changing, by the first user equipment device from a first mode of operation to a second mode of operation, in response to losing wireless connectivity with a first wireless base station of a terrestrial wireless network system, said first mode of operation being a terrestrial wireless only mode of operation in which satellite communications are not enabled, said second mode of operation being a mode of operation in which the first user equipment device is enabled to communicate with other user equipment devices and wireless base stations of the terrestrial wireless network system and satellites of a satellite communications system.

12. The method of claim 1, further comprising:
after the satellite assisted terrestrial wireless device-to-device communications connection between the first user equipment device and the second user equipment device has been established, determining, by the CMCS, when to terminate the satellite assisted terrestrial wireless device-to-device communications connection between the first user equipment device and the second user equipment device based on signaling information provided by the first user equipment device to the CMCS via the satellite assisted terrestrial wireless device-to-device communications connection between the first user equipment device and the second user equipment device.

13. The method of claim 12,
wherein said signaling information includes reference signal received power measurements made by the first user equipment device on reference signals received by the first user equipment device from a first wireless base station of a terrestrial wireless network to which the terrestrial wireless core network is a part, said reference signals being received after the establishment of the terrestrial wireless device-to-device connection between the second user equipment device and the first user equipment device.

14. A system comprising:
a Continuous Mobile Communications System (CMCS), said CMCS including memory and a first processor, said first processor controlling the CMCS to perform the following operations:
making a determination that a first user equipment device meets criteria for providing satellite assisted terrestrial wireless device-to-device communications;
identifying a second user equipment device to provide a satellite assisted terrestrial wireless device-to-device communications connection to the first user equipment device; and
sending instructions to a terrestrial wireless core network for establishing a satellite assisted terrestrial wireless device-to-device communications connection between the second user equipment device and the first user equipment device.

15. The system of claim 14,
wherein said determination that the first user equipment device meets criteria for providing satellite assisted terrestrial wireless device-to-device communications is based on location information for the first user equipment device provided to the CMCS from a satellite core network.

16. The system of claim 15, wherein said determination that the first user equipment device meets criteria for providing satellite assisted terrestrial wireless device-to-device communications is further based on movement information for the first user equipment device provided to the CMCS from the satellite core network or derived from the location information for the first user equipment device provided to the CMCS from the satellite core network, said movement information including speed information for the first user equipment device, said speed information being the speed at which the first user equipment device is moving.

17. The system of claim 16, wherein said criteria includes: (i) the first user equipment device is moving at a speed less than a first speed threshold amount, (ii) the first user equipment device has a subscription to a terrestrial wireless network and a subscription to a satellite wireless network, and (iii) the first user equipment device does not have wireless connectivity with the terrestrial wireless network.

18. The system of claim 14, wherein said first user equipment device is a dual subscription wireless device capable of simultaneously wirelessly communicating with: (i) satellites of a satellite wireless network, and (ii) wireless communications devices of a terrestrial wireless network, said terrestrial wireless core network being part of the terrestrial wireless network.

19. The system of claim 14, wherein the first processor further controls the CMCS to perform the following additional operation:
prior to sending instructions to the first terrestrial core network for establishing a satellite assisted terrestrial wireless device-to-device communications connection between the second user equipment device and the first user equipment device, generating, by the CMCS, said instructions, said instructions including: (i) identification information for the first user equipment device which is to be the target of the satellite assisted terrestrial wireless device-to-device communications connection, (ii) identification information for the second user equipment device which is to host the satellite assisted terrestrial wireless device-to-device communications connection, and (iii) radio resource information for the satellite assisted terrestrial wireless device-to-device communications connection to be established.

20. A non-transitory computer readable medium including a first set of computer executable instructions which when executed by a processor of a Continuous Mobile Communications System cause the Continuous Mobile Communications System to perform the steps of:
making a determination that a first user equipment device meets criteria for providing satellite assisted terrestrial wireless device-to-device communications;
identifying a second user equipment device to provide a satellite assisted terrestrial wireless device-to-device communications connection to the first user equipment device; and
sending instructions to a terrestrial wireless core network for establishing a satellite assisted terrestrial wireless device-to-device communications connection between the second user equipment device and the first user equipment device.
